(19) United States
(12) Patent Application Publication
(10) Pub. No.: US 2023/0050511 A1
(43) Pub. Date: Feb. 16, 2023

(54) ENTERPRISE AUTOMATION SYSTEM

(71) Applicant: Krista Software Inc., Dallas, TX (US)

(72) Inventor: John J. Michelsen, Dallas, TX (US)

(21) Appl. No.: 17/887,451

(22) Filed: Aug. 13, 2022

Related U.S. Application Data
(60) Provisional application No. 63/233,149, filed on Aug. 13, 2021.

(51) Int. Cl. G06Q 10/10

(52) U.S. Cl. CPC G06Q 10/10

(57) ABSTRACT

In one embodiment, a method comprises providing a set of a conversation blocks in a programming interface to an author; and constructing a conversation based on instantiation and configuration by the author of a plurality of conversation blocks of the set of conversation blocks, the conversation implementing an automation flow with respect to at least one backend system of an organization, wherein a first instantiated conversation block of the set of conversation blocks specifies a request, wherein the request is mapped to an extension comprising logic to interact with a backend system of the at least one backend system to effectuate an action described by a title of the request.

### CROSS-REFERENCE TO RELATED APPLICATION

This application claims the benefit of and priority from U.S. Provisional Pat. Application No. 63/233,149 entitled “ENTERPRISE AUTOMATION SYSTEM” and filed Aug. 13, 2021, the entire disclosure of which is incorporated herein by reference.

### TECHNICAL FIELD

This disclosure relates in general to the field of computer systems and, more particularly, to enterprise automation.

### BACKGROUND

Enterprise automation typically involves developers creating complex code with calls to backend systems. Thus, coders who want to interact with backend systems must understand how the backend systems operate and the interface requirements of the backend systems. However, interfaces to backend systems are generally not intuitive to a typical business user lacking programming experience and thus the business user must rely on a developer with specialized expertise to create automations involving the backend systems, resulting in a disconnect between consumers of the automations, long development cycles, and other inefficiencies.

### BRIEF DESCRIPTION OF THE DRAWINGS

FIG. 1 illustrates a communication system enabling the use of conversation as a programming language in accordance with certain embodiments.

FIG. 2 illustrates a private catalog in accordance with certain embodiments.

FIG. 3 illustrates a view of a catalog that may be provided by workspace studio in accordance with certain embodiments.

FIG. 4 illustrates a view of an ecosystem that may be provided by workspace studio in accordance with certain embodiments.

FIG. 5 illustrates a view of conversations of a topic that may be provided by a workspace studio in accordance with certain embodiments.

FIG. 6 illustrates a view of requests in a domain that may be provided by a workspace studio in accordance with certain embodiments.

FIG. 7 illustrates a view of entities in a domain that may be provided by a workspace studio in accordance with certain embodiments.

FIG. 8 illustrates a view to create an entity that may be provided by a workspace studio in accordance with certain embodiments.

FIG. 9 illustrates a view to select a data type for an entity field that may be provided by a workspace studio in accordance with certain embodiments.

FIG. 10 illustrates a view that may be provided by the workspace studio for creating a request in accordance with certain embodiments.

FIG. 11 illustrates a view for creating or editing various parameters of a conversation in a workspace studio in accordance with certain embodiments.

FIG. 12 illustrates a view that may be displayed by a workspace studio after a person makes a request option is selected for a conversation start block in accordance with certain embodiments.

FIG. 13 illustrates a view that may be displayed by a workspace studio after a system trigger option is selected for a conversation start block in accordance with certain embodiments.

FIG. 14 illustrates example conversation blocks that may be used in a conversation in accordance with certain embodiments.

FIG. 15 illustrates an inform a person conversation block in accordance with certain embodiments.

FIG. 16 illustrates an ask a person conversation block in accordance with certain embodiments.

FIG. 17 illustrates example selection options that may be provided by a role based selection interface in accordance with certain embodiments.

FIG. 18 illustrates example settings that may be shown when a response rules details header is selected in accordance with certain embodiments.

FIG. 19 illustrates an attach additional information interface in accordance with certain embodiments.

FIG. 20 illustrates an ask a system conversation block in accordance with certain embodiments.

FIG. 21 illustrates an ask a system conversation block when a search header is selected in accordance with certain embodiments.

FIG. 22 illustrates selection of an extension in accordance with certain embodiments.

FIGS. 23A-E illustrate example input specification interfaces in accordance with certain embodiments.

FIG. 24 illustrates a system response received conversation block in accordance with certain embodiments.

FIG. 25 illustrates a make a decision conversation block in accordance with certain embodiments.

FIG. 26 illustrates a call another conversation block in accordance with certain embodiments.

FIG. 27 illustrates a repeat steps in a loop conversation block in accordance with certain embodiments.

FIG. 28 illustrates use of a repeat steps in a loop conversation block in conjunction with an inform a person conversation block in accordance with certain embodiments.

FIGS. 29-30 illustrate use of a repeat steps in a loop conversation block in conjunction with an inform a person conversation block in accordance with certain embodiments.

FIG. 31 illustrates example configuration options for an ask Krista Al conversation block in accordance with certain embodiments.

FIG. 32 illustrates example configuration options for an ask Krista Al conversation block when calculate a number value is selected as the model type in accordance with certain embodiments.

FIG. 33 illustrates a prediction generator of the ask Krista Al conversation block in accordance with certain embodiments.

FIG. 34 illustrates example configuration options for an ask Krista Al conversation block when check anomalous value is selected as the model type in accordance with certain embodiments.

FIG. 35 illustrates a manage information conversation block in accordance with certain embodiments.

FIG. 36 illustrates a view that may be provided for an end path or conversation block in accordance with certain embodiments.

FIG. 37 illustrates various interfaces that may be presented to a user to allow the user to participate in an ad-hoc conversation in accordance with certain embodiments.

FIG. 38 illustrate interfaces associated with an ad-hoc conversation in accordance with certain embodiments.

FIG. 39 illustrates a workspace in accordance with certain embodiments.

FIG. 40 illustrates example roles of an organization’s directory and example roles used within an enterprise automation system in accordance with certain embodiments.

FIG. 41 illustrates an interface for role mapping that may be performed during the importing of a topic from a catalog into a workspace in accordance with certain embodiments.

FIG. 42 illustrates privilege settings for a workspace that may be configured by a user in accordance with certain embodiments.

FIG. 43A illustrates privilege settings for a topic in accordance with certain embodiments.

FIG. 43B illustrates privilege settings for a conversation in accordance with certain embodiments.

FIG. 44 illustrates a view for editing an entity in accordance with certain embodiments.

FIG. 45 illustrates a role matrix in accordance with certain embodiments.

FIG. 46 illustrates a free-form text message defined within an inform a person conversation block in accordance with certain embodiments.

FIG. 47 illustrates an interface for configuring ad-hoc privileges in accordance with certain embodiments.

FIG. 48 illustrates extension selection during the importing of a topic in accordance with certain embodiments.

FIG. 49 illustrates a view for configuring attributes for an extension set in accordance with certain embodiments.

FIG. 50 illustrates a view that may be provided by an example client for interacting with one or more workspaces in accordance with certain embodiments.

FIG. 51 illustrates an example client with a message of a conversation in accordance with certain embodiments.

FIG. 52 illustrates various icons of an example client in accordance with certain embodiments.

FIG. 53 illustrates conversation starters in accordance with certain embodiments.

FIG. 54 illustrates a dashboard in accordance with certain embodiments.

FIG. 55 illustrates an example search for opportunities in accordance with certain embodiments.

FIG. 56 illustrates a computing device coupled to a plurality of backend systems and an application server via a network in accordance with certain embodiments.

### DETAILED DESCRIPTION OF EXAMPLE EMBODIMENTS

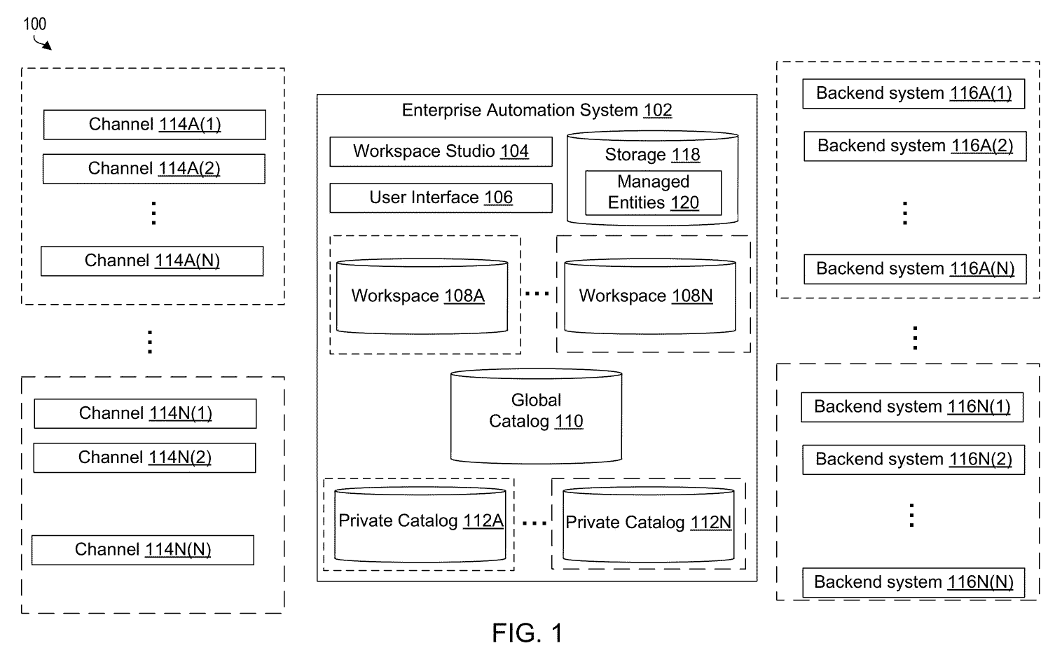

FIG. 1 illustrates a communication system 100 enabling the use of conversation as a programming language in accordance with certain embodiments. Communication system 100 includes an enterprise automation system 102 (sometimes referred to herein as “Krista”), a plurality of channels 114 (e.g., 114A(1)-(N), ..., 114M(1)- (N)), and a plurality of backend systems 116 (e.g., 116A(1)-(N), ..., 116M(1)-(N)).

The system 100 may allow a person to initiate (e.g., via a channel 114) a conversation between the person and one or more other people and/or one or more computing systems (e.g., backend systems 116). The conversation may take place within a particular context (e.g., ecosystem, domain, topic, etc.) and may have a defined outcome. In various embodiments, a conversation may include various easily understandable conversational constructs that are organized into a flow, where such constructs may include, e.g., a person or a computing system (e.g., backend system 116) asking a question, a person or a computing system (e.g., backend system 116) providing information, and conditionals defining the order of the flow (e.g., based on contents of the conversation). In various embodiments, the conversations may be built from a standard set of programming blocks including one or more of the following conversation blocks: “inform a person”, “ask a person”, “ask a system”, “make a decision”, “call another conversation”, “repeat steps in a loop”, “ask artificial intelligence (Al)”, “manage information”, and “end path or conversation.”

The enterprise automation system 102 may comprise technology that is able to understand the people interacting with the backend systems 116 (rather than requiring the people to understand how to interact with the backend systems 116). Enterprise automation system 102 may include a workspace studio 104 that allows users without formal programming experience to create conversational flows (referred to herein as conversations or automations) that interact with one or more backend systems 116 (e.g., using extensions that translate easily understandable programming blocks to logic that communicates directly with these backend systems via application programming interfaces (APIs), robotic process automation (RPA) scripts, or other methods) to provide the desired business functionality. For example, the extensions may map APIs or other capabilities of the backend systems 116 to real world business functions used by humans (e.g., “get last week’s pay stub”, “how much time off do I have?”, etc.).

Thus, system 100 may comprise a workspace studio 104 enabling process authors to literally model human conversations to create a conversation based interface to allow users to interface with backend systems 116 in a human-like way. Channels 114 may utilize the conversations to connect humans to the backend systems 116 via a user interface 106 of the enterprise automation system 102. In some embodiments, system 100 may utilize natural language processing (that utilizes the language of the process owners) to find the conversations and/or requests that provide access to backend systems 116, thus allowing non-programmers easy access to even complex backend systems. Thus, authors in an organization may build workflows by modeling conversations in domains familiar to them. Users of channels 114 may also consume the automations as conversations without formal training (if the user understands the business domain in which the conversation is applied, the user will be able to find, utilize, and understand the conversation).

As just one brief example, a conversation may proceed as follows. An employee uses a channel 114 to ask a human resources (HR) manager for time off. The system 100 may relay the request to the HR manager (through a different channel 114) along with information (e.g., the paid time off balance of the employee) associated with the request that is obtained from the backend system 116 that implements an HR system. The HR manager may review the information and approve the request, and the system 100 may then log the leave request (e.g., in the same and/or a different backend system 116) and notify the employee that the request has been approved.

Various embodiments of the present disclosure may provide one or more technical advantages. For example, system 102 may allow non-programmers to create and change automation flows quickly without specialized training (e.g., new conversations or changes to a conversation may be reflected immediately in the user interface 106 after being deployed). As another example, system 102 may allow human users to invoke automation flows via natural language constructs. As another example, system 102 may maintain an ever-growing catalog of automation, system extensions, and artificial intelligence to accelerate technology adoption. As other examples, system 102 may enable more frequent and quicker (e.g., immediate) code deployments, faster time to recover from incidents, reduced change failure rate, maximized collaboration, and/or data integration across functional business areas.

Various embodiments may provide methods and infrastructure to program automation and workflows with conversational constructs as opposed to traditional programming constructs. Some embodiments may enable integration of systems by NLP/taxonomy mapping of human intent to system capabilities in such a way that people trying to leverage system capabilities do not need to understand the technology of the system and systems with similar capabilities become interchangeable (as opposed to just exposing the APIs of the systems). In addition to the age-old method of a) conceive the automation, b) program the automation, and c) deliver the automation to end users; various embodiments allow the end-users of the automation themselves to interactively conceive an automation flow on-the-fly with live execution of the same (e.g., by using ad-hoc conversations). In various embodiments, the taxonomy used (e.g., the collective taxonomy of the ecosystem structure, entities, and requests) enables provision of NLP searches without any machine learning model creation or training by authors/programmers. In many embodiments, automation flows may enforce a potentially complex set of data security features without the authors of the automations having to specifically program any code into the system. Also, in at least some embodiments, automation flows are presented in appropriate mediums (e.g., web/Mac/Windows/FB/WhatsApp/voice) properly without any specific user interface work on the part of the author/programmer of the automations.

A channel 114 may comprise an interface (e.g., provided by a computing application) to communicate with enterprise automation system 102 (e.g., with user interface 106 and/or workspace studio 104). In various embodiments, a channel 114 comprises a collaboration system or conversational application. In some examples, a channel 114 may comprise a commonly used messaging application such as Slack® or Microsoft Teams®, a mobile application (e.g., an application executable on a Google Android® or Apple iOS® platform such as Facebook® Messenger, WhatsApp®, or the like), a desktop application (e.g., an application executable on a Microsoft Windows® or Apple macOS® platform), an Internet browser, a short message service (SMS) application, a chatbot, and/or a REST application programming interface (API). In some embodiments, the same human user may be able to utilize multiple different channels 114 to interface with enterprise automation system 102. In various embodiments, a channel 114 may provide one or more features of a client of system 102 that may display messages of a conversation to a user and allow the user to communicate information to the system 102 during the conversation (additional example features of a client will be described in more detail below).

A user may interact with a channel 114 in any suitable manner. For example, the user may utilize a keyboard, mouse, touchscreen, voice-to-text capability, display, speakers, or other input or output device associated with a computing system providing the channel 114 to provide information to system 102 or consume information from system 102.

A backend system 116 may be any system capable of providing information or other computing resources to a user. A backend system 116 may read data, analyze data, update data, manipulate data, or perform other suitable tasks. Various types of backend systems 116 may include or utilize robotic process automation, application development platforms, packaged applications, systems of record, integration platforms, artificial intelligence and machine learning models, or other automation systems. One or more backend systems 116 may support any suitable operations of an organization, such as sales order management, accounts receivables, inventory management, human resources (e.g., benefits enrollment, time tracking), executive dashboards, security incident management, or other suitable operations.

As mentioned above, enterprise automation system 102 may facilitate communication between one or more channels 114 and one or more backend systems 116. For example, a particular organization may utilize a variety of backend systems 116 and enterprise automation system 102 may enable users associated with the organization to author conversations and use the conversations to access information from and utilize computing capabilities of the backend systems 116 through one or more channels 114.

In the embodiment depicted, system 102 comprises workspace studio 104, user interface 106, a plurality of workspaces 108, a global catalog 110, a plurality of private catalogs 112, and storage 118.

The workspace studio 104 may provide an interface to allow users (e.g., authors, administrators, etc.) associated with an organization to program conversations, create various resources (that may be utilized by the conversations), configure security settings, or perform other operations (e.g., with respect to a workspace 108, global catalog 110, or private catalog 112) associated with the particular organization.

A user may access the workspace studio 104 in any suitable manner (e.g., through any of the channels 114 or through other suitable methods, such as through any suitable computing system). For example, in one embodiment, a user may use an Internet browser to log into the workspace studio 104. As another example, a user may use a desktop or mobile application (which in some embodiments could be an application dedicated to providing interaction with the workspace studio 104) to interface with the workspace studio.

The workspace studio 104 may provide an interface to allow a user to make changes to one or more workspaces 108 or private catalogs 112 associated with the organization of the user. Such changes will be described in more detail below.

A channel 114 may connect to one or more workspaces 108 and backend systems 116 via a user interface 106 of the enterprise automation system 102. The user interface 106 may use conversations and extensions of a workspace 108 of an organization to connect channels 114 to backend systems 116 of the organization to allow the users of the channels 114 to interact with the backend systems 116 and other users in ways that are intuitive to the users. In various embodiments, the user interface 106 may utilize natural language processing based on input provided (e.g., via text, voice, or bot) by a user to determine the conversation (and/or request) that a user of a channel 114 is attempting to invoke (or to identify a group of possible conversations and/or requests from which the user may select a conversation to invoke). The user interface may then pass data between one or more users of channels 114 and/or backend systems 116 as defined by the conversation blocks of the invoked conversation. In various embodiments, the user interface 106 may provide access to resources of one or more workspaces to a user based on access rights that have been granted to the user (such access rights are discussed in more detail below).

In various embodiments, the enterprise automation system 102 may facilitate communication between users and backend systems 116 for a plurality of organizations (wherein each organization may use its own set of respective channel(s) 114 and backend system(s) 116). Enterprise automation system 102 may implement security protocols to ensure that users of a particular organization are not able to access data and/or components (e.g., workspaces 108, private catalogs 112, backend systems 116) of other organizations. In the embodiment depicted, a first type of dashing is used to illustrate components of a first organization and a second type of dashing is used to illustrate components of a second organization. Thus, channels 114A(1)-(N), workspace 108A, private catalog 112A, and backend systems 116A(1)-(N) may be dedicated to a first organization and channels 114N(1)-(N), workspace 108N, private catalog 112N, and backend systems 116N(1)-(N) may be dedicated to a second organization.

The enterprise automation system 102 may comprise a global catalog 110. The global catalog 110 may comprise resources (e.g., conversations, requests, extensions, entities) that may be imported by any of the organizations into their own workspace(s) 108. In some embodiments, the global catalog 110 may present the same resources to each organization that is eligible to access the resources of the global catalog (or at least some resources may be made common to multiple organizations that access the global catalog). In some embodiments, the global catalog 110 may be maintained by personnel of an entity that owns or controls system 102.

Private catalogs 112 may be specific to particular organizations. For example, a particular private catalog 112 may be built by an organization (e.g., by importing resources from the global catalog 110, importing resources from another private catalog 112 of the organization, and/or by creating resources within the private catalog via the workspace studio 104.

A workspace 108 may include resources imported from one or more catalogs that are made available to users of an organization (e.g., through a client). An organization may have any suitable number of workspaces (e.g., different departments within an organization could each have their own workspace, different geographical regions of a company could each have their own workspace, etc.). A workspace 108 may also include information specific to the organization, such as the people, role privileges, and extensions specific to the organization.

The system 102 may also include storage 118 to host any suitable data utilized in providing the features of system 102. In some embodiments, storage 118 may include one or more databases, such as a relational database (e.g., SQL database), NoSQL database, and/or other suitable database. In some embodiments, storage 118 may host managed entities 120 (e.g., instances of entities created by users to be described in further detail below). In that sense, managed entities 120 may be considered as a backend system 116 for any number of organizations that use the system 102. In various embodiments the managed entities 120 could be stored local to the system 102 or could be stored remote from the system (and could even be stored in memory spaced leased from an entity different from the entity that controls operation of system 102).

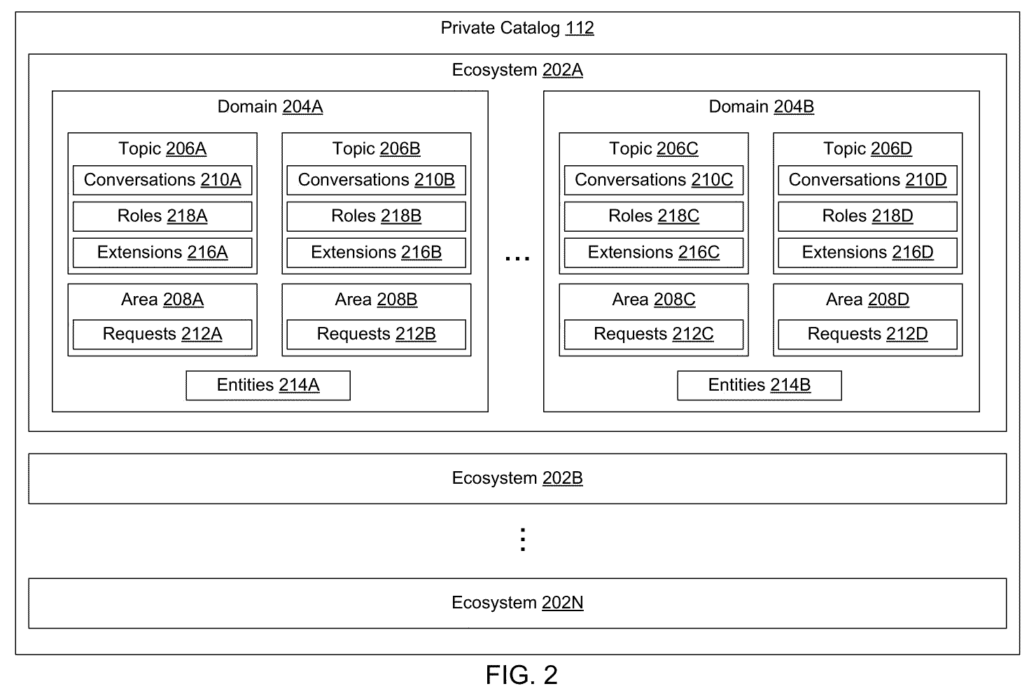

FIG. 2 illustrates a private catalog 112 in accordance with certain embodiments. Global catalog 110 may be arranged similarly (in whole or in part). A private catalog may include a collection of conversations 210, requests 212, and other resources arranged in a hierarchy.

In the embodiment depicted, private catalog 112 is arranged into a plurality of ecosystems 202. An ecosystem 202 may include one or more domains 204. Each domain may include one or more topics 206 and one or more areas 208. A topic 206 may include one or more conversations 210, roles 218, and extensions 216, while an area 208 may include one or more requests 212. A domain 204 may also have a plurality of entities 214. In other embodiments, any suitable arrangement of the resources of a catalog may be used.

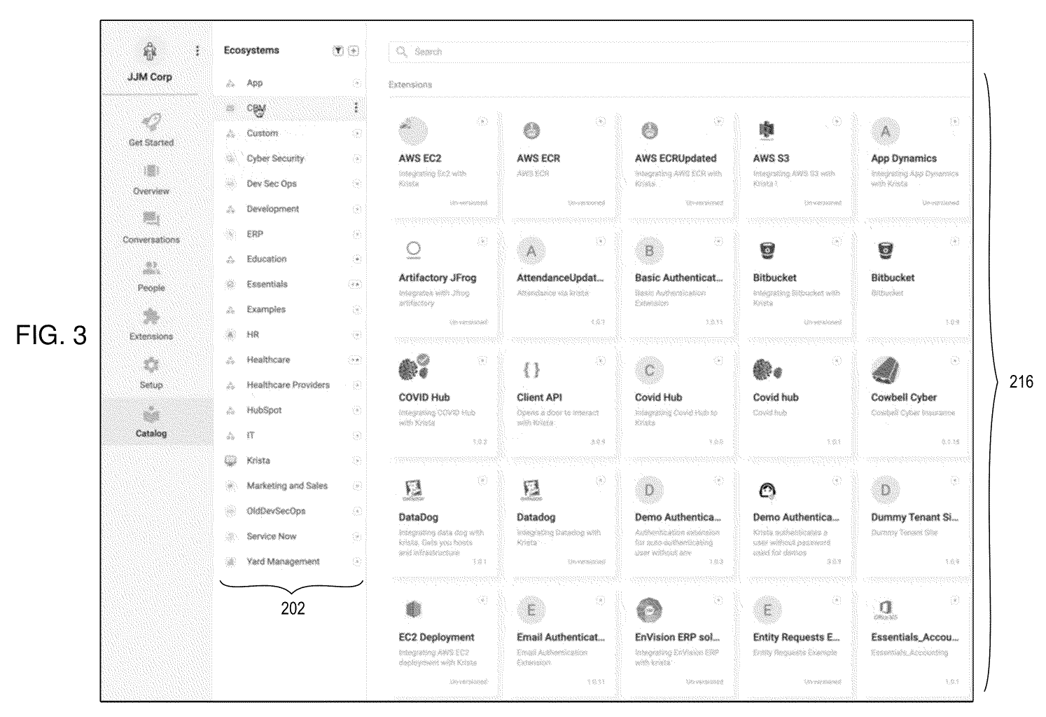

FIG. 3 illustrates a view of a catalog (e.g., global catalog 110 or private catalog 112) that may be provided by workspace studio 104 in accordance with certain embodiments. For example, various views shown herein may be example views shown to a user that is using the workspace studio. In this view, the ecosystems 202 of the catalog are depicted. For example, the ecosystems 202 include Customer Relationship Management (CRM), Cyber Security, Dev Sec Ops, Enterprise Resource Planning (ERP), Essentials (e.g., word processing, spreadsheets, email clients, etc.), Human Resources (HR), Information Technology (IT), and Marketing and Sales, among others.

This view also depicts various extensions 216 of the catalog as well. The extensions may be grouped into extension sets, where an extension set may correspond to a backend system 116 and may comprise one or more extensions 216 for that backend system 116. For example, in the view of FIG. 3 (in which a particular ecosystem has not been selected yet so the extension sets across all of the ecosystems are shown), there is an extension set for Amazon Web Services (AWS) Elastic Compute Cloud (EC2), another extension set for AWS Elastic Container Registry (ECR), and so on. When a particular ecosystem is selected in this view, the extensions that support the requests of that ecosystem may be displayed. When a particular extension set is selected, the individual extensions of that extension set may be displayed. Extensions 216 will be discussed in more detail below.

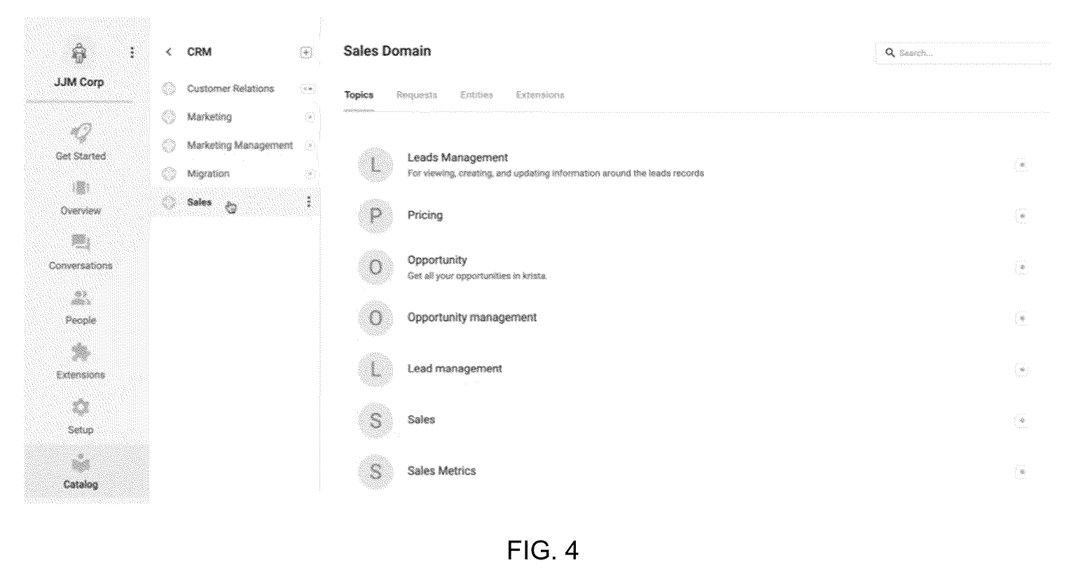

FIG. 4 illustrates a view of an ecosystem 202 that may be provided by workspace studio 104 in accordance with certain embodiments. When an ecosystem 202 is selected, the domains 204 of that ecosystem are displayed. In this example, the CRM ecosystem has been selected and the domains of the CRM ecosystem include Customer Relations, Marketing, Marketing Management, Migration, and Sales.

On a separate section to the right, various types of information associated with a selected domain is displayed. For example, the topics 206, requests 212, entities 214, and extensions 216 of a domain may be displayed in this section (e.g., depending on which header is selected for viewing). In this example, the Sales domain and the Topics header is selected, thus the topics of the Sales domain are displayed. In the embodiment depicted, the topics of the Sales domain include Leads Management, Pricing, Opportunity, Opportunity management, Lead management, Sales, and Sales Metrics.

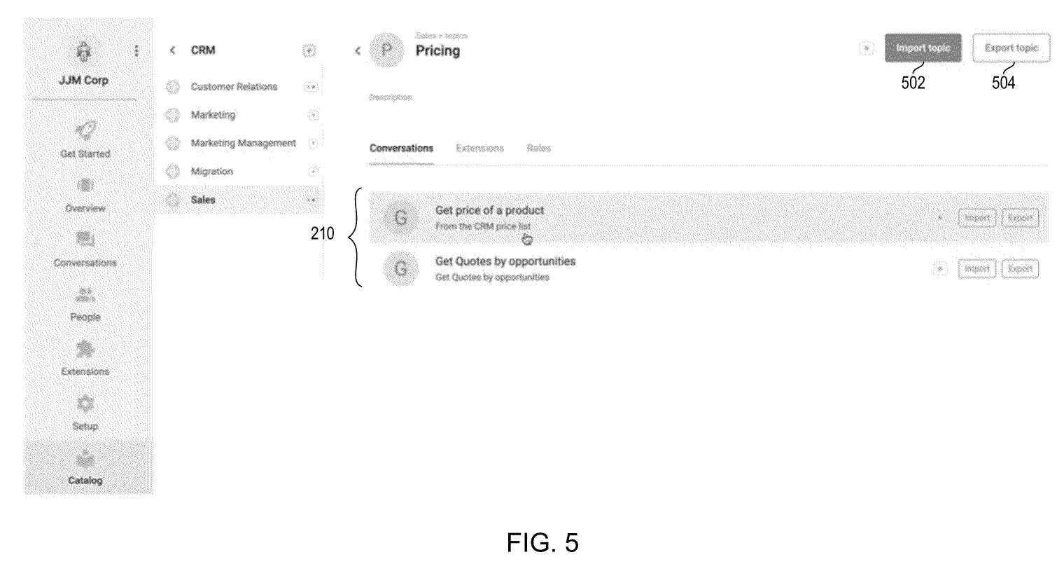

Selecting one of these topics may bring up a view such as that shown in FIG. 5, where the conversations 210 (and other resources, such as extensions 216 and roles 218) of that topic may be displayed (depending on the particular header that is selected). An import topic option 502 to import the selected topic (including its resources, such as conversations and the requests, entities, extensions, and roles utilized by the conversations) into a workspace 108 is also provided (additionally or alternatively, individual conversations and supporting resources may be imported). An export topic option 504 to export the topic into a private catalog 112 is also provided (e.g., an organization may maintain multiple private catalogs and use this option to share data between catalogs). Alternatively, the user may selection the Extensions or Roles header to view the extensions 216 or roles 218 used (and/or available for use) by the conversations in the selected topic.

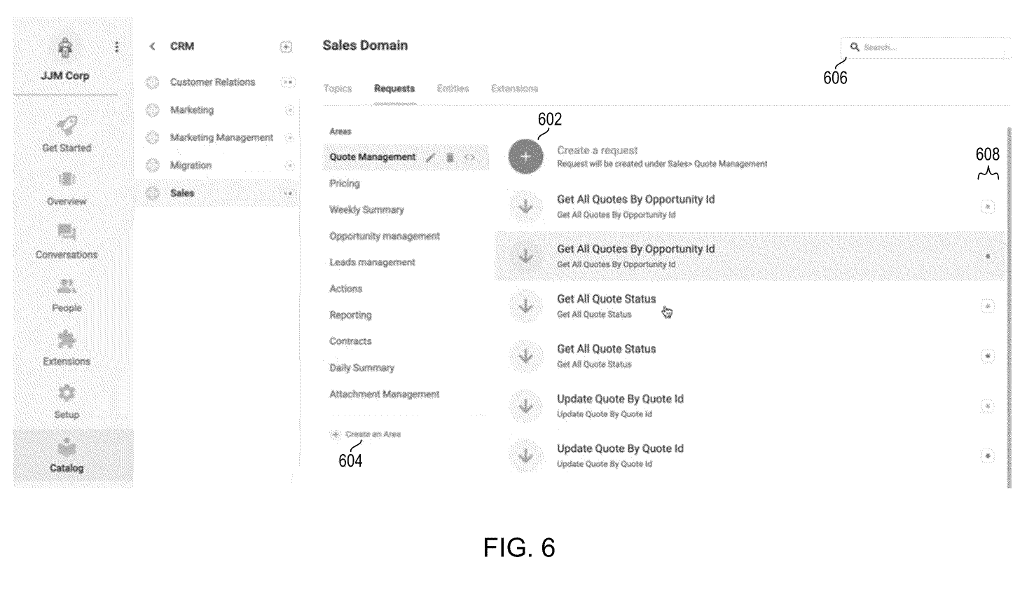

Returning again to the view of FIG. 4, the user may also select the Requests header of the selected domain to view the requests 212 of the domain 204. An example resulting view is shown in FIG. 6, where the requests of the Sales domain are shown grouped by areas 208 such as Quote Management, Pricing, Weekly Summary, and so on. The requests of the selected area 208 (Quote Management in this instance) are shown on the right side. These requests include Get All Quotes By Opportunity Id, Get All Quote Status, Update Quote By Quote id, and so on (this particular view shows duplicate requests because multiple catalogs are displayed simultaneously, though in various embodiments, a filter may be provided such that resources of only one catalog or multiple selected catalogs are shown).

This view also provides a create request interface 602 to create a request 212 in the selected area (the creation flow for a request will be described in more detail below) and a create new area interface 604 to create a new area. Furthermore, this view includes a search bar 606 to search for requests of the domain (and/or for requests of the selected area within the domain). In various embodiments, this search may utilize keyword searching and/or NLP to identify matching requests.

The list of requests 212 also includes status indicators 608. In some embodiments, the status indicators may include different visual effects for different statuses. For example, each status may be represented by a different color. In other embodiments, each status may be represented by a unique shape or text. Example statuses for the requests include draft mode (e.g., in which only the user who created the request can access the request), test mode (e.g., in which selected users can access the request before the request is globally available), and/or a live mode (e.g., in which the request has already been tested and is available for use by anyone with access to a workspace into which the request has been imported). In some embodiments, test data (rather than data from a real backend system 116) will automatically be used when a request in draft mode is executed (unless otherwise specified), while a request in test mode may utilize either test data or actual data from a backend system 116 (depending on the configuration set for the request), and a request in live mode will utilize actual data from a backend system 116.

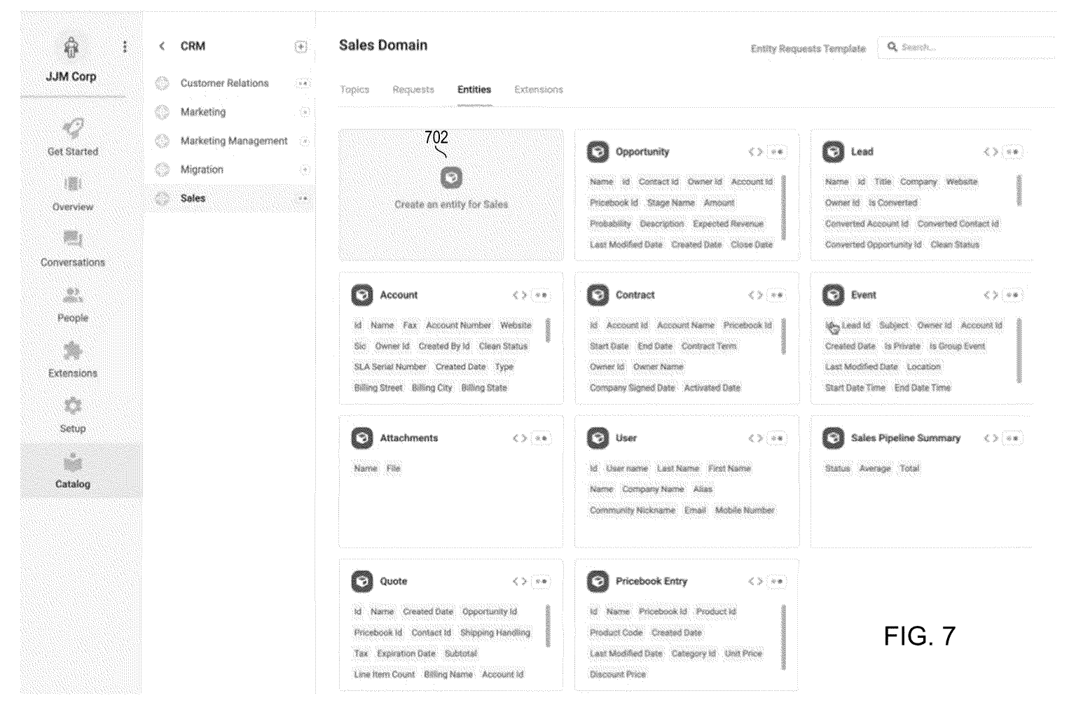

A domain may also include one or more entities 214. An entity 214 may comprise a data object with one or more fields. FIG. 7 illustrates a view of example entities of a domain that may be provided by workspace studio 104. In this example, the Sales domain has entities including Opportunity, Lead, Account, Contract, Event, Attachments, User, Sales Pipeline Summary, Quote, and Pricebook Entry. Each entity includes one or more fields. For example, the Attachments entity has a Name field and a File field. As another example, the Sales Pipeline Summary entity has a Status field, an Average field, and a Total field.

An entity 214 may provide a definition for any number of instances of the entity that may be stored, e.g., by one or more backend systems 116 of an organization or as a managed entity 120 within a storage 118 of system 102 or coupled to system 102. For example, in a real life environment, any number of Accounts or Leads may be present, each having a unique set of values for the fields of the entity. The view of the entities may also include a create entity interface 702 to create a new entity.

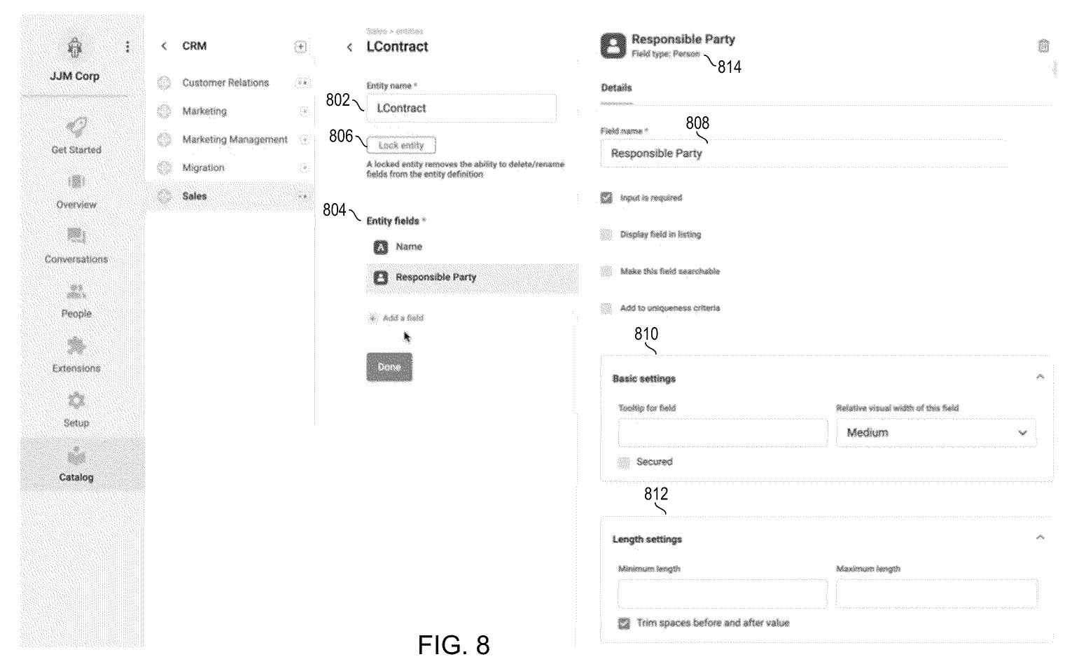

FIG. 8 illustrates a view to create an entity that may be provided by workspace studio 104 in accordance with certain embodiments. As depicted, a name 802 and one or more fields 804 may be assigned to the entity. A lock entity option 806 may specify whether fields may be deleted from or renamed in the entity definition.

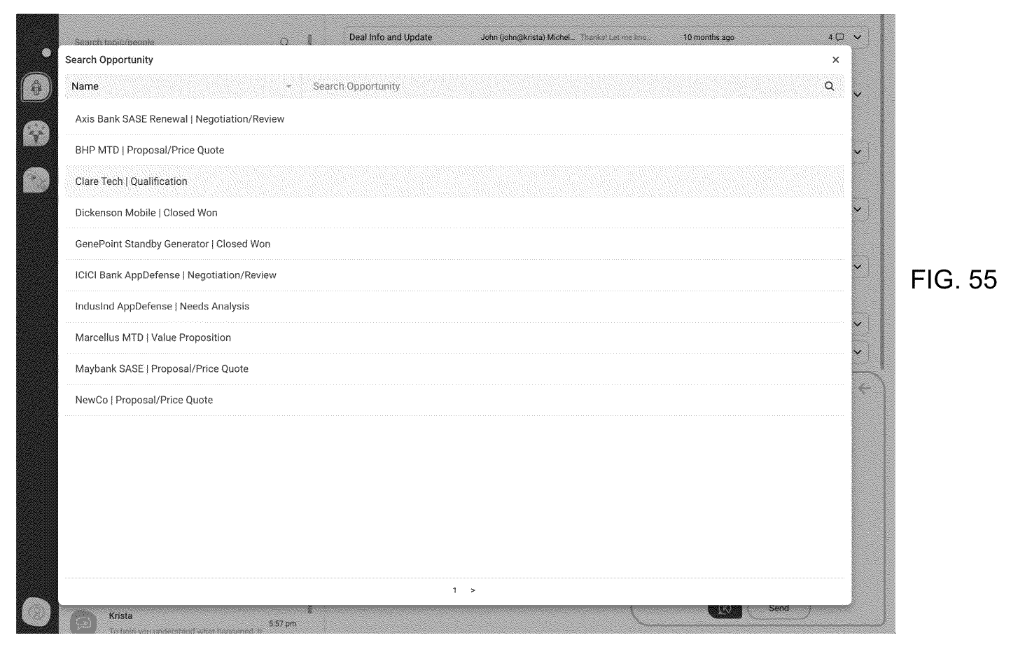

The right side of the view shows parameters for a selected entity field 804. A field may be given a name 808 (Responsible Party in this instance). A field may also have various other parameters. For example, an input is required parameter may specify whether a value has to be supplied for the field when an instance of the entity is created. A display field in listing parameter may allow the author to specify whether the field is part of the basic set of information a person would want to see (e.g., in order to differentiate one entity from another). For example, for an example entity that represents a customer, the customer Id may be unique, but not helpful to a person (whereas fields such as name, address, status of account, etc. may be useful and thus may have this setting checked). In various embodiments, this field may be referenced to determine which fields to include in lists that the system 102 generates (e.g., for display in a client as depicted in FIG. 55 where the name and status fields of the opportunity entity have this parameter selected and are shown responsive to a search for opportunities). A make this field searchable parameter may allow the author to specify whether the field may be included in NLP searches, e.g., initiated by a user in a channel 114, as well as for entity selection by the user. An add to uniqueness criteria parameter may specify whether the field is part of what makes one record unique from another (e.g., similar to a primary key in a relational database).

Basic settings 810 may allow specification of a tooltip for the field that will be displayed in association with the field to aid a user. A relative visual width of this field setting may provide a hint used by a channel 114 for rendering purposes as to how much space will be needed to display the field. A secured setting may specify that the information is private and thus may be rendered similar to a password field. This field may be encrypted for transfer and may not be logged the same as non-secured info is.

Length settings 812 may specify a minimum length and a maximum length for text that a user may enter for the field (e.g., to limit the entry to a system supported length). Length settings may also include a setting for trimming spaces before and after the value of the field, e.g., when extraneous spaces are entered by a user inputting the value. A data type 814 may also be specified for each field. In the embodiment depicted, the Person data type is assigned to the Responsible Party field.

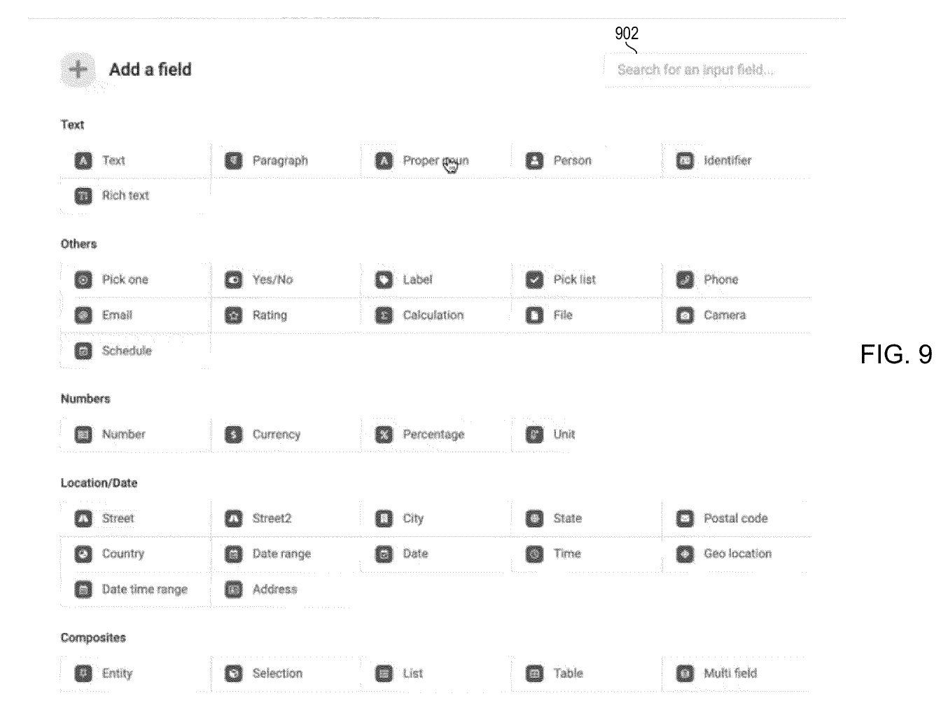

FIG. 9 illustrates a view to select a data type for an entity field 804 that may be provided by workspace studio 104 in accordance with certain embodiments. While any suitable data types are contemplated herein, the interface of FIG. 9 includes Text data types (e.g., Text, Paragraph, Proper noun, Person, Identifier, Rich text), Others data types (e.g., Pick one, Yes/No, Label, Pick list, Phone, Email, Rating, Calculation, File, Camera, Schedule), Numbers data types (e.g., Number, Currency, Percentage, Unit), Location/Date data types (e.g., Street, Street2, City, State, Postal code, Country, Date range, Date, Time, Geo location, Date time range, Address), or Composites data types (e.g., Entity (e.g., where an entity field 804 may be a different entity 214), Selection (e.g., where an entity field 804 is selected from a plurality of predefined values), List (e.g., comprising a plurality of values), Table (e.g., comprising a multi-dimensional array of values), and Multi field (e.g., comprising a plurality of values of different data types). This view may also include an input field search interface 902, allowing the author to search for field types or entity names.

In various embodiments, an entity 214 created by a user is automatically placed into a private catalog 112 associated with an organization of the user (as opposed to being placed in the global catalog 110 which is accessible to multiple organizations and the content of which may be controlled by a central entity).

The entities 214 may be utilized within requests 212 and/or conversations 210. For example, a conversation 210 may access and/or modify one or more field values of one or more instances of one or more entities 214. At the conversation level, an author may specify (e.g., via an extension selection) whether an entity is to be stored to and/or retrieved from a particular backend system 116 or managed entities 120. Implementations in which entity instances are stored in managed entities 120 may be particularly useful in cases where data needs to be located in a particular geographical location (e.g., due to its sensitive nature) or where an organization does not desire to set up a backend system 116 to store the data.

Thus, a declared entity 214 (e.g., the definition of the entity) may be used in NLP searches (e.g., for the entity or to identify relevant conversations and/or requests) and within the definition of requests 212 that reference the entity, while instances of the entity (e.g., with actual data in one or more fields of the entity) may be stored in one or more backend systems 116 or as managed entities 120 in storage 118.

A domain may also include a plurality of requests 212 grouped by areas 208. A request 212 may provide a template for an interaction with one or more backend systems 116 and may have a format that is easily understandable by authors that create automation flows (e.g., conversations 210) that utilize the request. In various embodiments, a request may include parameters such as a title, a description, one or more inputs, and one or more outputs (in some embodiments an author of an organization may create the request and supply these fields). The name and other parameters of a request may be easily understandable by a human (e.g., as opposed to an obscure or generic name and/or parameters of an API to a backend system 116 or a complex block of code that is required to interact with a backend system). One or more extensions may be used in association with (e.g., mapped to) the request to perform the action(s) represented by the request (e.g., as described in the title and/or description of the request) on one or more backend systems 116. In effect, an extension translates a request having a format intuitive to a user (e.g., a typical business user) to a format compatible with a backend system 116. Thus, extensions translate what a human would say (e.g., using business domain specific language) to programming constructs (e.g., API calls, RPA scripts, etc.).

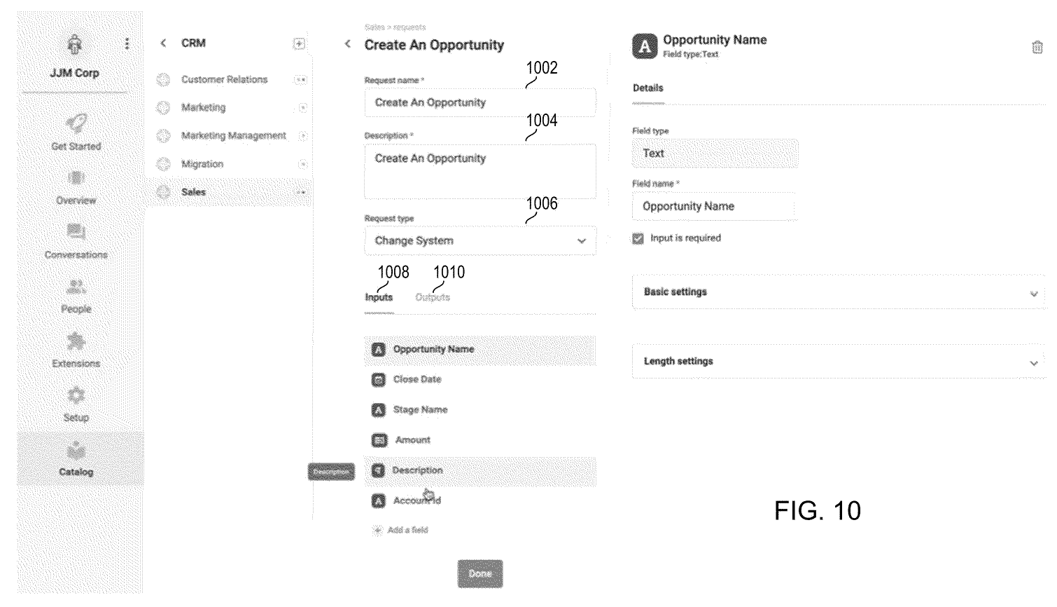

FIG. 10 illustrates a view that may be provided by the workspace studio 104 for creating (or editing) a request 212 in accordance with certain embodiments. As shown, the author of the request may enter a name 1002 (also referred to as title) and a description 1004 for the request. The name of the request may describe an action that is to be effectuated (e.g., by a backend system 116) by performance of the request. Although not shown, in some embodiments, the author may also provide one or more synonyms for the title of the request. The author may also select where in the hierarchy of the catalog the request should appear. In the embodiment depicted, the new request was initiated from within a particular ecosystem (CRM), domain (Sales), and area (requests), so the location within the hierarchy may be explicitly understood by the workspace studio. In other embodiments (for example, if the author initiates the request creation outside of the location within the hierarchy), then the author may specify an ecosystem, a domain, and an area for the request.

The author may also specify a type 1006 of the request 212. For example, the type 1006 may be selected from a plurality of types, such as change system (e.g., a request that has the ability to change data stored by a backend system 116), query system (e.g., a request that will not change the data stored by a backend system 116), and wait for event (e.g., a request that will be executed responsive to a system event, such as an event that occurs at a backend system 116). In some embodiments, the request types may be used (e.g., during a rollback action) to determine whether to instruct an extension to try to restore the state of the data of the backend system(s) accessed during a conversation. For example, if a request type is query system, no action need be taken since the data of the backend system would not have been changed, whereas if a request type is change system, then data at the backend system may need to be restored to its previous state (e.g., if the data was actually changed and the backend system supports an undo operation or the data can otherwise be restored to its previous state).

Furthermore, an author may specify one or more input fields 1008 and/or one or more output fields 1010 for the request 212. In some embodiments, the field type may be selected from a group of available field types that are the same field types available when creating an entity as described above with respect to FIG. 9 (or the grouping of available field types may differ in any suitable manner in other embodiments). The author may provide a title for each field (thus requests may facilitate easy interaction between humans and the backend systems, since humans will intuitively understand the inputs supplied to the backend systems and the backend systems will respond with outputs that are easily understood by humans).

Other settings may be available for each field. For example, as in the entity definitions, an author may select whether input is required for the field when the request is called. The field may also have basic settings and length settings, which may be similar to the basic settings and length settings for fields of an entity as described above. Any suitable constraints on values of the field may be configured (and the options for setting such constraints could vary depending on the type of the field). As just one example, for a number field or a date field, a range may be specified for allowable values (and/or particular values that are disallowed may be specified).

In various embodiments, when adding an input or output field, an author may search for a preexisting field to include as an input field or output field. The search may cover any suitable collection of fields, such as fields of entities and/or fields of other requests and could include all fields in a catalog, or a subset of fields (e.g., only the fields in the same ecosystem, domain, and/or area as the request being created). When a preexisting field is selected, that field (and its settings) may be added to the request being created. In some embodiments, an author may additionally or alternatively be able to search for a field type for an input field or output field.

In various embodiments, system 102 may directly ingest APIs of backend systems 116 and auto-generate requests 212 based thereon. For example, if a backend system 116 has an API that generally tracks what a human would ask for, then instead of requiring an author to build requests 212 (e.g., using the flow described above) for that backend system 116, system 102 may generate the requests and corresponding extensions automatically (e.g., without any input from a user) based on the API. For example, for a particular API function, a request 212 may be generated by mapping parameters of the API function to parameters of the request 212. For example, one or more of a title, input names, input types, output names, or output types of an API function may respectively be used as (or otherwise mapped to) a title, input names, input types, output names, or output types of the request 212. The extension 216 for the request 212 may simply include a call to the API. If any conversions for inputs or outputs are to be performed, conversion logic may also be placed in the extension. In some embodiments, entities 214 may also be autogenerated by system 102 based on API definitions (e.g., for data structures or variables).

When a request 212 is initially created, it does not include logic to perform the action(s) specified by the request with respect to one or more backend systems 116. Instead, the request may be reviewed by a developer (e.g., of the same organization as the author of the request, a developer for the organization that controls system 102, the author of the request, or some other person or entity) with expertise in one or more backend system(s) 116 that can service the request 212, and the developer may create one or more extensions 216 for the request, where an extension 216 includes the code that interacts with a backend system 116 to accomplish the desired actions of the request. An extension may cause a backend system 116 to read data, analyze data, update data, or take other actions. An extension may include any suitable programming code, such as one or more API calls, robotic process automation scripts, translation logic (e.g., to translate between formats of field values of a request to formats used by a backend system 116), or other suitable logic.

Thus, a request 212 may eventually be mapped to an extension 216 that implements the action(s) specified by the request with respect to one or more backend systems 116. When that request 212 is called, the associated extension 216 will be executed.

Accordingly, the author of the request 212 does not need to perform the low level programming tasks required to interact with the backend systems, but merely needs to describe the function of the request in terms intuitive to a human and specify the inputs and outputs of the request. The author of a request may be agnostic as to which backend system 116 will be used to perform the request. In some instances, a developer may create multiple extensions for the request (e.g., one extension 216 for each backend system 116 that is capable of performing the request). Thus, the same request could be used to access multiple backend systems that perform similar functions, thus rendering similar backend systems interchangeable.

This flow is drastically different from existing development flows, where backend systems have APIs and authors creating automation flows are forced to integrate their flow with the API. Instead, in this embodiment, the reverse order is performed: a request is specified by an author first and then a developer creates the logic to map the specified request to the backend system. This flow enables an author that is not experienced in programming to integrate systems to perform automation flows.

If a request 212 is not yet mapped to an extension 216 (or if the request is otherwise configured to use test data, e.g., because the request is still being tested before being deployed), then test data generated by system 102 may be used for outputs of the request when the request is called in a conversation. Test data generated by the system 102 may comply with any suitable constraints set for the fields of the request.

Topics 206 may also have defined roles 218 for users of an organization along with access permissions per role for various resources of the organization. The roles 218 will be discussed in further detail below.

In addition to creating requests, authors may also create automation flows referred to herein as conversations in the workspace studio 104 using human language constructs. Simple and intuitive building blocks may be provided to allow an author that is not familiar with the technical aspects of software coding to construct these conversations. These building blocks are modeled after the way humans interact with each other and with systems.

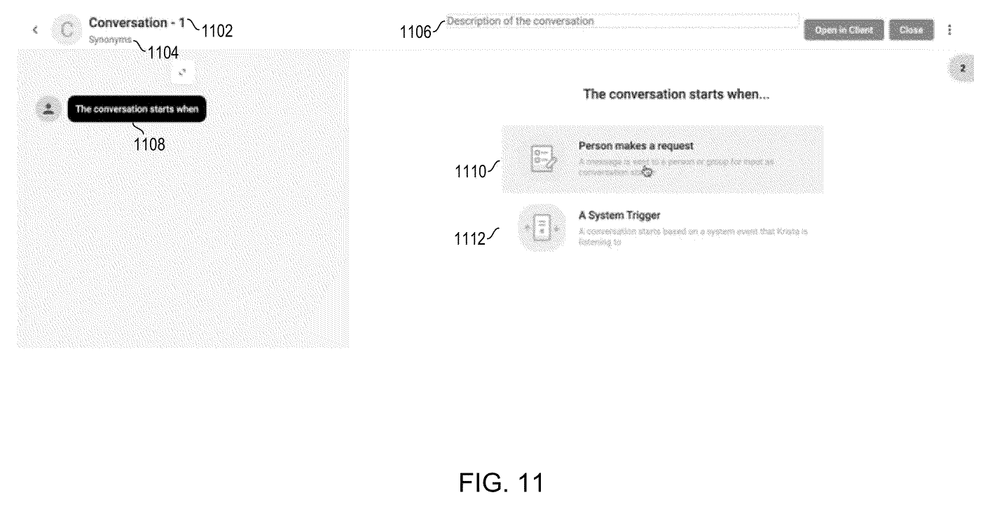

FIGS. 11-36 depict views that may be provided by workspace studio 104 to allow an author to create and/or edit a conversation 210. In the view of FIG. 11, various parameters of the conversation 210 may be generated or edited, such as a name 1102 of the conversation, synonyms 1104 for the name of the conversation, and a description 1106 of the conversation. The conversation may also be assigned (whether implicitly by the workspace studio 104 or explicitly as defined by the author) to a location within the hierarchy of the catalog (e.g., the ecosystem, domain, and/or topic applicable to the conversation).

FIG. 11 also depicts an instance of a conversation start block 1108 that defines how the conversation may be initiated. The conversation start block 1108 is shown within a section on the left referred to herein as a program flow (in which the other conversation blocks will also be placed). The section on the right side of the view may display configuration options for the block selected in the program flow. With respect to the conversation start block, the author may specify whether the conversation is to be initiated when a person makes a request (e.g., a user enters a message via a channel 114 with contents that are determined through a search operation to match the conversation or the user selects a conversation starter from a group of displayed conversation starters) by selecting option 1110 or when a system provides a trigger (e.g., a system event that is being listened to by a request of system 102 occurs) by selecting option 1112.

By way of example only (as any suitable conversation starters may be created), potential conversation starters could include user provided messages such as “aggregate pipeline information”, “check opportunity status”, “obtain pricing approval”, “collect sales metrics”, or “check available delivery dates”; or system triggers such as the closing of a deal in a CRM system, a new order being received, or a particular time of the week being reached (e.g., every Thursday at 11:00 AM).

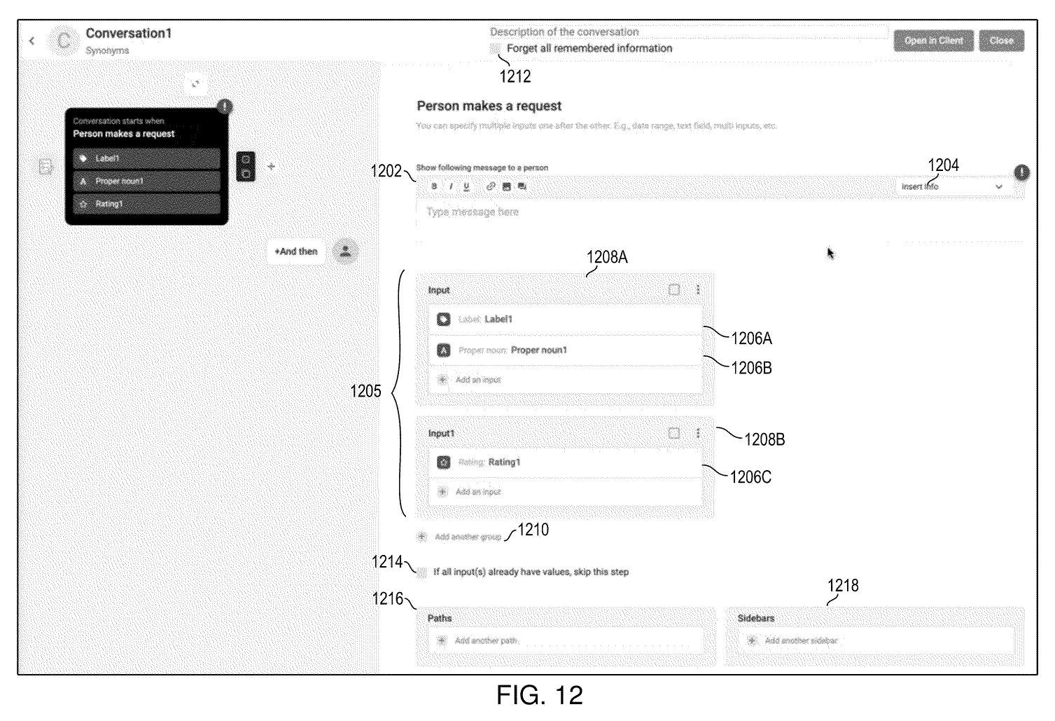

FIG. 12 depicts a view that may be displayed by the workspace studio 104 after option 1110 (person makes a request) is selected for the conversation start block 1108. This view allows the user to specify a message in a message interface 1202 to be shown to a user that initiates the conversation through a channel 114. The message may include text supplied by the author, media, inserted information (e.g., through insert info interface 1204), or other suitable information.

As will be illustrated in further detail below, the insert info interface 1204 may allow insertion of any variables that are active within the conversation (e.g., up to the point of the corresponding conversation block) into the message specified within message interface 1202. Such variables may collectively be considered conversation information. The variables may each include any number of fields and may be created (e.g., by asking a person or system for information during execution of a conversation block, by creating variables as part of the execution flow, etc.) or accessed (e.g., entities may be accessed from a backend system) during the conversation and may either be cleared when the conversation is over (e.g., if the Forget all remembered information field 1212 is asserted for the conversation, if a threshold amount of time has passed since the conversation ended, or if a user of a client provided by channel 114 specifically requests that the conversation information be cleared) or may be allowed to persist through one or more subsequent conversations (e.g., to avoid the burden of requiring the user to repeatedly enter the same information).

The view of FIG. 12 also provides the author with an input interface 1205 to specify one or more inputs 1206 to be requested from the user when the conversation is executed. These inputs may each include one or more fields and may become variables within the conversation information. The fields or inputs to a conversation block may have any suitable characteristics of entity fields or request fields. For example, the fields of the inputs 1206 may each be assigned a data type as well as any other suitable parameters (such as those described above with respect to entity fields or request fields). In the embodiment depicted, the inputs 1206 may be arranged in groups 1208. For example, group 1208A may include inputs 1206A and 1206B while group 1208B includes input 1206C. The author also may be presented with an option 1210 to add another group. Input groups may be used to provide a hint during rendering of the conversation by a channel 114 (e.g., to instruct the groups of inputs to be requested in separate pages), which may facilitate favorable display of the requests across many different channel types (and simplify data entry for the user).

A skip step interface 1214 may allow the author to specify whether the requests for the inputs may be skipped if all inputs 1206 already have values. For example, as described above, in some instances the conversation information may be carried over from a conversation to one or more other conversations (e.g., conversations within the same topic, same domain, same ecosystem, etc.). Thus, if the input values have already been supplied in a previous conversation and are carried over to the current conversation (instead of being cleared explicitly by the user or cleared based on settings of the previous conversation or other suitable settings), the user is not asked again for the inputs, but rather the values of the corresponding variables for the inputs from the previous conversation may be used in the current conversation. In some embodiments, instead of skipping the input request altogether, the values of inputs that are known may be supplied to the user and the user may be given the option to confirm (or edit) the values of the inputs.

The view may also include a paths interface 1216 in which an author may add one or more paths that may be taken in program flow of the conversation. In various embodiments, each path may be given a title by the author and may be rendered as a button or the like in the client with the title of the path by the channel 114 when a conversation is executed by a user and the path may be executed if the user selects the button. A path may include instances of any suitable conversation blocks (such as those described below) and may end with an instance of an end path or conversation block (which will also be described below). In various embodiments, any number of paths may be taken before the conversation proceeds to the next conversation block after the conversation block including the paths.

The view may also include a sidebars interface 1218 in which an author may add one or more sidebars that may be executed in the conversation. A sidebar may include one or more conversation blocks that will be executed before the conversation moves past the conversation block that includes the sidebar. For example, a sidebar may allow the pausing of the conversation flow to allow a user to consider additional information. For example, during execution of a conversation a manager could be asked to approve time off for an employee in a message. A sidebar may be provided in association with the conversation block that shows the message requesting approval to allow the manager to see additional information if desired (e.g., the production plan for the week that is requested off, a history of leave requests for that employee, etc.).

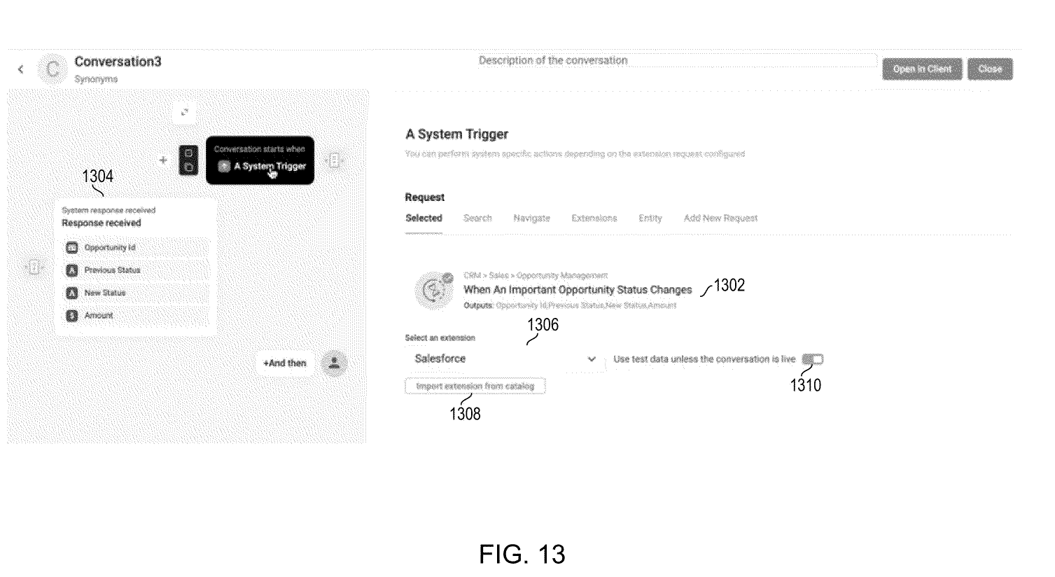

FIG. 13 depicts a view that may be displayed by the workspace studio 104 after option 1112 (a system trigger) is selected for a conversation start block (e.g., 1108). In this instance, the author may map a request 212 with type “wait for event” (e.g., as described above) to the conversation start block and when the event specified by the request occurs, the conversation may start. In some instances, the request 212 may be mapped to an extension 216 that includes logic to detect a triggering event. In various embodiments, the event may be detected by the extension of the request in any suitable manner. For example, the extension may invoke an API for a backend system 116 that will return when a triggering event is detected by the backend system 116, the extension may monitor one or more other requests that utilize the backend system to determine whether those requests have caused the triggering event, the extension may periodically poll a backend system 116 to determine whether the event has occurred, or the extension may detect the event in another suitable manner.

In the embodiment depicted, a request 1302 titled “When An Important Opportunity Status Changes” is used as the triggering request to initiate the conversation. The request is mapped via an extension to a Salesforce backend system 116. In this example, the request may execute (and the conversation may be initiated) when the status of an important opportunity changes in an organization’s Salesforce instance (which could occur by execution of a conversation 210 or request 212 or through other means such as a user accessing Salesforce directly and change an opportunity status). This request does not have any inputs, but has outputs of Opportunity Id, Previous Status, New Status, and Amount. When this request is mapped to the conversation start block, an instance of a system response received block 1304 may be automatically added to the flow and may include the outputs of the mapped request. The system response received block will be described in more detail below.

The view may provide various headers providing functionality depending on the header selected. For example, in the embodiment depicted, a Selected header is selected, resulting in the display of the selected request and an extension interface 1306 to select an extension for the request (e.g., from among one or more available extensions) or another interface 1308 to import an additional extension from a catalog. Another interface 1310 may allow the author to specify whether test data (e.g., fictitious data generated by system 102 as opposed to data from an actual backend system 116) is to be used (e.g., as the data for the outputs of the request) or not when the conversation is not yet live.

A Search header may allow the author to search for other requests. As an alternative to searching for a request, an author may select the Navigate header and may navigate through the hierarchy of requests (e.g., by selecting an ecosystem, domain, and/or area after which the requests within that ecosystem, domain, and/or area will be displayed for selection). The Extensions header may allow the author to view the supported extensions for the requests, the Entity header may allow the author to search for or create an entity (e.g., to be utilized in association with the system trigger), and the Add New Request header may allow the author to create a new request that could be used to detect the trigger to initiate the conversation.

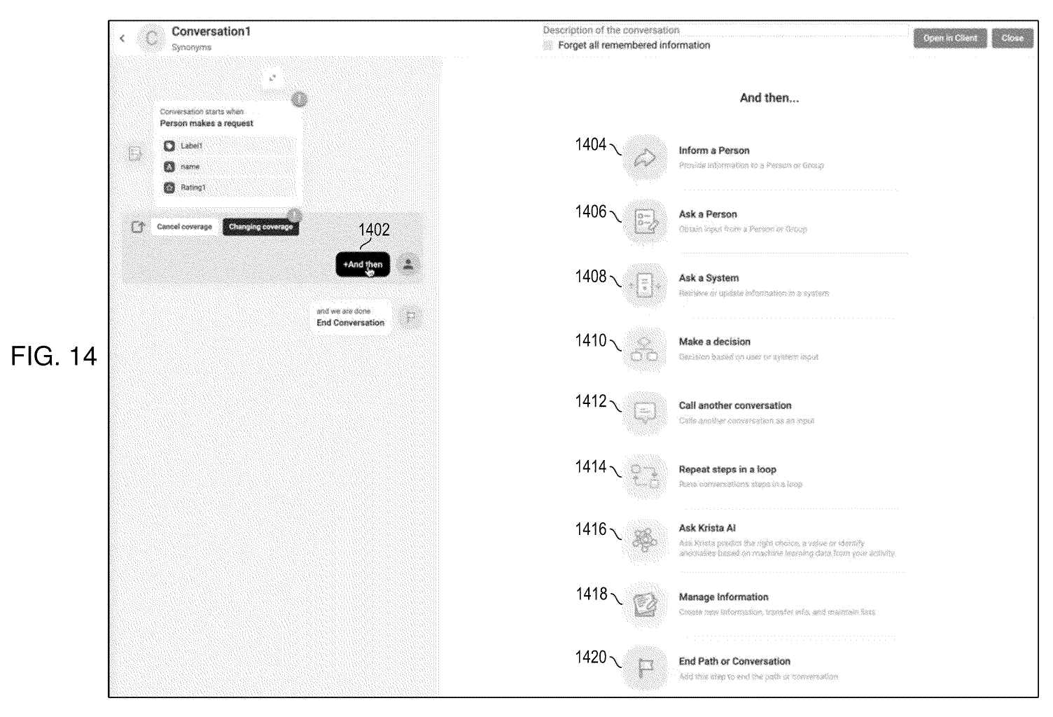

FIG. 14 depicts available conversation blocks that may be instantiated within a conversation. For example, the conversation blocks may be shown (e.g., simultaneously with the program flow) by workspace studio 104 when an author selects a placeholder block 1402 (which in some embodiments may display the text “+And then”). In the depicted embodiment shown, the placeholder block 1402 is part of the “Changing coverage” path, but the placeholder block 1402 could alternatively be part of the main conversation flow (e.g., as shown in FIGS. 12 and 13), a sidebar, or other portion of the conversation.

In the depicted embodiment, the available conversation block types include: inform a person block 1404, ask a person block 1406, ask a system block 1408, make a decision block 1410, call another conversation block 1412, repeat steps in a loop block 1414, ask Krista Al block 1416, manage information block 1418, and end path or conversation block 1420. In other embodiments, one or more of these conversation block types may be omitted and/or other conversation block types may be provided.

As a brief introduction to each conversation block, the inform a person block 1404 may be used to provide information to a user or group of users (e.g., via one or more channels 114). The ask a person block 1406 may be used to request information from a user or group of users (e.g., via one or more channels 114). The ask a system block 1408 may be used to retrieve or update information in a backend system 116. The make a decision block 1410 may be used to make a decision based on user or backend system input. The call another conversation block 1412 may execute another conversation. The repeat steps in a loop block 1414 may run one or more conversation blocks in a loop. The ask Krista Al block 1416 may ask an artificial intelligence system for a prediction (e.g., of a value or decision), to identify whether a field value is an anomaly, or perform other suitable Al function. The manage information block 1418 may allow for creation of new variables or manipulation of existing variables in the conversation information. The end path or conversation block 1420 signifies the end of a path or conversation.

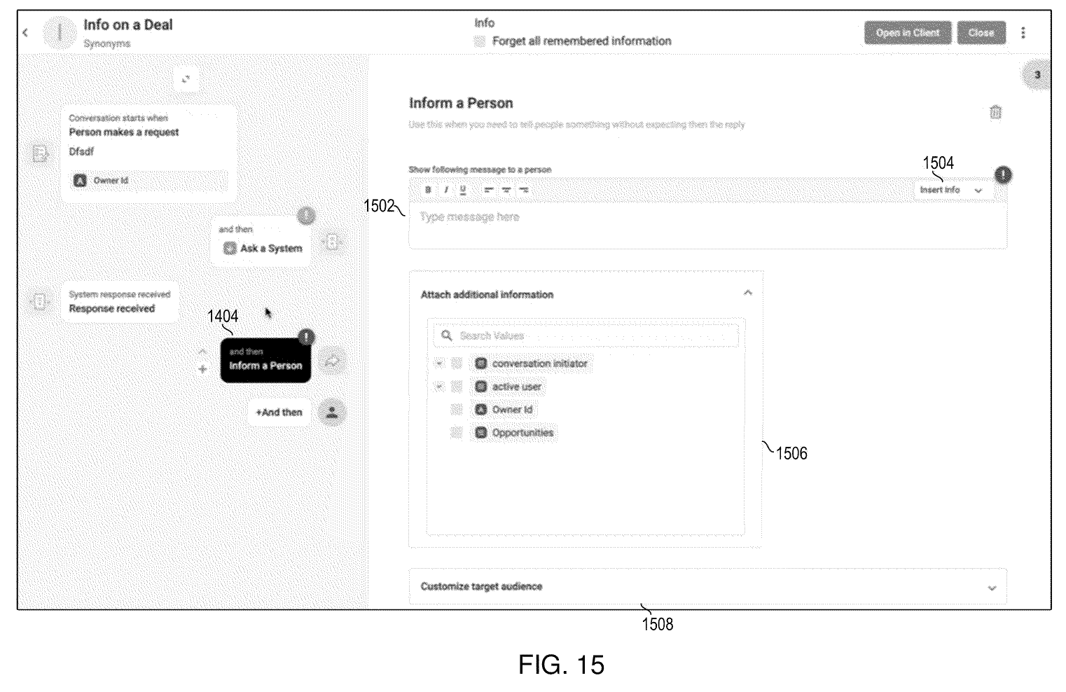

An inform a person block 1404 may be used to provide information to a user or group of users (e.g., via one or more channels 114). As depicted in FIG. 15, an inform a person block 1404 may include a message interface 1502 for the user to type a message, to insert one or more media files (e.g., pictures, videos, etc.), or to insert variables (or individual fields) from the conversation information using insert info interface 1504. A variable (or field thereof) may be inserted inline with text supplied by the author. For example, if employee and salary are variables present in the conversation information with respective values of John Smith and $75,000, message interface 1502 may include a message such as “employee’s salary is salary.” and when the block 1404 is executed during a conversation it may be rendered through a channel 114 as “John Smith’s salary is $75,000.”

Similar to the insert info interface 1504, the attach additional information interface 1506 may allow the user to select one or more variables (or fields thereof) from the conversation information to attach to a message displayed to one or more users. In various embodiments, values for variables provided via the attach additional information interface 1506 may include identifying information (e.g., a title of the variable) whereas values for variables provided via the insert info interface 1504 are merely displayed as the values themselves. In various embodiments, the formatting of information provided in a message to a user from the insert info interface 1504 and the insert info option 1504 may be dependent on the channel 114 used to display the message (e.g., information provided via insert info option 1504 may generally be rendered like a text message to flow similar to human language while information provided via attach additional information interface 1506 may be provided in a table or figure).

In various embodiments, only the variables that are part of the conversation information up to the inform a person block 1404 may be included as options for insertion within the insert info interface 1504 or as options for attach additional information interface 1506. In the depicted example conversation, at the point of the inform a person block 1404, the available variables are conversation initiator (e.g., a variable for the person that initiated the conversation via a channel 114, this variable could have fields with known information about this person, such as name, roles, manager, etc.), active user (e.g., whoever is currently interacting with the conversation, this would be the same person as the conversation initiator at the time the conversation is started, but could change to another user as the conversation progresses, e.g., depending on who is being asked for input in an ask a person block), Owner Id (e.g., a variable that is listed as input for the conversation start block), and Opportunities (which, e.g., could be returned in the system response received block above the inform a person block 1404).

The customize target audience interface 1508 may allow the author to control who the information specified in message interface 1502 or attach additional information interface 1506 is shown to when the inform a person block 1404 is executed within the conversation. In some embodiments, the customize target audience interface 1508 may allow the author to specify one or more particular users (e.g., by name or by a variable in the conversation information) that should receive the information. Additionally or alternatively, the author may specify one or more roles, and all users having those specified roles may receive the information.

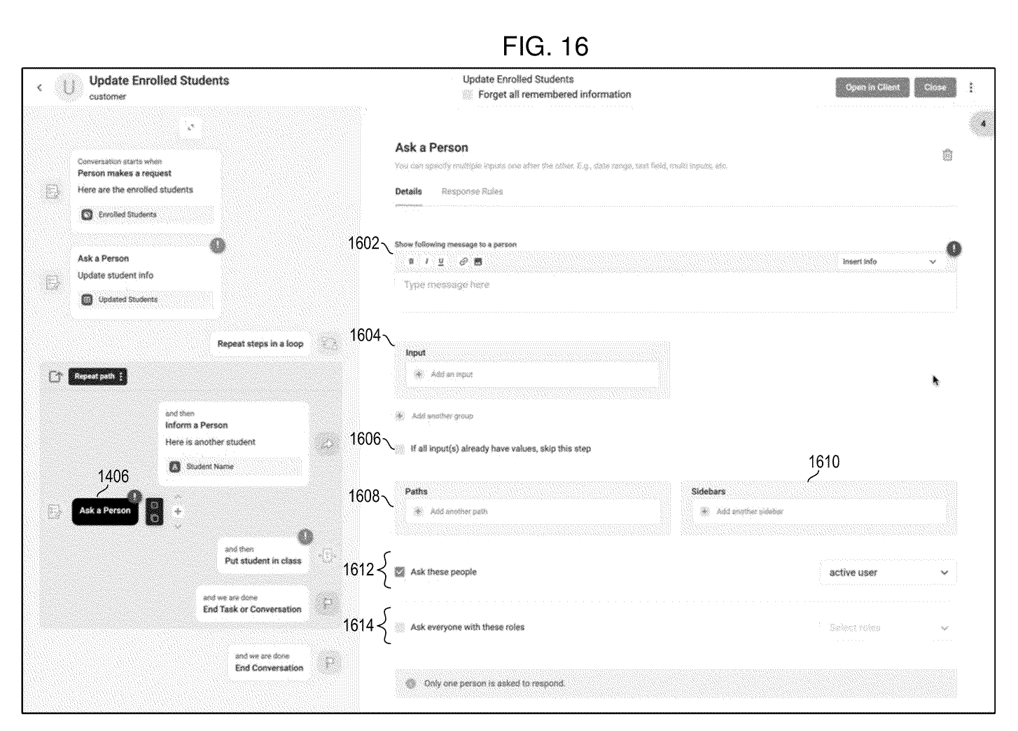

The ask a person block 1406 may be used to request information from a user or group of users (e.g., via one or more channels 114). In the embodiment depicted in FIG. 16, the ask a person block 1406 includes a Details header and a Response Rules header.

The settings shown under the Details header may include a message interface 1602, an input interface 1604, a skip step interface 1606, a paths interface 1608, a sidebars interface 1610, an ask these people interface 1612, and an ask everyone with these roles interface 1614.

Message interface 1602 may allow the author to specify a message to be provided to one or more users, e.g., in conjunction with asking for one or more inputs from the users. The message interface 1602 may include any of the characteristics of message interface 1202 or 1502 described above. Similarly, input interface 1604, skip step interface 1606, paths interface 1608, and sidebars interface 1610 may include any suitable characteristics of input interface 1205, skip step interface 1214, paths interface 1216, and sidebars interface 1218 respectively.

Input interface 1604 may allow the user to specify one or more inputs to be requested from one or more users. Ask these people interface 1612 may include a binary check box that specifies whether a message asking for the input(s) as specified by the ask a person block 1406 is presented to one or more specific users. Interface 1612 may also allow the author to specify one or more specific users, such as a user by name, a user represented by a variable (e.g., the conversation initiator, active user, manager of active user, etc.). Ask everyone with these roles interface 1614 may include a binary check box that specifies whether a message asking for the input(s) as specified by the ask a person block 1406 is presented to one or more people have a specified role (or roles). Interface 1614 may also allow the author to specify one or more roles from a collection of roles 218 (e.g., roles that are configured for the topic 206 to which the conversation 210 belongs). When a role is selected in interface 1614, the message asking for the input(s) may be presented to all users having the selected role.

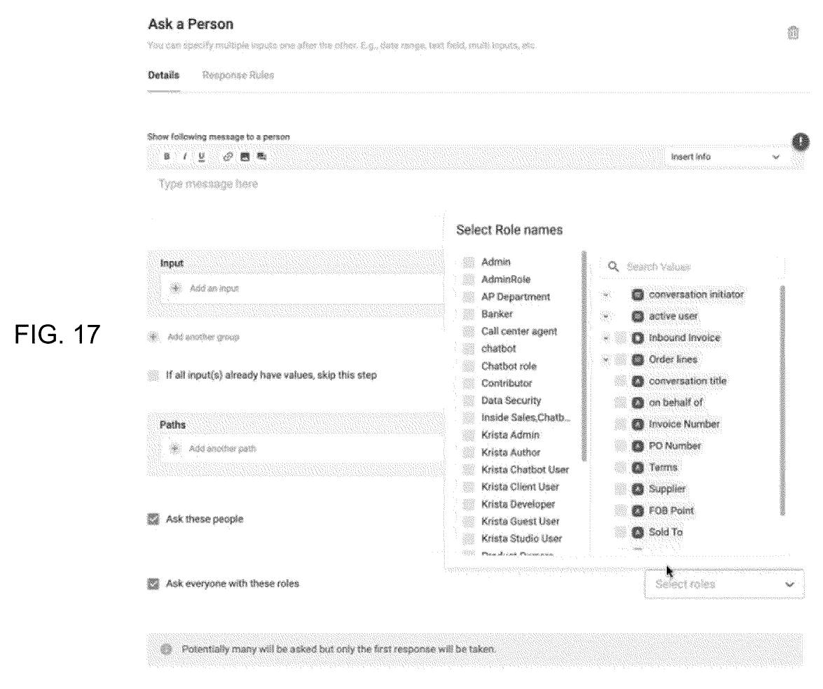

FIG. 17 illustrates example selection options that may be provided by interface 1614. As depicted, various roles are shown along with checkboxes in order to allow one or more of the roles to be selected. Along with the roles, variables of the conversation information are shown to the right. In some situations, one or more of these variables (or fields thereof) may dynamically specify one or more roles, such that when these variables or fields are selected the corresponding people having those roles will be asked (an inform a person conversation block may operate similarly). Such embodiments may allow dynamic determination of one or more persons to which a message is to be presented, e.g., when the specific person(s) are not known at the time the conversation is authored.

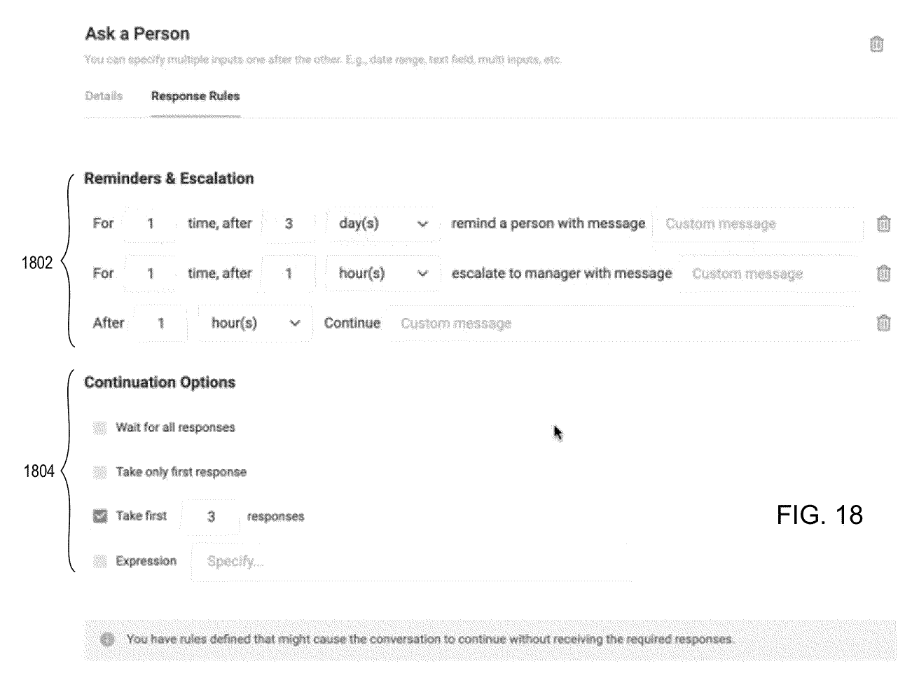

FIG. 18 illustrates example settings that may be shown when the Response Rules Details header is selected. This view includes a reminders & escalation interface 1802 and a continuation options interface 1804. Interface 1802 may allow the author to set conditions under which reminders may automatically be sent to request the input(s) from the users specified in the ask a person block 1406.

In the embodiment depicted, interface 1802 may allow the author may specify the number of times and the interval at which the one or more users will be reminded if they do not respond with the input(s) as well as provide a custom message for the reminder (e.g., which may be included with another message specifying the input(s) requested).

Interface 1802 may also allow the author to specify the number of times and the interval at which a manager (or managers) of the one or more users may be provided a custom message if a respective user has not provided a response with the input(s).

Interface 1802 may also specify how long to wait for the desired responses until continuing with the flow of the conversation (in this example, the duration is set to 1 hour). When this time period has been reached, a custom message that is set by the author may be provided to the one or more users that have not responded.

Thus, in various embodiments, when an ask a person block is executed in a conversation and the system 102 does not receive a response (or all required responses), the system 102 may automatically follow up with the user (or users) that have not yet responded (e.g., after a threshold amount of time has passed) or may escalate the issue (e.g., to one or more managers).

Interface 1804 may specify settings for continuing the flow. For example, the author may require that responses be received from each user that is specified in the block 1406 before execution of the flow of the conversation resumes. As another example, the author may specify that only the first response is used as input and the flow may continue after this response is received. As yet another example, the author may specify that the first X number of responses (where X is any suitable integer) will be used as input, and the flow may continue after the X responses are received. As yet another example, the author may specify any suitable expression (e.g., utilizing any variable values from the conversation information or other suitable information as well as mathematical or logical operators) which when met may result in continuation of the flow (e.g., the author could specify that responses have to be received from at least two role types, from a certain user if a particular threshold for a variable value is met, etc.).

Thus, the ask a person block 1406 may be modeled to perform the same types of actions a human may take when asking for information (e.g., by reminding others, escalating the issue when a response is not received, by continuing on after a certain amount of time has passed or other response conditions are met, etc.).

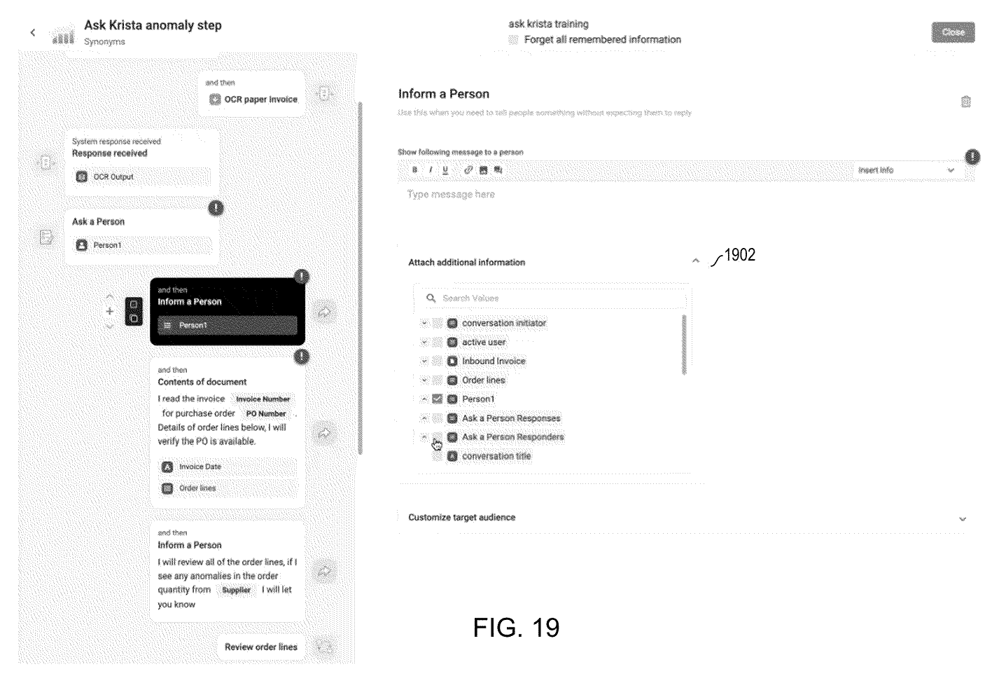

An ask a person block 1406 may result in additional variables (e.g., the responders as well as the responses) being added to the conversation information. For example, in the embodiment depicted in FIG. 19, an attach additional information interface 1902 shows that Ask a Person Responses as well as Ask a Person Responders are now part of the conversation information.

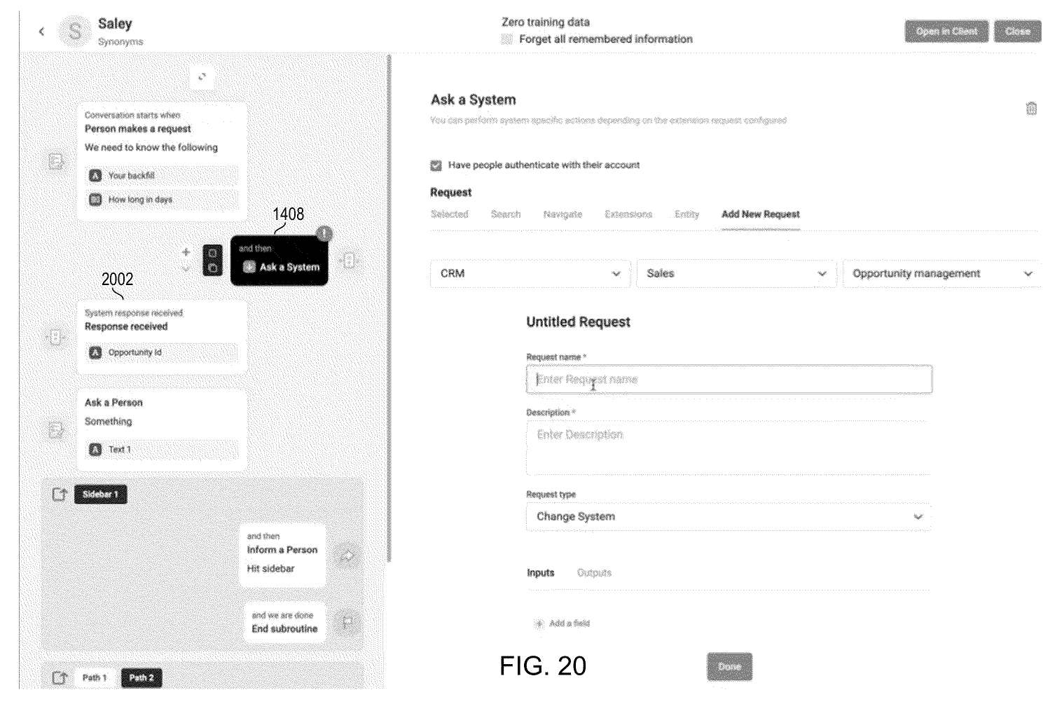

FIG. 20 depicts an ask a system block 1408. The ask a system block 1408 may be used to retrieve or update information in a backend system 116. In conjunction with the addition of an instance of an ask a system block 1408 to the program flow of the conversation, a system response received block 2002 may also be automatically added to the conversation. In the embodiment depicted, the view for the ask a system block 1408 includes various headers including Selected, Search, Navigate, Extensions, Entity, and Add New Request headers.

When the Add New Request header is selected, the author may be presented with a view to create a new request 212 to implement the ask a system block 1408. The flow for creating the request in this instance may have any suitable characteristics of the flow described above in connection with FIG. 10.

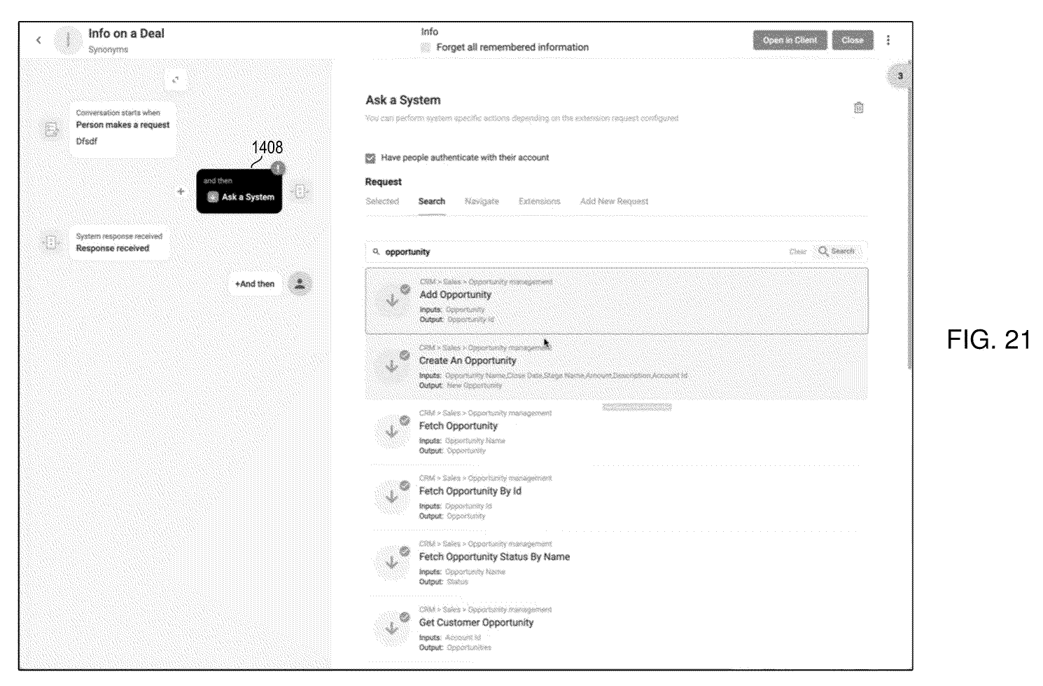

FIG. 21 depicts an ask a system block 1408 when the Search header is selected. In this view, the user may search for a request 212 to implement the ask a system block 1408. As shown, the search results may include a plurality of requests (e.g., as identified by the titles of the requests). The search results may also include parameters of the requests 212. For example, as depicted, the search results include the location within the hierarchy of the requests. In the embodiment depicted, all requests in the search results are located in the CRM ecosystem, Sales domain, and Opportunity management area, although the search results may also return requests that are respectively in different hierarchy locations in some instances. In various examples, the search results may give preference to requests that are in the same domain as the conversation (although the search results may additionally or alternatively include requests from one or more other domains). As depicted, the search results may also show the input and output fields of the requests 212.

As an alternative to searching for a request, a user may select the Navigate header and may navigate through the hierarchy of requests (e.g., by selecting an ecosystem, domain, and/or area, after which the requests within that ecosystem, domain, and/or area will be displayed).

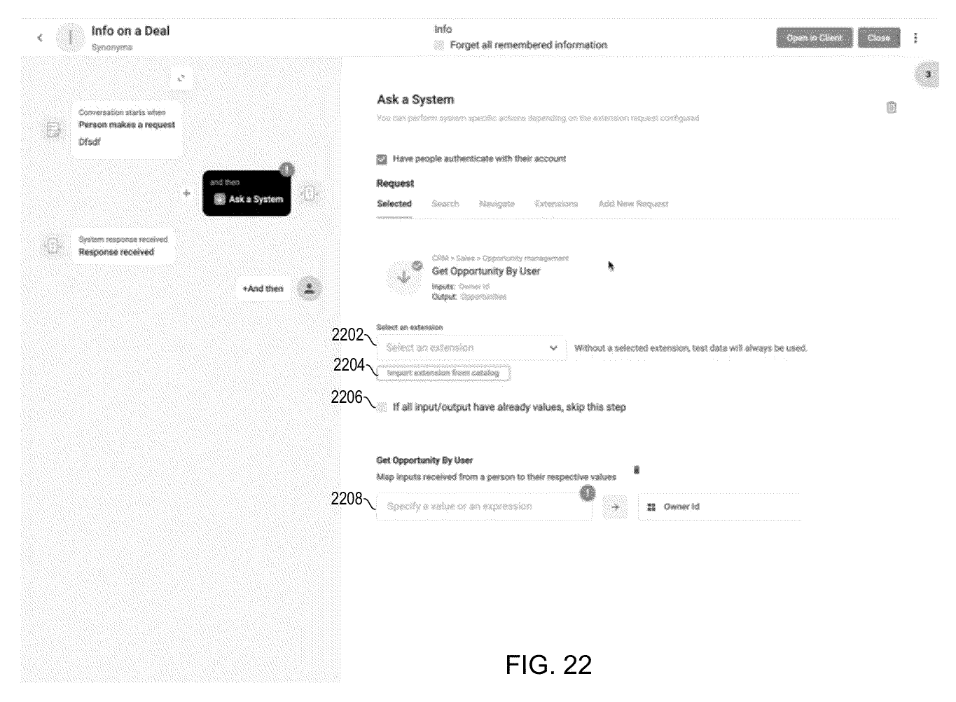

As depicted in FIG. 22, once a user has selected a request, the Selected header is activated and the author is allowed to choose which extension to use for the request 212. As described above, in some instances, multiple extensions may be programmed for the same request. For example, if a request simply stores data, a first extension may be built for a first backend system comprising a first database, a second extension may be built for a second backend system comprising a second database, and so on (as a side note, in some embodiments, one of these extensions could comprise logic to store the data in managed entities 120). Thus, in this instance, the author may select which backend system 116 should fulfill the request.

In the embodiment shown, the author may select an extension from a dropdown interface 2202 that may include the extensions that have been created for the request and that are currently within the workspace 108 of the author. The user may also be provided with an import extension interface 2204 to import an extension for the selected request from a global catalog 110 or private catalog 112. If an extension is not selected for the request, then system 102 may generate test data for the output of the request during the execution of a conversation.

The ask a system block 1408 may include a skip step interface 2206 that allows an author to specify whether the ask a system block 1408 should be skipped if all of the input and output values of the request 212 already have values within the conversation information. This skip step interface 2206 may have any suitable characteristics of skip step interface 1214 or 1606.

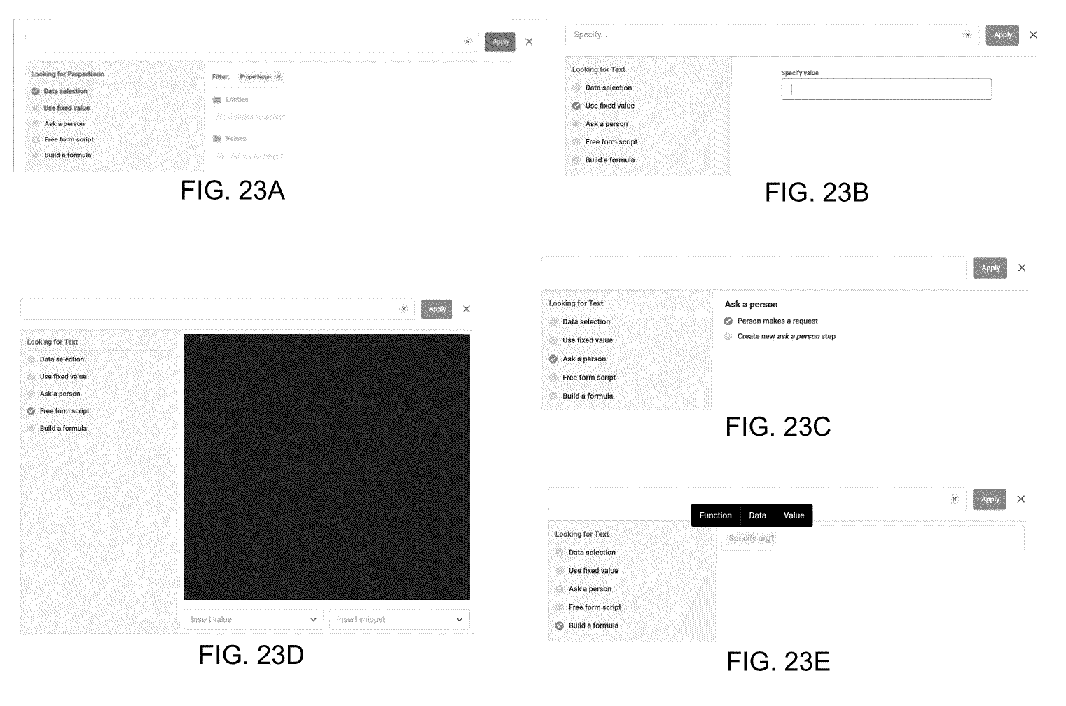

Finally, this view may allow mapping of user (or other) inputs to inputs of the request. For example, when a user clicks inside mapping interface 2208, a window may allow the user to specify a value or an expression (e.g., as shown in FIGS. 23A-E). Input options that may be mapped to the input value (Owner Id in this example) for the request include data selection (e.g., as shown in FIG. 23A where the author may select an entity or a variable value from the conversation information), a fixed value (e.g., as shown in FIG. 23B, such as a predefined value specified by the author), a value from an ask a person block (e.g., as shown in FIG. 23C where the user executing the conversation or another specified user may be asked for the input value, the request for the input may be added to the conversation start block when it is based on a person making a request, or a new ask a person block 1406 may be added prior to the ask a system block 1408), free form script (e.g., as shown in FIG. 23D in which in perl, javascript, PHP, python, or other suitable scripting language may be used to produce a field that can be mapped to the input, wherein the scripting language may access variables of the conversation information in some instances), or build a formula (e.g., as shown in FIG. 23E, using one or more variables of the conversation information and logical or mathematical operators).

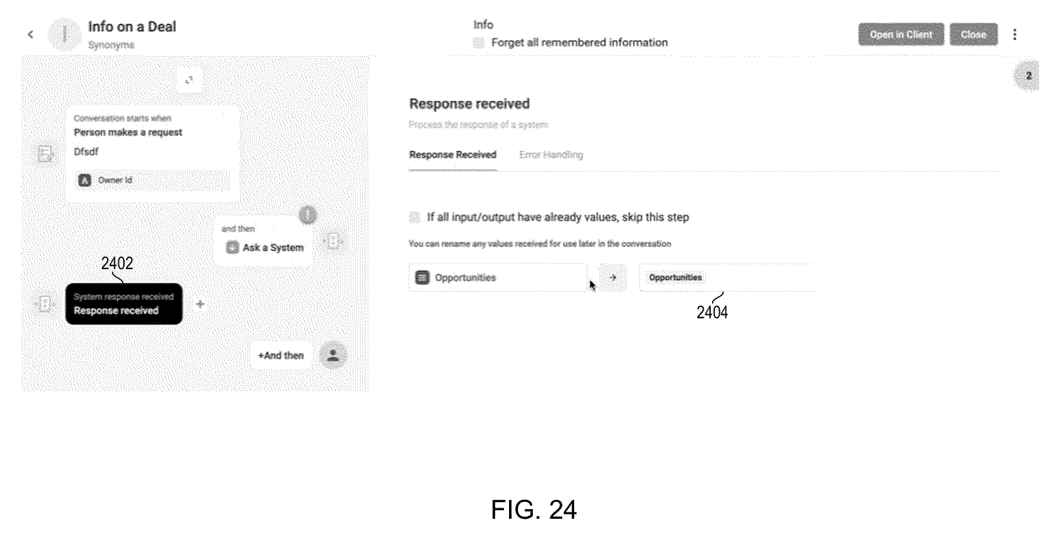

FIG. 24 depicts a system response received block 2402. As mentioned earlier, a system response received block may be automatically added after an ask a system block. In the embodiment depicted, when the system response received block 2402 is selected, the author may map the output (e.g., Opportunities) of the preceding ask a system block to a variable name 2404 to be included in the conversation information for later use in the conversation. The author may also define error handling procedures as well in this block.

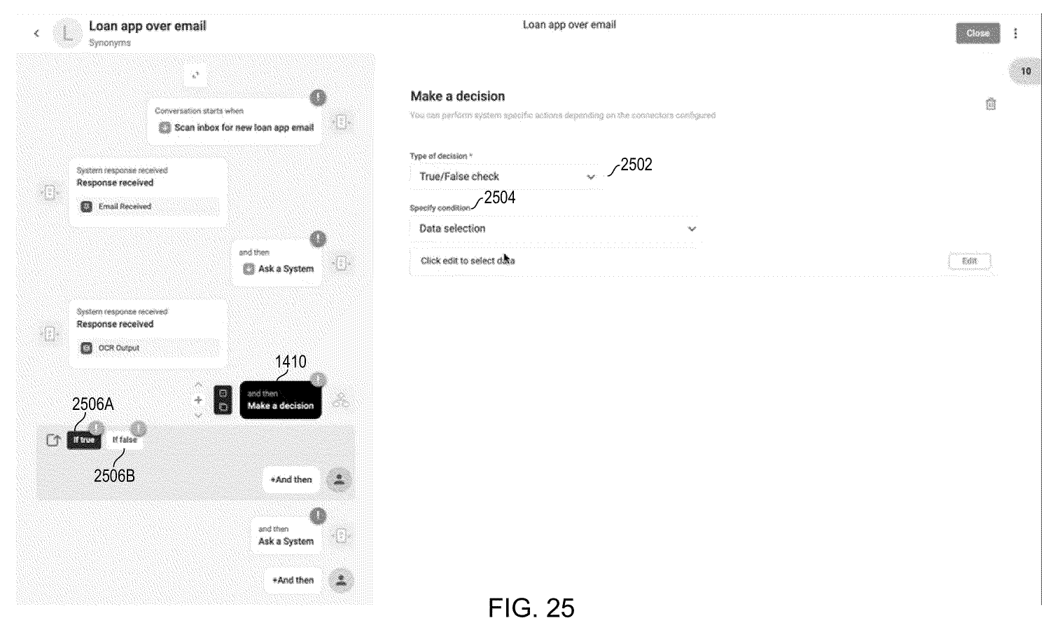

FIG. 25 illustrates a make a decision block 1410 in accordance with certain embodiments. The make a decision block 1410 may be used to make a decision, e.g., based on user or backend system input. When the make a decision block is added, an author may select a type of decision using decision interface 2502. Various examples of decisions that may be utilized are true/false check, branch based on value, branch on presence of value (e.g., this option may be used when a specified input is not required and the corresponding variable may or may not be given a value in previous blocks of the conversation), or decision table (e.g., in which each entry in the decision table may be mapped to a different path). An author may also specify the conditions for the decision using conditions interface 2504. In various embodiments, the conditions may be based at least in part on data or conditions specified using one or more of the options described above with respect to FIGS. 23A-23E.

The make a decision block 1410 may result in multiple paths 2506 being placed into the program flow of the conversation below the make a decision block 1410. In the embodiment depicted, the True-False check selection for the type of decision results in an “If true” path 2506A and an “If false” path 2506B being placed in the conversation.

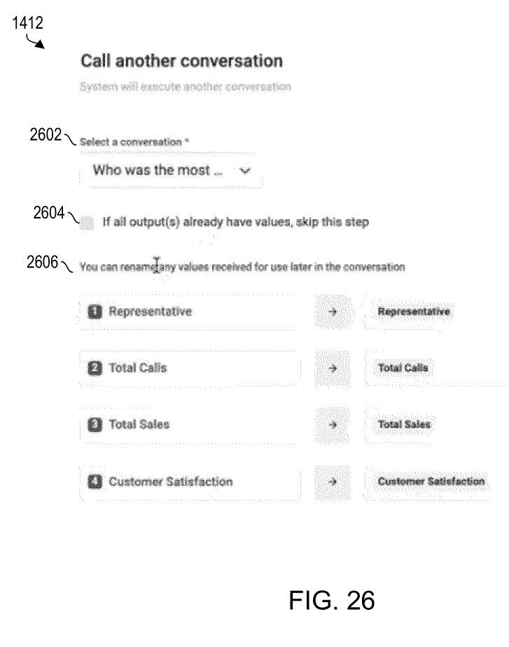

FIG. 26 illustrates a call another conversation block 1412 in accordance with certain embodiments. The call another conversation block 1412 may specify execution of another conversation 210 (effectively enabling program subroutines). The block 1412 may include a conversation selection interface 2602 allowing the user to select a conversation from a list (e.g., of conversations of the same topic), to search for a conversation, to navigate to a conversation, or to otherwise select a conversation to be executed.

Block 1412 may also include a skip step interface 2604, allowing the author to specify whether execution of the specified conversation should be skipped if all output(s) of the conversation already have values. Block 1412 may also include a renaming interface that is dynamically populated with the outputs of the selected conversation. The renaming interface may allow the author to change the variable name of an output of the specified conversation (if desired) for later use in the conversation including the instance of the call another conversation block 1412.

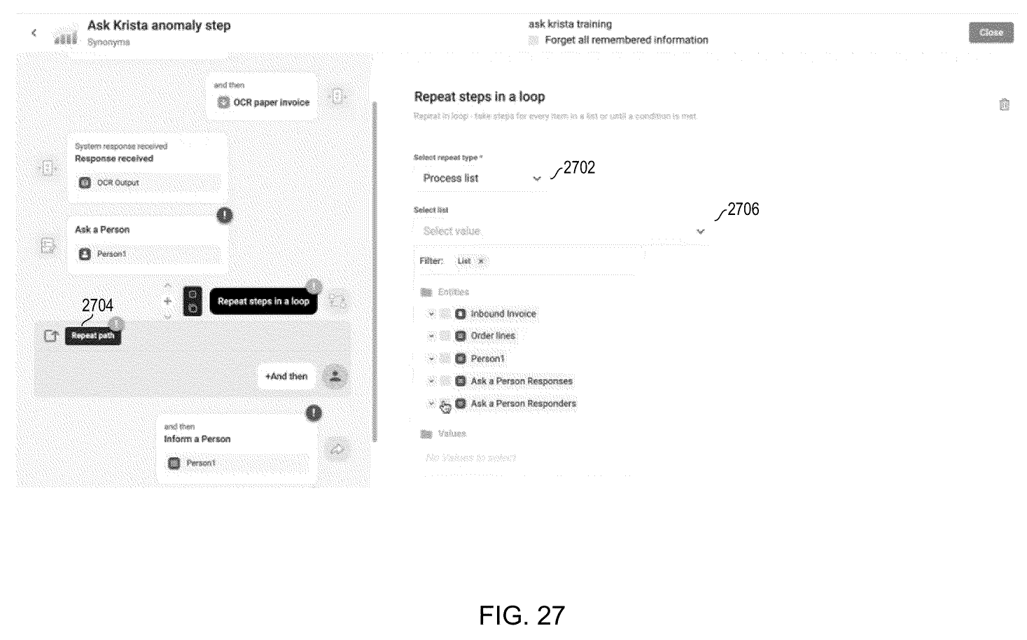

FIG. 27 illustrates a repeat steps in a loop block 1414. The repeat steps in a loop block 1414 may run one or more conversation blocks in a loop. The author may select a repeat type from repeat type interface 2702. For example, the repeat types may include a process list type and an until condition type. When the process list type is selected, the path 2704 associated with the repeat steps in a loop block 1414 (where the path could include any suitable combination of conversation blocks) may be executed for each element of a list selected from select list interface 2706. When the until condition type is selected, the path may be executed until a condition (e.g., based on one or more variables of the conversation information) specified by the author is met.

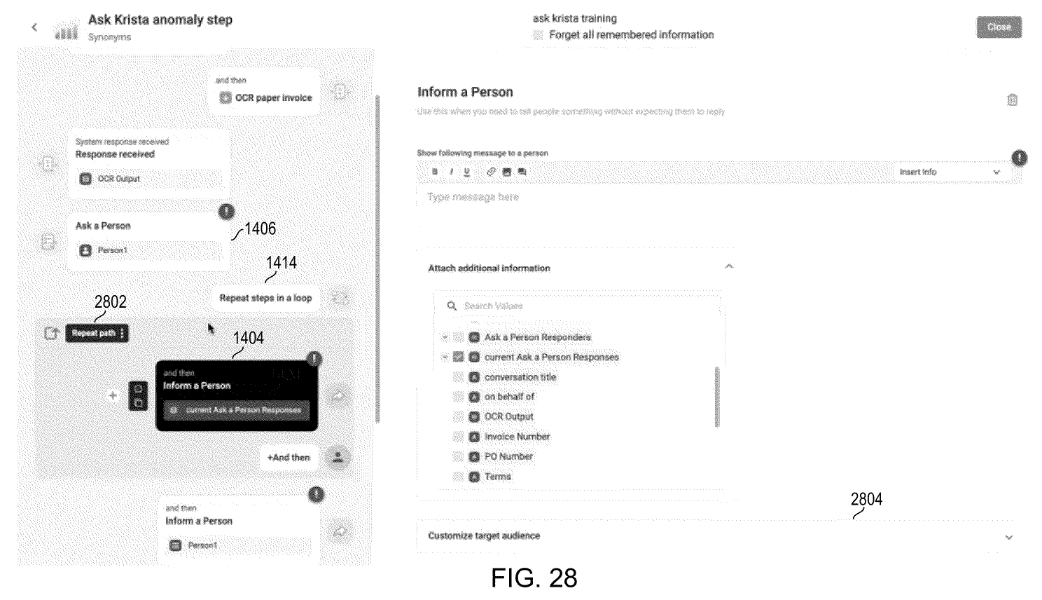

FIG. 28 illustrates use of the repeat steps in a loop block 1414 in conjunction with an inform a person block 1404. In FIG. 28, an inform a person block 1404 is placed within a repeat path 2802. The inform a person block 1404 is set to provide current Ask a Person Responses (e.g., responses that are received as a result of the “current” ask a person block 1406 above the repeat steps in a loop block 1414) as additional information to users meeting criteria specified in the customize target audience interface 2804.

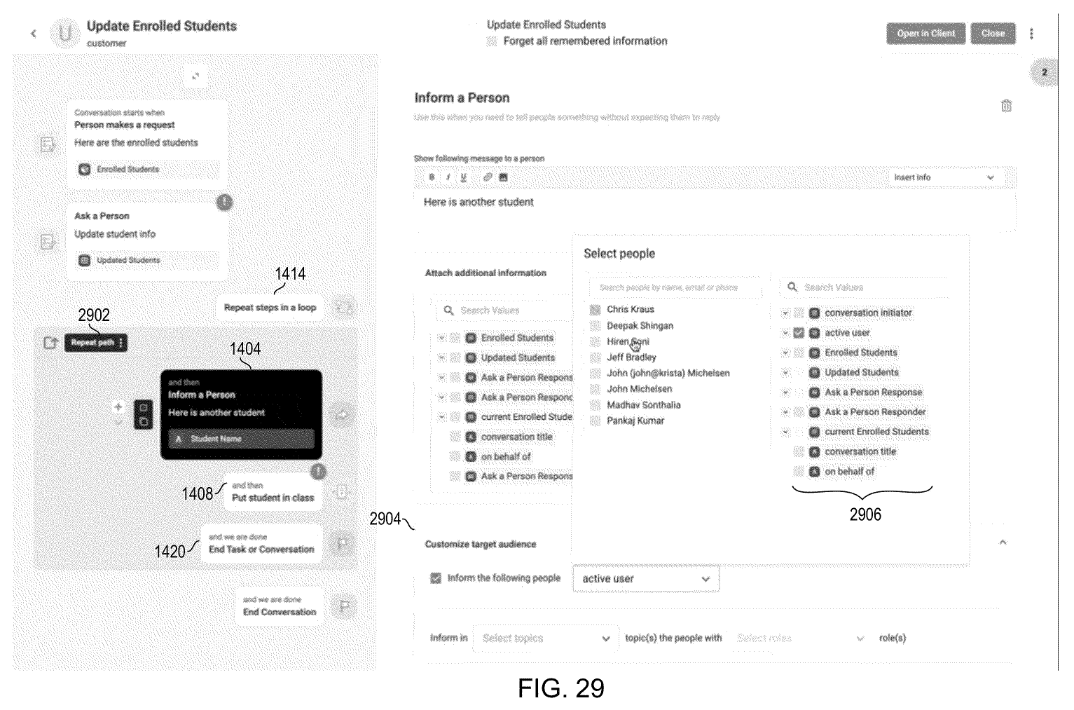

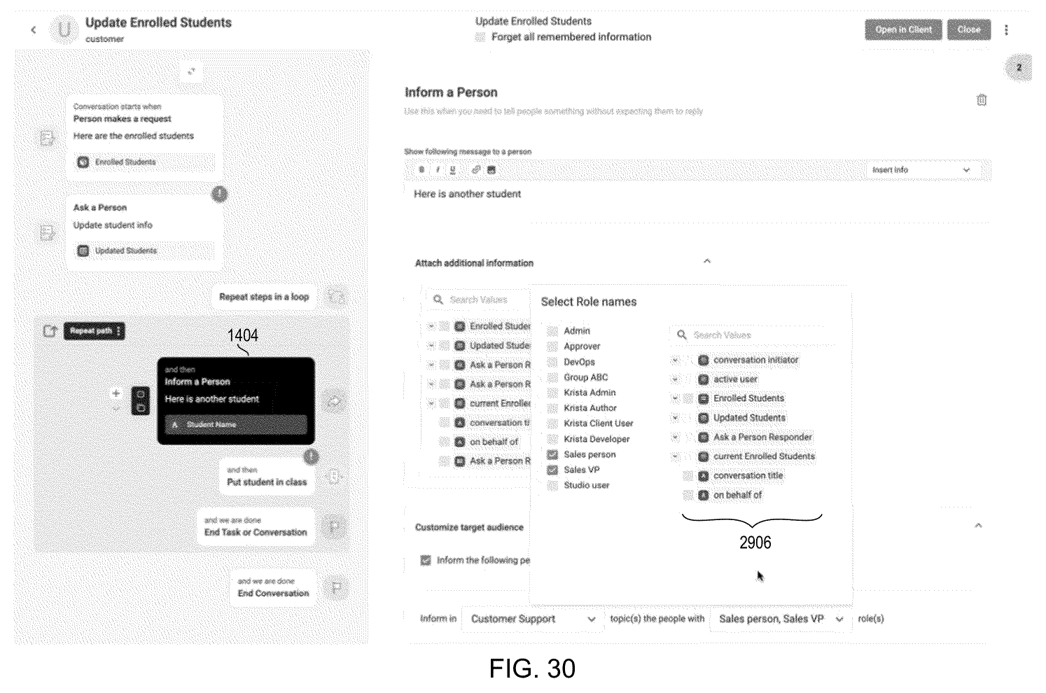

FIGS. 29-30 further illustrate use of the repeat steps in a loop block 1414 in conjunction with an inform a person block 1404. In FIG. 29, an inform a person block 1404 is placed within a repeat path 2902. The inform a person block 1404 is set to provide a message “Here is another student” as well as a Student Name variable to users meeting criteria specified in the customize target audience interface 2904. In the depicted embodiment, only the active user is set to receive the message (while the interface may allow for additional selection of specific people, people represented by variables in conversation information 2906, or people having specified roles). After the target audience is informed, an ask a system block 1408 may execute a “Put student in class” request and then the end path or conversation block 1420 may result in the path being executed again if the loop conditions are met. Although not shown, the repeat steps in a loop block 1414 may be set to process a list of Student Names.

In FIG. 30, additional users have been selected as the target audience for the inform a person block 1404. In the depicted embodiment, the users with roles of Sales person and Sales VP in the Customer Support topic have been selected to receive the message of the inform a person block 1404. As depicted, other roles (e.g., as represented by variables in the conversation information 2906) could additionally or alternatively be selected.

The ask Krista Al block 1416 may ask an artificial intelligence system for a prediction (e.g., of a value or decision), to identify whether a field value is an anomaly, or perform other suitable Al function. The Ask Krista Al block 1416 may be used to ask for any suitable intelligent predictions. By way of illustration only, the block may be used to provide a prediction as to whether a deal is ready to close, a prediction of forecasted revenue based on open opportunities and their stages, a prediction of a value of a company based on current and future revenue based on various characteristics of the company, or other suitable predictions. The ask Krista Al block 1416 in conjunction with the other features provided by the workspace studio for creating and editing conversations allows seamless integration of machine learning with existing processes.

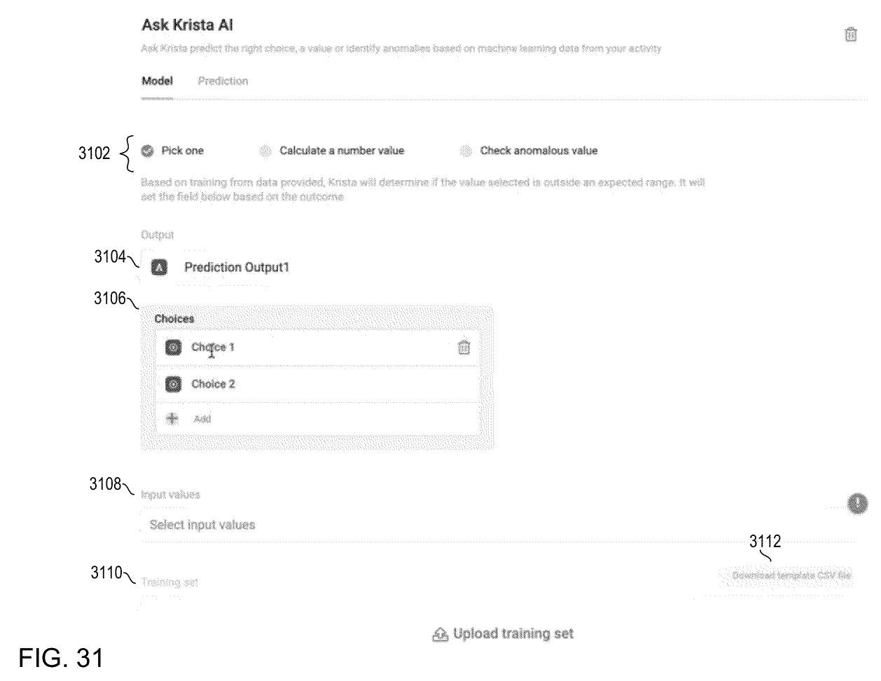

FIG. 31 depicts example configuration options for an Ask Krista Al block 1416. When the Model header is selected, settings associated with the model to be used for the prediction may be configured. In this embodiment, the model type is selected as pick one via the model selection interface 3102. When the pick one option is selected, the system 102 may use one or more machine learning models to predict the best choice from a plurality of choices based on one or more input values. If multiple models are used, the results of the models may be combined together in any suitable fashion to generate the prediction provided by system 102.

The author may assign a name 3104 to the prediction to be generated by the block 1416. A choice interface 3106 may allow the author to provide a plurality of choices. In many instances, the choices may be set to true and false, but in other instances any suitable number of choices and choice values may be used. One or more input values for the prediction may be supplied using input interface 3108 and training data may be supplied (or removed) for the model(s) used via training set interface 3110. A link 3112 to a template for the training data may also be provided (where the template is generated dynamically based on the input value(s) and the choices).

Although not shown for the pick one selection, when the Prediction header is selected, an interface to allow the author to test predictions may be provided, wherein the author may provide example values for the inputs and predictions are provided based on those values (and the available training data).

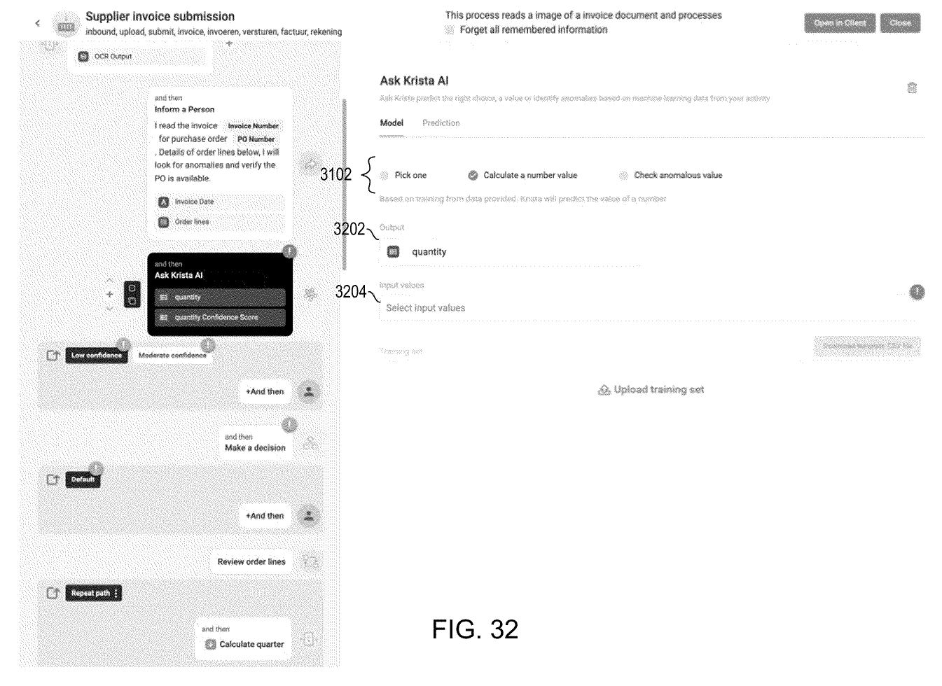

FIG. 32 depicts example configuration options for an Ask Krista Al block 1416 when calculate a number value is selected as the model type. The options may include an output interface 3202 in which the author may specify an output to be predicted by the system 102 using one or more machine learning models as well as an input interface 3204 in which the author may specify one or more inputs for the prediction. In this view, the author may also provide training data or download a training data template.

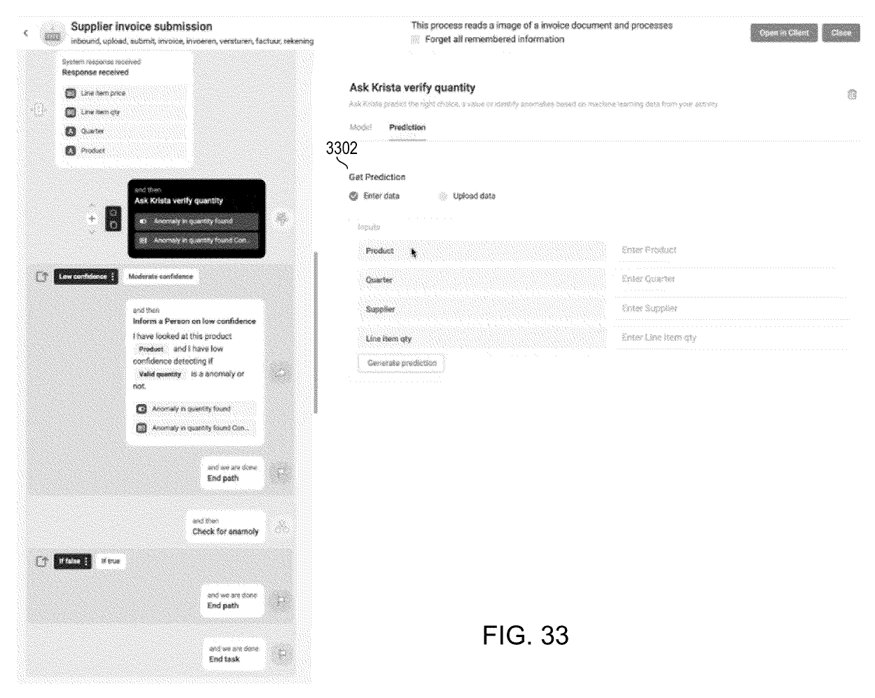

FIG. 33 depicts a prediction generator of the Krista Al block 1416 and may be displayed when the Prediction header is selected. The author may use the prediction interface 3302 to select whether the sample data is going to be entered or uploaded. If the data is to be entered, the inputs may be displayed along with interfaces for the author to enter a value for each input. After the data has been entered (or uploaded), a prediction may be generated and presented to the author for review. The prediction generator may allow an author to test the robustness of the predictions (e.g., as a sanity check) before the block 1416 is executed in a conversation.

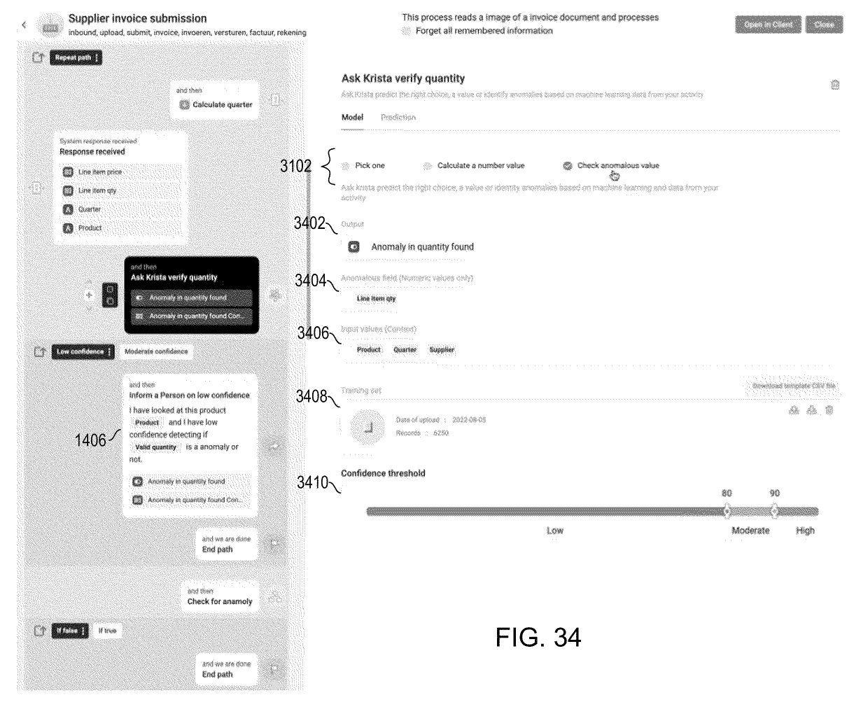

FIG. 34 depicts example configuration options for an ask Krista Al block 1416 when check anomalous value is selected as the model type. These options may include an output interface 3402 where a name for the binary output as to whether an anomaly was found may be provided, an anomalous field interface 3404 where a variable (e.g., of the conversation information) is to be checked for an anomaly is supplied, and an input interface 3406 where one or more inputs may be supplied as context for the anomaly checking. Training set data may also be supplied, removed, or downloaded via the training set interface 3408.

A confidence threshold interface 3410 may also be provided in various embodiments (similar interfaces could also be used for the other model types). When an instance of an ask Krista Al block 1416 is executed in a conversation, a prediction along with a confidence metric for the prediction may be generated (e.g., based on the robustness of the training data, the specific model used, and/or the input data). The interface 3410 may allow the author to specify confidence intervals that may be used in the conversation’s program flow. Although any suitable number of confidence intervals may be specified over any suitable range for the confidence metrics, in the embodiment depicted, a low confidence interval, moderate confidence interval, and high confidence interval are defined over a range from 0-100. The author may use the sliders to adjust the width of each interval.

In various embodiments, the conversation may fork based on the value of the confidence metric (e.g., one or more paths that are each associated with a different confidence interval may be placed in the conversation automatically or responsive to user direction). In one example, if the confidence metric indicates high confidence, then the conversation may proceed based on the prediction without human user input (and no extra path is added for the high confidence interval), if the confidence metric indicates moderate confidence, a path may be added in which a prediction is sent to a human user along with a request for the user to confirm the value predicted, and if the confidence metric indicates low confidence, the human user may be prompted to input the value (e.g., without showing the human user the predicted value). As another example, in the embodiment depicted, for the low confidence interval, a path has been added wherein an ask a person block informs a target audience that it was difficult to determine whether the value was an anomaly or not. These are examples only as the author programming the conversation may program any suitable outcomes based on the confidence metric and any suitable number of confidence intervals may be used.

When a block 1416 is executed within a conversation, input for the block 1416 may be provided from the conversation information (or may otherwise be based on the conversation flow) and output of the block 1416 may be added to the conversation information for any suitable use in the conversation (e.g., to present to a user, to write to a backend system 116, to use as a condition for a loop or branch, etc.).

In various embodiments, the training data used by the model(s) of a block 1416 may include training data supplied by the author (e.g., via interface 3110) and/or training data generated through execution of the conversation including the block 1416. For example, once a conversation with an ask Krista Al block 1416 has been deployed (e.g., taken live), execution of the block 1416 may provide information that may be added to a training set for the block 1416. For instance, whenever a prediction is verified by a human (or an outcome is supplied by a human user, e.g., responsive to a prediction with a low confidence metric), the inputs and the prediction (or human provided outcome) may be added to the training set for the block 1416.

In the embodiment depicted, the actual machine learning model(s) used for the prediction are not exposed to the author. However, in other embodiments, the author may be able to select the machine learning model (and/or any suitable parameters of the machine learning model) to be used for the prediction. For example, the catalogs may include machine learning models and the author may select a machine learning model for an ask Krista Al block 1416. In some embodiments, the ask a system block 1408 may additionally or alternatively be used to call a request that executes a machine learning model to provide a prediction (and/or associated information such as a confidence metric). Thus, various embodiments may allow users of an organization to utilize customized machine learning models to generate predictions within conversations.

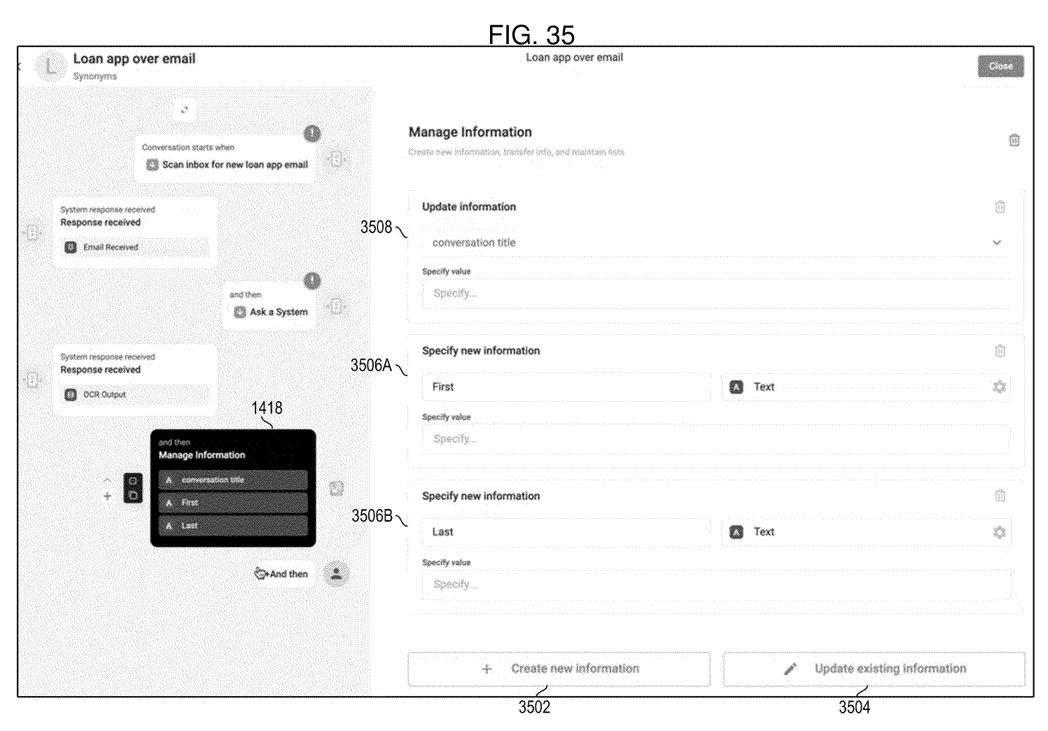

The manage information block 1418 may allow for manipulation of information or creation of new information in the conversation information. FIG. 35 illustrates a manage information block 1418 in accordance with certain embodiments. Such information may then be used in future conversation blocks. In the conversational context, the manage information block 1418 may be used as a sticky note would be used by a human as a way to manipulate information and/or keep information for later use.

When the create new information interface 3502 is selected, the author may be taken to a view to select a field type (e.g., similar to the view of FIG. 9 above). The user may then be able to name the field, specify an initial value of the field, provide synonyms for the field name, specify whether input is required for the field (e.g., if input is required then the conversation may not proceed until the information is provided), and/or set other options for the field. When specifying an initial value, the user may be provided with any of the following options: set the value equal to an existing entity or value, use a fixed value, set the value to nothing, enter a free form script (e.g., in perl, javascript, PHP, python, or other suitable scripting language) for the value, or build a formula for the initial value (e.g., using any suitable mathematical or logical operators), similar to options discussed above for other fields. Some of these options may allow the user to manipulate variables that are already a part of the conversation information to produce the new variable.

The resulting new information may be shown in an interface 3506. For example, in the depicted embodiment, a new variable “First” of type text is shown in interface 3506A and a new variable “Last” of type text is shown in interface 3506B.

When the update existing information icon 3504 is selected, a list of the variables of the conversation information may be presented to the author. The author may select a variable and then may specify a new value for the variable (which could include setting a new value for one or more fields of the variable). In one example, the user may be presented with any of the options listed above for setting the initial value of a new variable (or other suitable options—for example, an additional option of ask a person may be available). Updated information may be shown in an interface 3508.

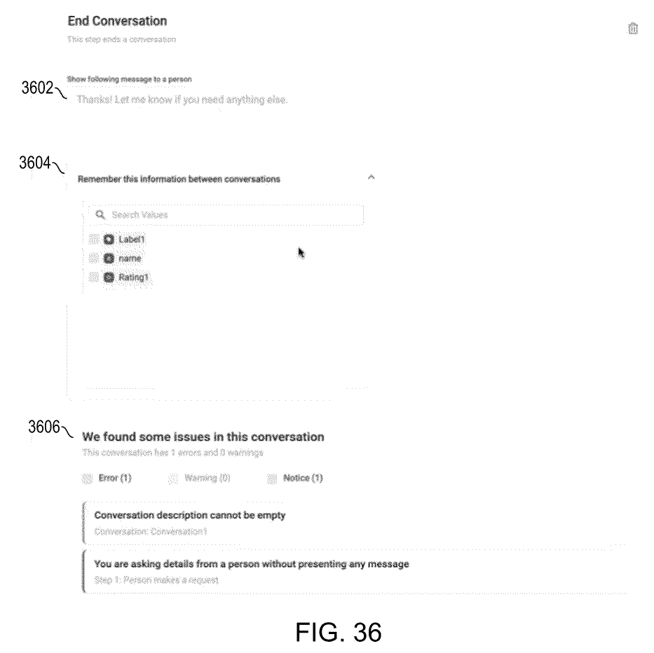

The end path or conversation block 1420 signifies the end of a path or conversation. FIG. 36 depicts a view that may be provided for an end path or conversation block 1420.

Message interface 3602 allows for the author to specify a message to be shown to a person (e.g., the active user) upon execution of the block 1420. Information persistence interface 3604 depicts variables of the conversation information and allows the author to select which information will be persistent between conversations (e.g., the checked information may be maintained in the conversation information for one or more future conversations). In some embodiments, one or more of the variables (or fields thereof) may be checked by default (e.g., if the variable is checked for persistence in one or more other conversations, then the variable may be checked by default in other conversations). This view may also provide information 3606 including errors, warnings, and/or notices about the conversation (or path) that is closed by the block 1420.

In various embodiments, input provided by a human user (e.g., via a channel 114) may be used to search (e.g., via NLP) for requests 212 that directly access the backend systems (in addition or as an alternative to searching for conversations 210 based on the human input). Since requests 212 already define the inputs required and outputs delivered when invoked during execution of a conversation and are fully typed, a user may simply invoke a request 212 rather than an entire conversation 210 to accomplish a desired action. This may enable users to drive activities across several disparate backend systems 116 via commands based on the ability of the user to communicate in the language of the business processes supported by the backend systems 116. Thus, a user may declare an action to take, and the system 102 may guide the user (e.g., using NLP) to a request 212 that can perform the action (referred to herein as an ad-hoc request). In cases where a single request may not perform the entirety of the action desired by the user, the user may perform any additional steps on the fly in an ad-hoc conversation (e.g., using a series of ad-hoc requests) and then submit that stream of steps to an author or other user that can author a conversation 210 (or the user may author the conversation 210 if the user has the appropriate permissions) in order to convert the created ad-hoc conversation into a standard conversation 210 for inclusion into a workspace 108 for others to use later. Such embodiments greatly enhance the automation process by allowing automation to be created in the moment (as opposed to requiring a user to submit a request to a developer, having the request placed on a backlog, and having to wait for the developer to create the request for the user).

In some embodiments, direct access to a request 212 may be provided by generation of a mini-conversation comprising an ask a person block 1406 to receive any inputs required for the request, an ask a system block 1408 to perform the desired action, and an inform a person block 1404 to provide the results of the action. In some embodiments, this mini-conversation sequence may be placed in a loop so that the user may access one or more backend systems 116 with other requests (e.g., using the same mini-conversation constructs) to allow flexibility in the actions the user may take.

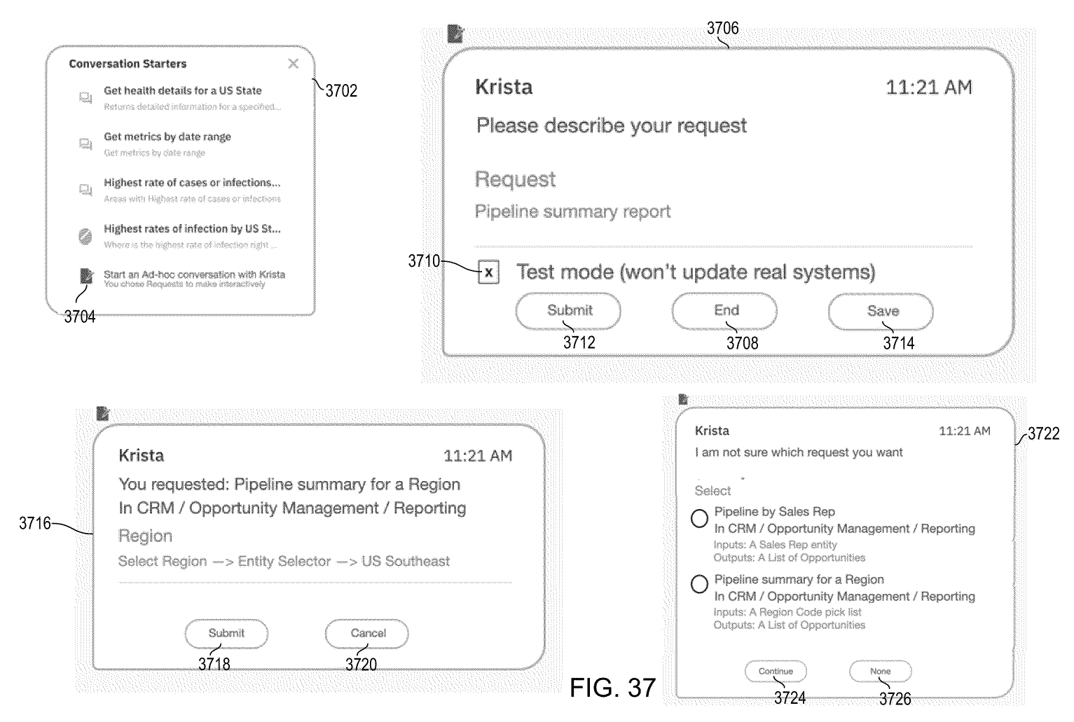

FIG. 37 illustrates various interfaces that may be presented to a user (e.g., through a channel 114) by the system 100 (e.g., via user interface 106) to allow the user to participate in an ad-hoc conversation. Interface 3702 includes an icon 3704 that the user may select to initiate the ad-hoc conversation. The icon 3704 may be displayed along with other icons (e.g., for conversation starters or other content, where different icons displayed with the conversation starters may correspond to different status of conversations indicating, e.g., whether the conversations are in draft mode, test mode, or live mode).

When the icon 3704 is selected, another interface 3706 may be provided prompting the user to enter a message (e.g., input that will be used to search for a request 212). This interface 3706 may correspond to an ask a person block 1406 (e.g., may be implemented using the same logic that is executed during a conversation when an ask a person block is executed). In some embodiments, this interface 3706 may be shown again after a request 212 has been completed and a result has been returned to the user (e.g., via an inform a person block 1404 or the equivalent). Thus, this process may operate as an infinite loop until a break condition is encountered. The loop may end when the user provides a selection (e.g., by selecting the “End” icon 3708). In some embodiments, the loop may also end when a user has not interacted with the interface 3706 for a threshold amount of time.

The interface 3706 may also include the ability (e.g., shown as a checkbox 3710) to enable or disable a test mode (in which backend systems 116 aren’t accessed when the request is performed, but rather the system 102 will produce test data for system outputs). Thus, when in test mode, the ad-hoc conversation may operate in a similar manner to a standard conversation run in test mode. This mode may allow a user to experiment with the interface without concern for the consequences.

In various embodiments, the user may describe the request 212 that is desired using natural language in the interface 3706. In this example, the user has entered “Pipeline summary report” as the action to be taken. When the user selects submit icon 3712 (or otherwise submits the description of the action), a search (e.g., NLP search) may be performed for a matching request 212.

In some embodiments, the search may be done in phases and/or the results of the search may be ordered based on a location of the results within the hierarchy of requests. For example, the ecosystem(s) that are referenced in the topic may be searched first and if no results are found then the other ecosystems of the workspace may be searched for a matching request. For example, if a user performing the search has a particular topic (e.g., People Operations) selected in the client, and that topic includes requests to the HR ecosystem, then the HR ecosystem may be searched for requests first. As another example, the results of the ecosystem(s) referenced in the topic may be ranked higher in the search results than results of the other ecosystems of the workspace.

When only one request 212 is a good match, the system 102 may assume that this request is the desired request. In some embodiments, before executing the request 212, an ask a person block 1406 may be executed to confirm that this is the proper request (and/or to solicit input information if required by the request 212). An example interface 3716 is shown (e.g., this interface may be shown responsive to a determination that only one good search result exists or responsive to a search result selection from a list of results by the user). The interface may display information associated with the request, such as the location of the request within the catalog hierarchy (CRM/Opportunity Management/Reporting in this case), user authentication information (not shown in the depicted interface), and/or any prompts for parameters needed to execute that request. In this instance the parameter is an entity for a region and the US Southeast Region has been selected by the user via an entity selector. More specifically, Select Region is the name of the input for the Pipeline summary for a Region request 212, it has a type of Entity Selector, and US Southeast is the name (in string format) of the entity that the user has selected. Selecting the submit icon 3718 will send the ask a person block’s response with the input(s) provided and will result in the request being executed and any outputs of the request being provided via an inform a person block. Selecting the cancel icon 3720 results in ignoring the suggested request and may take the user back to the initial ask a person block (resulting in interface 3706) to allow the user to tweak the search terms, end the ad-hoc conversation, or save the ad-hoc conversation (as described below).

If more than one match appears to be a feasible match, the user may be presented with the results and allowed to choose a request. Interface 3722 represents an example view of multiple results that may be presented to a user. The view may provide any suitable details associated with the requests in order to allow the user to select the appropriate request 212. For example, as shown, the titles, locations in the hierarchy, inputs, and/or outputs of the requests may be shown. When the user selects the “Continue” icon 3724, the user may be taken to the ask a person block (e.g., interface 3716 or the like) and asked for inputs. If there are no inputs, then the request may be invoked without this step. If the user selects the “None” icon 3726, then the flow may return to the initial ask a person block (resulting in interface 3706), where the user can try searching again, or end or save the ad-hoc conversation.

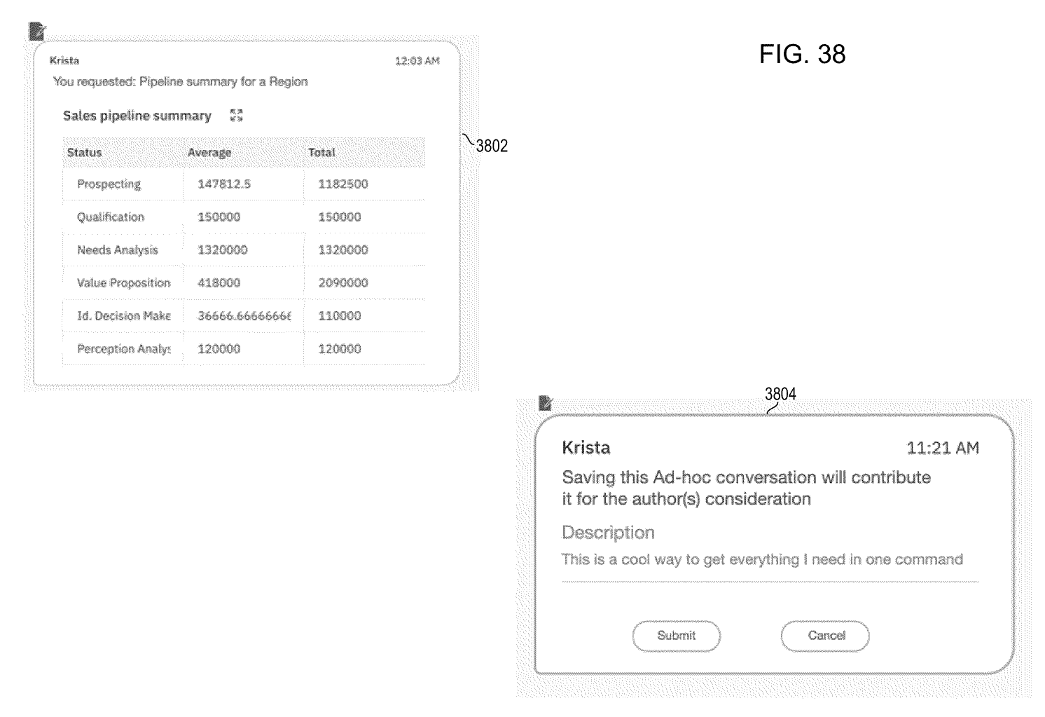

After the request is executed, an inform a person block may be constructed with the output(s) of the request and executed to provide the results to the user. This may result in an interface 3802 of FIG. 38 (or the like) with the results being shown to the user. The flow may then loop back to the Ad-hoc request screen (e.g., interface 3706) and the process may be repeated, or the ad-hoc conversation may be saved or ended.

When a user initiates (e.g., via save icon 3714) the saving of an ad-hoc conversation (e.g., after executing a series of requests 212), an interface 3804 may be shown to the user. In the embodiment depicted, the interface may allow the user to enter a description of the ad-hoc conversation. The interface 3804 may also inform the user that the ad-hoc conversation will be submitted (e.g., to one or more persons with an author role in the topic that the ad-hoc conversation is initiated in) for consideration as a conversation or allow the user to select who the ad-hoc conversation will be submitted to. A message comprising the history of the requests 212 may then be sent to the appropriate one or more persons. In various embodiments, the message may omit the inputs and outputs of the requests (and those values could be fetched in a detailed report of a conversation execution based, e.g., on a conversation ID included in the message if needed by the recipient). In various embodiments, if the user performing the ad-hoc conversation has author rights, the user may be taken to a view to convert the ad-hoc conversation to a standard conversation 210 for inclusion in a catalog (e.g.,112) and/or workspace 108.

In some embodiments, the history of the requests 212 executed in the ad-hoc conversation may be displayed to the user and the user may be able to edit the order, input parameters, or other suitable parameters associated with the requests 212 of the ad-hoc conversation before submission of the ad-hoc conversation for consideration as a conversation. Thus, the saved sequence may be converted to a conversation, edited, passed to another user to be approved as a conversation, and/or otherwise handled.

In some embodiments, an interface showing state information (e.g., information similar to the conversation information described above) of the ad-hoc conversation may be available to the user as the user executes requests 212 during the ad-hoc conversation. For example, the state information may include results from execution of previous requests in order to allow the user to utilize any of these results (or derivations thereof) as inputs to additional requests during the ad-hoc conversation.

In various embodiments, during an ad-hoc conversation, a user may be presented with an option to share the state information of the ad-hoc conversation (e.g., one or more results of the ad-hoc conversation, requests called, etc.) with one or more other users. For example, a first user may invite another user (or multiple users) to view the ad-hoc conversation requests and/or results in real time as the first user executes requests. As another example, a first user may forward the results of one or more requests to one or more other specified users, users having a particular role (or combination of roles), or to all users within a particular topic.

In some embodiments, an NLP search interface may accept input from a user and may search for both conversations 210 and requests 212 that match the input. In various embodiments, priority in the search results may be given to existing conversations 210 (in other embodiments, the search for requests is not even performed if a suitable conversation match is returned). If the system 102 detects that no conversations match the input, but that a request is a good match, the user may be presented with an option to start an ad-hoc conversation and the matched request is selected (and a view such as that provided by interface 3716 may be presented). If no conversations match the input, but more than one requests match, then a view such as that provided by interface 3722 may be provided.

In some embodiments, the NLP search performed by a user may include information allowing identification of a conversation or request as well as one or more inputs for the conversation or request. For example, if a user entered “Give me all the opportunities with greater than fifty percent likelihood to close”, the system 102 may look for a conversation or request that can provide opportunities and may use “greater than fifty percent likelihood to close” as search and/or filtering criteria in performing the conversation or request that provides opportunities.

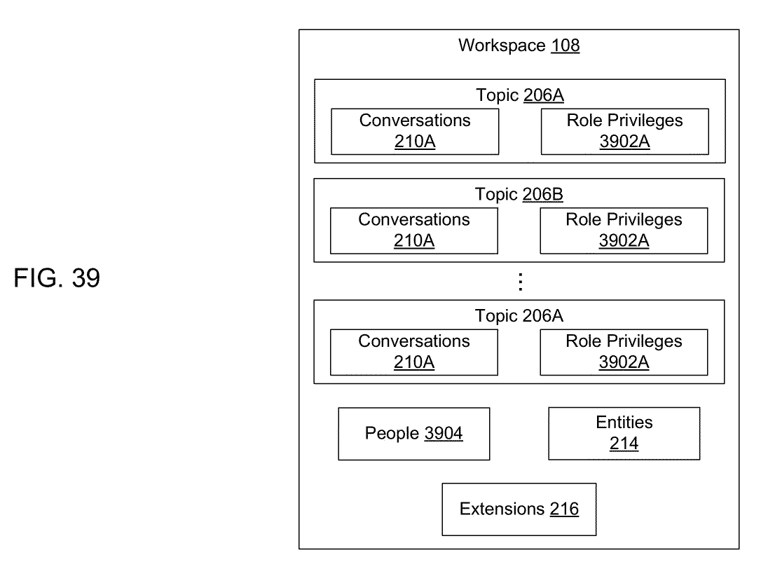

FIG. 39 illustrates a workspace 108 in accordance with certain embodiments. A workspace may include any number of topics 206 that have been imported from the global catalog 110 or one or more private catalogs 112. Each topic 206 may include one or more conversations 210 and role privileges 3902. A workspace may also include indications of people 3904 of the organization that are associated with the workspace, entities 214, and extensions 216 to backend systems 116 associated with the organization.

Various features may be provided by system 102 in order to keep the automations created by authors secure. For example, users associated with an organization may be assigned roles and the roles may be assigned to access rights with respect to resources of system 102. In addition to protecting access to information of the organization, measures may also be taken to secure the programming environment within an organization. For example, different privileges (e.g., view, author, deploy/take live) may be granted to users within a topic and/or an individual conversation within a topic. As another example, different privileges (e.g., read, update) may be granted to different users within an extension group. The roles within an organization may be customizable (and different workspaces, catalogs, ecosystems, domains, and/or topics could include different roles).

Compared to other types of automation or collaboration platforms, system 102 may provide a unique ability for process automation authors to “set it and forget it” when it comes to sensitive data security, allowing authors to send messages to wide varieties of people without worrying about unauthorized access to data (and without requiring the user to code the access control into the automation). In general messaging platforms, a user would have to author and send individual messages to the recipients based on the specific access right of each recipient, thereby frustrating process automation. Furthermore, changes to access rules could require changing code in hundreds of programs that have been written. Various embodiments herein address such problems.

Any suitable roles may be used within an organization. The roles may be defined with any suitable granularity with respect to system 102. For example, roles may be defined per catalog, per ecosystem, per domain, per topic, and/or per workspace. While the roles and associated privileges may be customizable, a few example roles and associated privileges are provided herein.

In one embodiment, an administrator is given access to administrative duties across resources of the organization. For example, an administrator (also referred to herein as Krista Admin) may import and export topics or other resources, take conversations 210 and requests 212 live, set up additional roles, or perform other administrative duties. As another example, an author may have the ability to author conversations and requests, but may not have the ability to take things live or import resources from a catalog to a workspace 108 (in other implementations, an author could also have such rights). A studio user may have the ability to create requests. A developer may have rights to view requests 212 and to program extensions 216 for requests. A client user may be able to search for and consume conversations and/or requests (e.g., through a channel 114), but may not have rights to edit the catalog or import resources into a workspace 108. In other embodiments, any suitable roles may be used and the access privileges may be allocated among the roles in any suitable manner.

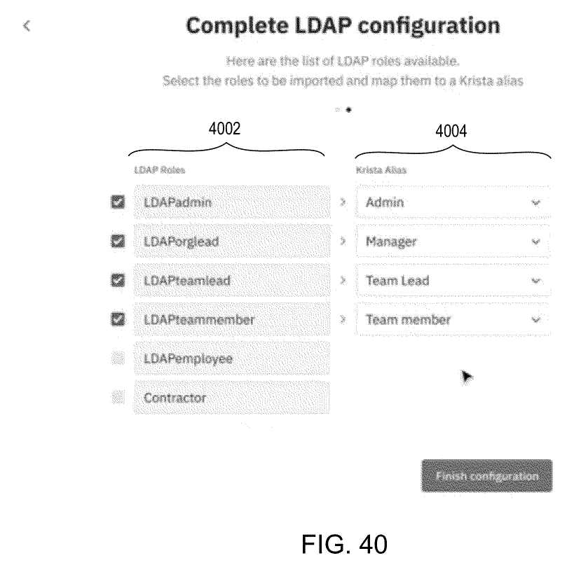

In some embodiments, people of an organization may be imported into a workspace 108 from a directory of an organization, such as a directory compliant with Lightweight Directory Access Protocol (LDAP). The directory may include roles assigned to people of the organization. FIG. 40 illustrates example roles 4002 of an organization’s directory and example roles 4004 used within system 102 (e.g., within a private catalog 112 and/or workspace 108 of the organization). As depicted, the roles 4002 may be mapped to the roles 4004 used by the system 102. For example, one or more roles 4002 in the LDAP may be mapped to a corresponding one or more roles 4004 in system 102. The mapping may be performed at any suitable granularity (e.g., per catalog, per ecosystem, per domain, per topic, and/or per workspace) and could be performed any number of times (e.g., once for each topic, etc.).

This method of mapping may be used to quickly assign roles to many users of an organization. The assignment of the roles to users may be stored by system 102 (e.g., in roles 218, people 3904, and/or other suitable area).

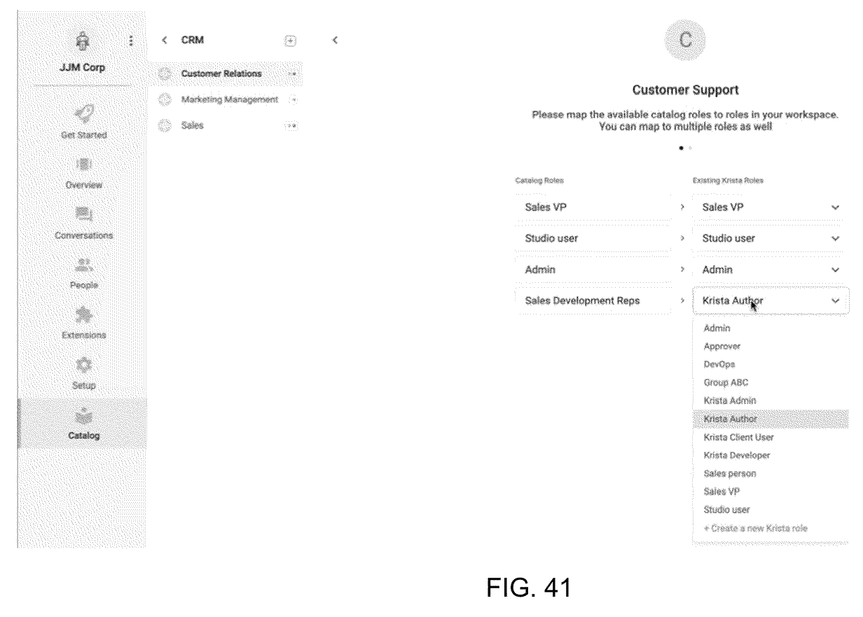

FIG. 41 illustrates an interface for role mapping that may be performed during the importing of a topic from a catalog into a workspace. In the embodiment depicted, the Customer Support topic in the Customer Relations domain in the CRM ecosystem is being imported from a catalog into a workspace. Various roles may exist in the catalog for the topic (including Sales VP, Studio user, Admin, and Sales Development Reps in the depicted embodiment). The roles that are in the catalog may or may not match up with the roles that have been created for a particular workspace. Thus, when a topic is imported, the roles that are utilized in the catalog for the topic may be mapped to existing roles in the workspace. Each role in the catalog (on the left) is mapped to a role in the workspace (on the right). In this instance, the Sales VP, Studio user, and Admin each map to the same role in the workspace. However, Sales Development Reps does not have an exact match with a role in the workspace. Accordingly, the user importing the topic may select a role in the workspace that aligns with the catalog role (e.g., in this instance, the workspace role Sales person may be selected from the list of available roles in the workspace to be mapped to the Sales Development Reps catalog role). The option to add a new role for the workspace is also provided in case a suitable match is not found.

After the mappings are complete, any references to a particular role in the imported resources of the topic within the catalog will be replaced with references to the mapped role in the workspace.

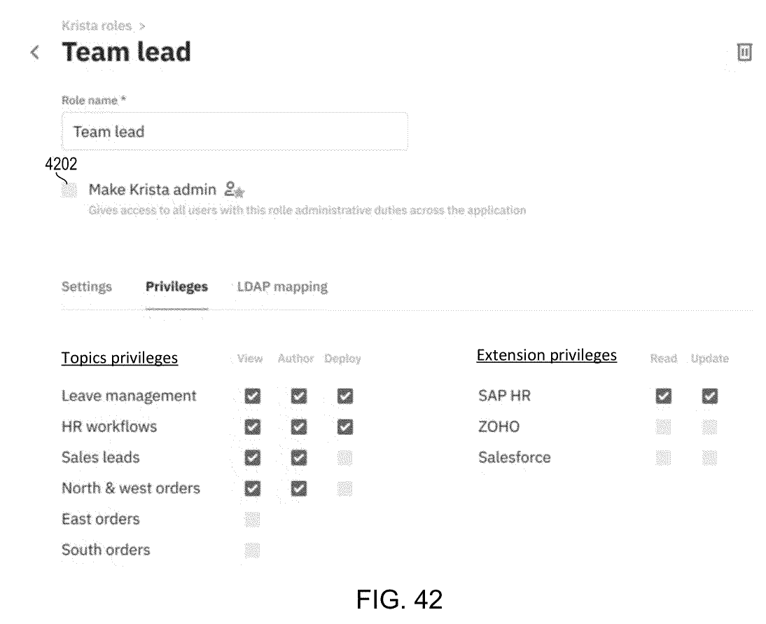

FIG. 42 illustrates privilege settings for a workspace 108 that may be configured by a user (e.g., an administrator or other user with heightened privileges). A plurality of roles may be created for the workspace. In the embodiment depicted, the Team lead role name is being created and configured. A role may also be given privileges of an administrator if desired (e.g., by checking the box 4202). A role may also be given privileges for each topic of the workspace. For example, in the embodiment depicted, the workspace includes Leave management, HR workflows, Sales leads, North & west orders, East orders, and South orders topics. For each of these topics, a role may be given view, author, and/or deploy (e.g., take live) permissions. A person having a role with view permissions for a topic may be able to view and initiate conversations within the topic. A person having a role with author permissions for a topic may be able to author conversations or requests within the topic. A person with deploy permissions may be allowed to deploy a conversation or request within a workspace (e.g., such that users having a role with view permissions may use the conversation or request through a channel 114 and actual backend system 116 may be accessed by the requests of the conversation).

Extension privileges may also be granted for each role. For example, in the embodiment depicted, the topic utilizes the SAP HR, ZOHO, and Salesforce extension sets to communicate with these backend systems. For each extension set, read and update permissions may be configured for the role.

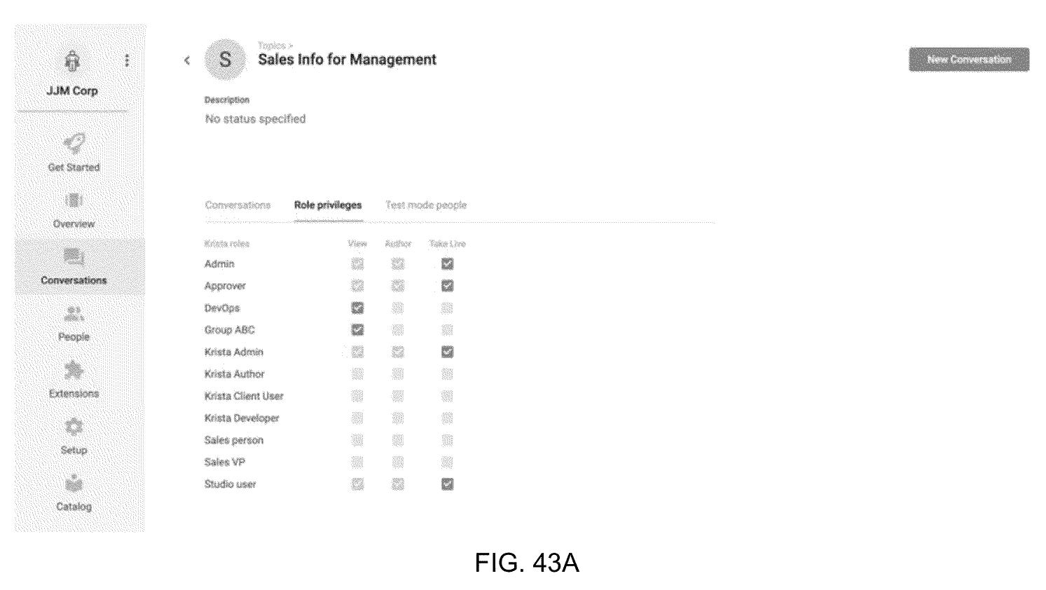

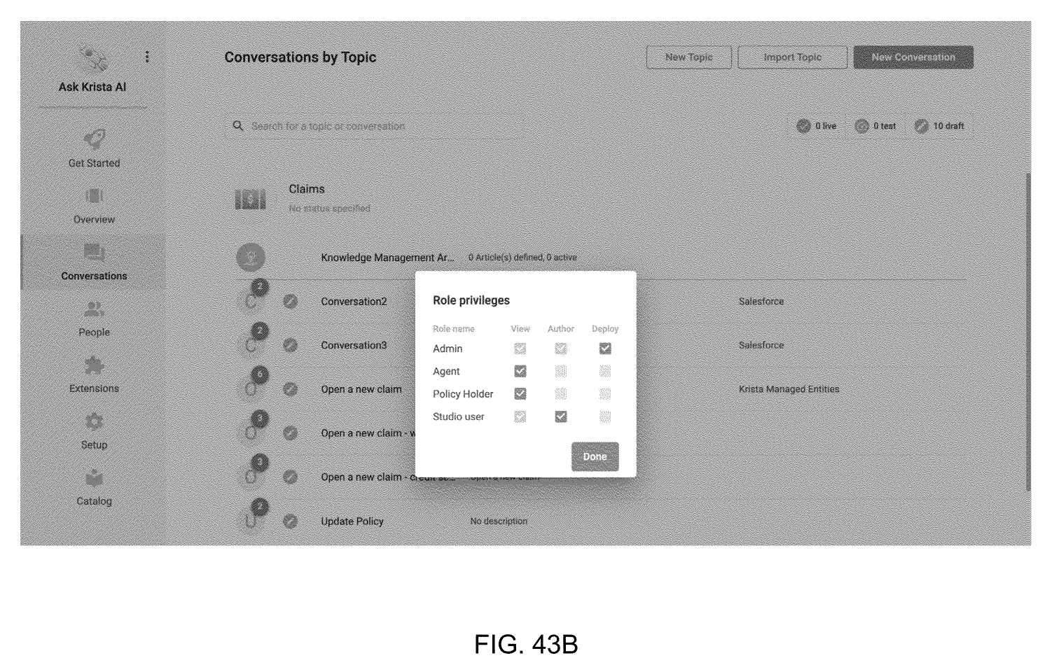

FIG. 43A illustrates privilege settings for a topic in accordance with certain embodiments and may be referred to as a topic level role matrix. In addition or as an alternative to setting privileges for multiple topics for a particular role as shown in FIG. 42, a user may be presented the option to set privileges for multiple roles for a particular topic. In FIG. 43A, for each available role, permissions are set for the Sales Info for Management topic. As depicted, if a particular role is assigned a permission of take live, that role is also assigned view and author privileges. Similarly, if a role is assigned author privileges, the role may also be assigned view privileges.

FIG. 43B illustrates privilege settings for a conversation in accordance with certain embodiments, the privilege settings may be shown, e.g., after selecting an individual conversation of a topic and may be referred to as a conversation level role matrix. In various embodiments, the privilege settings for a topic may provide constraints for privilege settings at the conversation level, such that if a user does not have a particular access level at the topic level, then the user may not have that access level for any of the conversations within the topic. However, a user may have a particular access level at the topic level, but have a lower access level (or no access) for a conversation of that topic based on the privilege settings for the individual conversation. For example, an HR manager might have view access to an HR topic but not have view access to an “Exec Comp Plan Changes” conversation within the HR topic.

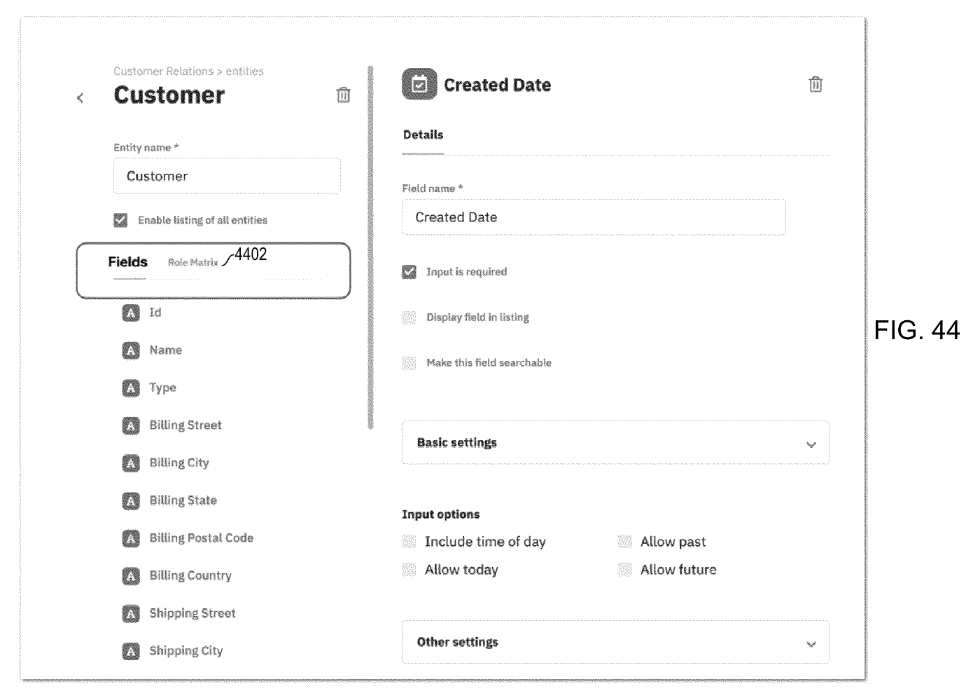

FIG. 44 illustrates a view for editing an entity 214 in accordance with various embodiments. The view shows a plurality of fields of the Customer entity, including Id, Name Type, Billing Street, and so on. The view also includes a header 4402 to display a role matrix. In various embodiments, system 102 may utilize a field role visibility matrix (which itself or similar matrixes may sometimes be referred to herein as role matrixes) to provide security in automation flows. The role matrix may be defined, e.g., on each entity definition in a catalog, on the forms for the ask a person and inform a person blocks, and/or for other suitable resources. A role matrix may provide the ability for authors to define access rights for fields of entities by role. Accordingly, in various embodiments, access to individual fields of an entity may be controlled based on roles of an organization.

Any one or more of the following permissions may be set for users based on their roles for a field (in various embodiments any subset of this group of permissions may be implemented): invisible, read, write once, and write. When a field is invisible to a user, it cannot be seen by the user (thus the user won’t know that the field even exists, let alone have access to read or write the value of the field). When a field is set to read for a user, the user may see the field and its value, but may not update the value of the field. When a field is set to write once for a user, the user can see the field and its value and set the field’s initial value, but may not change the value of the field if the field already has a value. If a field is set to write for a user, the user may see the field and its value and update the field value.

In various embodiments, each field of an entity may have permissions set, thus access controls do not explicitly need to be set for each entity. In some embodiments, an entire entity may be rendered by the system 102 as not viewable by users of a role when all the fields of that entity are set to invisible for that role. Similarly, all fields of the entity could be set to read, write, or write once (or different fields of the entity may have different permissions set) for any particular role.

In particular embodiments, every field of an entity and/or every field of any entity referenced in an ask a person block (e.g., the ask a person form and/or message) may be shown in the role matrix tables. For every such field, every role that has access to the conversation in which the entity is used (e.g., where access to the conversation may be defined in the conversation level role matrix discussed above), may be shown in the role matrix tables as well.

In various embodiments, default values may be used for the role matrixes. For example, for the first use of an entity in a workspace, the matrix from the entity definition in the catalog from which the entity was imported into the workspace may be used. As another example, for the first use of an entity in a particular conversation (but where the entity has been used already in other conversations), the role matrix may be copied from the most previously edited conversation. As another example, for the second or subsequent use of entity in a conversation, the role matrix may be copied from the first use of the entity in the conversation (in some embodiments, the role matrix may be copied from the most recent use of that entity in a previous block of the conversation). As yet another example, for the first use of a field, every role may be given write permission (or read permission if the field is used in an inform a person block). As another example, for subsequent use of the same field, the permissions may be copied from the use in the previous conversation block. As another example, for the first field created in an entity, all permissions may be given to the roles that are used in that domain (e.g., these roles may be obtained based on an aggregation of the roles in each topic of the domain, if there are no topics defined for that domain, every role in the workspace may be given every permission). As yet another example, for a subsequent field created in an entity, the closest field’s role matrix (e.g., for the field visually immediately above the field that is being created) may be copied. Other suitable default value schemes are contemplated herein.

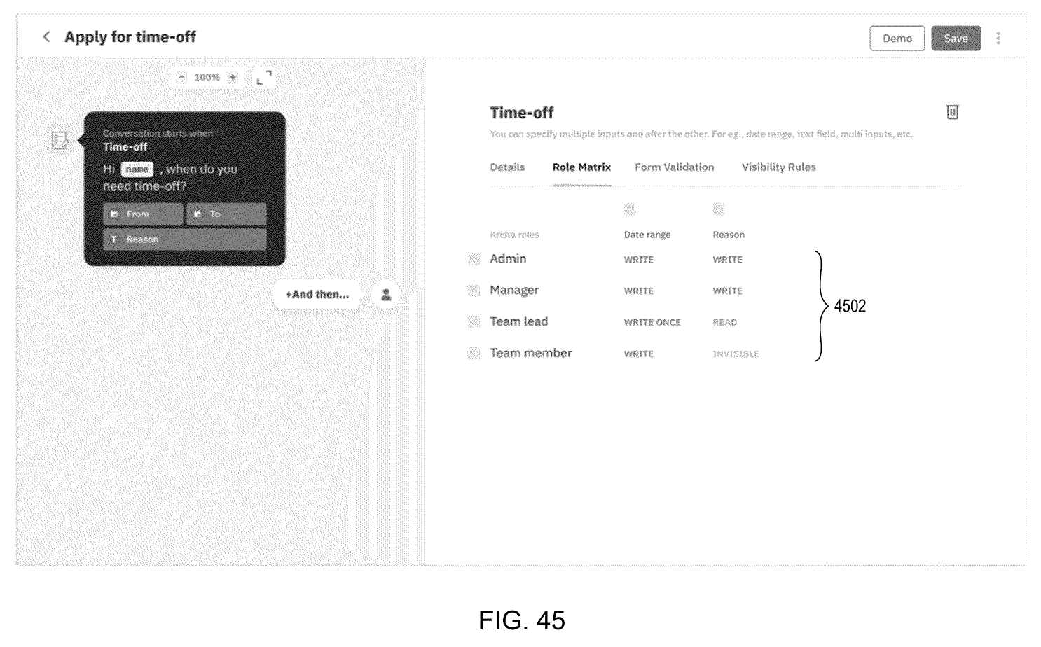

Although the actual role matrix for an entity is not shown in FIG. 44, the role matrix may appear similar to the role matrix 4502 shown in FIG. 45 for a conversation start/ask a person block. The block utilizes two fields: a date range and a reason. The roles shown in role matrix 4502 includes Admin, Manager, Team lead, and Team member. The intersection of each field and role may function like a cell in a table and may be assigned to one of the permissions. Selecting (e.g., by clicking on) one of the existing permissions may allow the author of the conversation utilizing the block to change the permission for the field and role combination.

As setting each role/field pair may be quite tedious, the ability to set the permissions on a particular field for all roles may be provided (e.g., by clicking the checkbox above the field name, where clicking the checkbox may open a list of permissions from which one may be selected). Similarly, the ability to set the permissions for all fields for a particular role may also be provided (e.g., by using a checkbox to the left of the role).

In some embodiments, the interface may also provide the ability to copy the permissions from one field to one or more other fields and/or from one role to one or more other roles. For example, clicking the checkbox above a field may bring up a menu item to copy permissions and when this menu item is selected the other fields may be presented and one or more fields may be selected to receive the same permissions as the field).

In some embodiments, the inform a person block may utilize a similar role matrix (in which every field referenced by the block and each relevant role is included in the matrix), but since fields are not updated by this block, the permissions may be limited to read and invisible. In other embodiments, access control may be implemented in an inform a person block through the ability to specify the target audience for each field that is to be shared via the block.

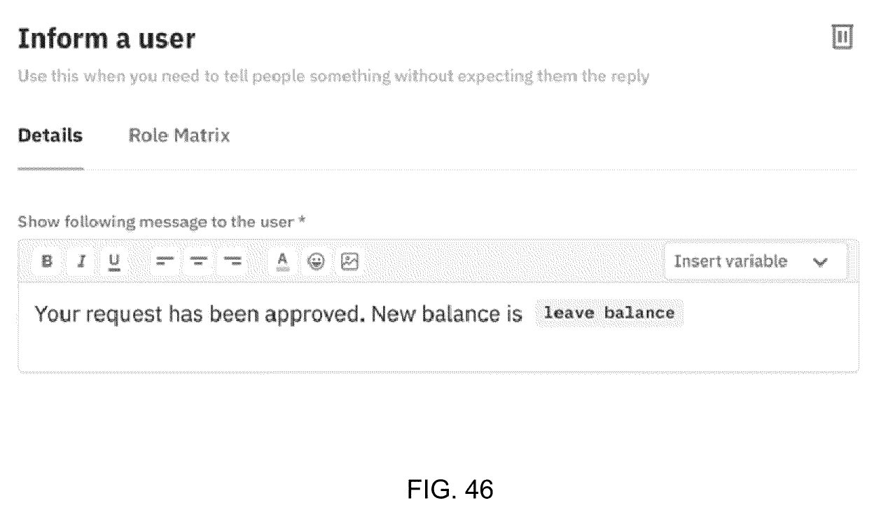

FIG. 46 illustrates a free-form text message defined within an inform a person block. This text message may include field values. In the message of FIG. 46, the text includes the field “leave balance.” In some embodiments, the role matrix for the block includes any fields that are included in the message to the user. When such a field is set to invisible for the role of the user that the message is to be sent to, the value of the field is omitted from the message (e.g., the value may be replaced with a message such as “field visibility restricted”). Similarly, for any such fields referenced in free-form text messages in an ask a person block, the fields may be included in the role matrix.

In various embodiments, an inform a person block may reference multiple fields of the same entity and the fields may have different values for the same role in the role matrix. For example, an opportunity entity may have a value field that is set to read for a particular role and a commission field that is set to invisible for that particular role. In such a case, when the inform a person block is executed to show information to someone having that role, the value for the value field may be shown, while the value for the commission field may be omitted (and in various embodiments any information indicating that the commission field exists may be omitted). If the particular role doesn’t have access rights to any of the fields of an entity (e.g., the opportunity entity), then no data associated with the opportunity entity would be shown to a person having that role (even the title of the entity may be omitted in a message provided to that person).

In some embodiments, a message that references an entity that is sent to a user may have all the fields and field values of that entity in a structured format. The message may be sent along with a role matrix (or at least the portion of the role matrix for the role that applies to the recipient user), so that the role matrix may be applied (e.g., by the client) at the time of data rendering for display to the user in order to block any fields/field values that the user does not have access to. In other embodiments, the information that the user does not have access to may be omitted entirely from the message.

A potential issue may arise if an author makes a field invisible to users, but then requires the field in form validation or visibility rules. In various embodiments, system 102 may detect such an instance and provide a warning to the author of the inconsistency. As an example, if a field is set to Invisible for a given role, a warning badge may be provided on that permission and provide a tooltip that says “This field has a Required Input form validation rule.”

In some embodiments, visual cues may be used to indicate which data is read-only (e.g., read-only data may appear differently than data that may be updated by the user). For invisible fields, anything that implies that the field is present in the form or entity may be omitted from a message (e.g., no dangling headers without data or the like). For example, if a salary field is hidden, a salary column as well as its “salary” may both be omitted.

Various security considerations may also be taken with respect to ad-hoc conversations. For example, interface 3716 or the like may include a selection (e.g., via a checkbox) to indicate whether to invoke on the backend system 116 with “system login” type credentials or to authenticate the user making the call to the request. For example, the selection may say “[x] Authenticate me to system” (where the x may be checked or unchecked) and a displayed tooltip could say something to the effect of “Check this if you have a login to the backend system and want to use your persona for this request.” The selection may be defaulted on. This could be shown above the input fields for the request, as the authentication may be needed for entity selection before the request is submitted.

Ad-hoc conversations may also utilize the features of potentially-updates-data in requests 212 (wherein the request may be marked with an indication of whether it can update data, such as the change system/query system types described above) and a field-level role matrix. Such features may be leveraged to ensure that people don’t obtain access to information that is too sensitive for their role.

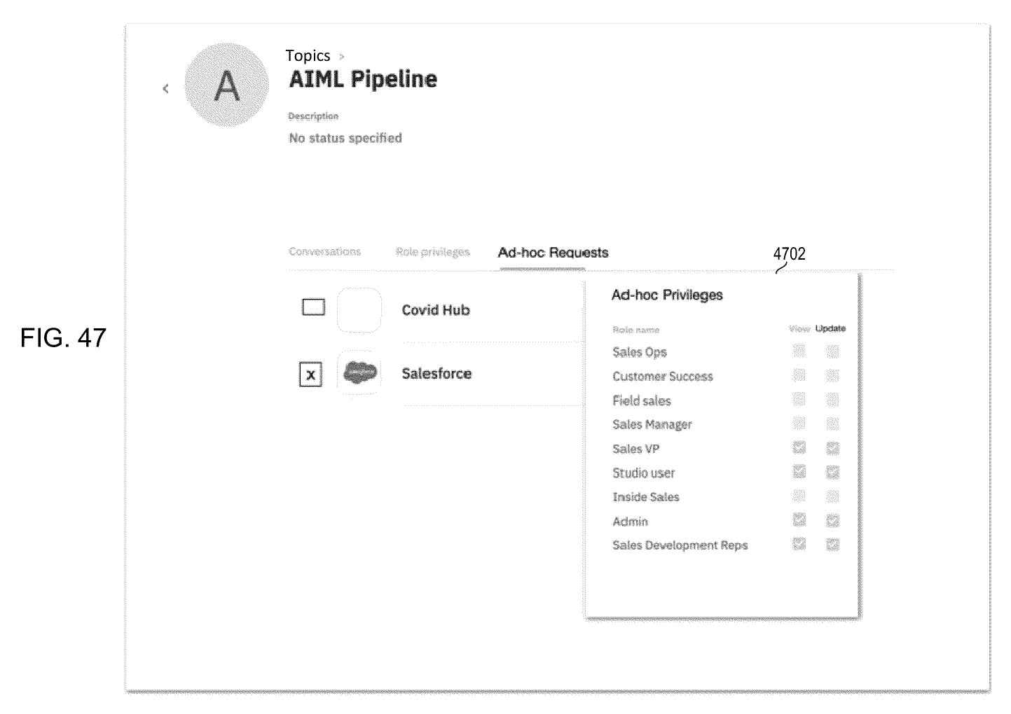

Particular users (e.g., administrators) may configure whether ad-hoc conversations and ad-hoc requests are allowed or not. In some embodiments, by default, ad-hoc conversations are not allowed. FIG. 47 illustrates an example interface for configuring ad-hoc privileges in accordance with certain embodiments. In this embodiment, a topic (AIML Pipeline) is selected and an additional header for Ad-hoc Requests (which could alternatively be titled ad-hoc conversations) is selected. This brings up an interface 4702 in which ad-hoc privileges may be configured per role and per backend system 116 that is supported by extensions of the topic (or the entire workspace in some embodiments). For example, in the embodiment depicted, ad-hoc conversations are allowed for the Salesforce extension set for the Sales VP, Studio user, Admin, and Sales Development Reps roles, but not for the other roles, while ad-hoc conversations are not allowed for the Covid Hub extension set. In some embodiments, only administrators may change these permissions, while authors are allowed to see the permissions but are not allowed to change them. In various embodiments, administrators may automatically have view and update privileges, while by default no other roles have these privileges unless an administrator explicitly allows them.

In embodiments where the potentially-updates-data feature is supported for requests, permissions may be granted for ad-hoc requests that can update data in a backend system 116 or only for ad-hoc requests that allow the viewing of data in a backend system 116 (when update is selected, view may also be selected automatically). In embodiments, where the potentially-updates-data feature is unavailable, a single permission of “enable” may be used per role (which permission may allow for viewing and updating).

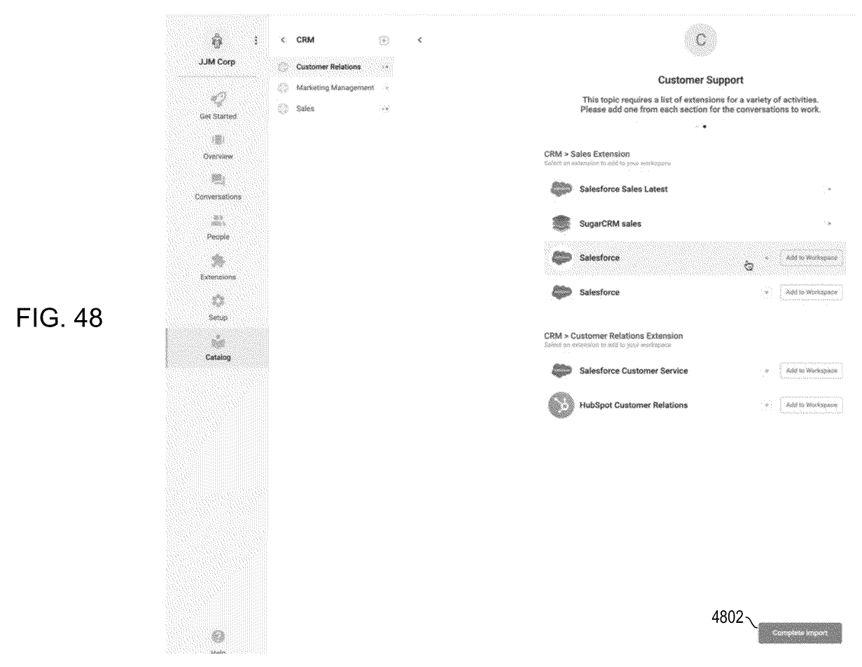

In addition to configuring security roles when a topic is imported, additional actions may be performed to complete the import. For example, FIG. 48 illustrates extension selection during the importing of a topic. During the import process, the system 102 may detect extension sets associated with the organization that include extensions mapped to requests of the conversation. A list of the extension sets that support the conversation(s) being imported are displayed. In some embodiments, an indication of whether the extension set is already part of the workspace may be displayed. For example, in the embodiment depicted, the Salesforce Sales Latest and SugarCRM sales extension sets are already part of the workspace. For the remaining extension sets that are not part of the workspace, an option to add any of these extensions sets to the workspace may be provided. Once the user has imported the desired extension set, the user may select the complete import icon 4802 to continue with the import process.

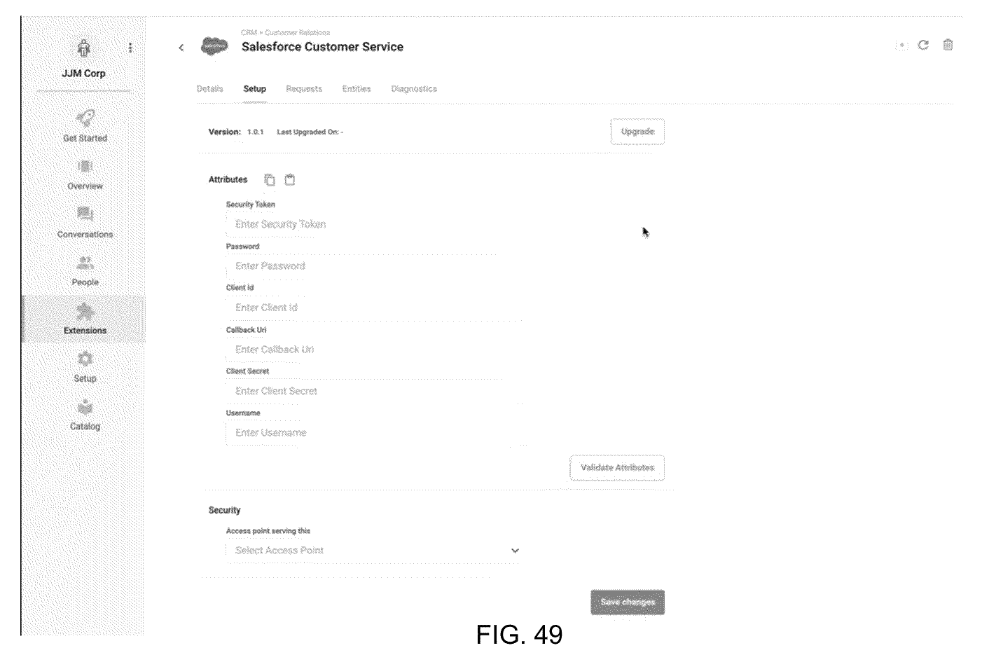

FIG. 49 illustrates a view for configuring attributes for an extension set. In some embodiments, such a view may be provided to allow the user to enter security credentials or other configuration attributes for the backend system 116 associated with the extension set. For example, the security credentials may include any one or more of a security token, password, client ID, callback URI, Client secret, user name, and access point.

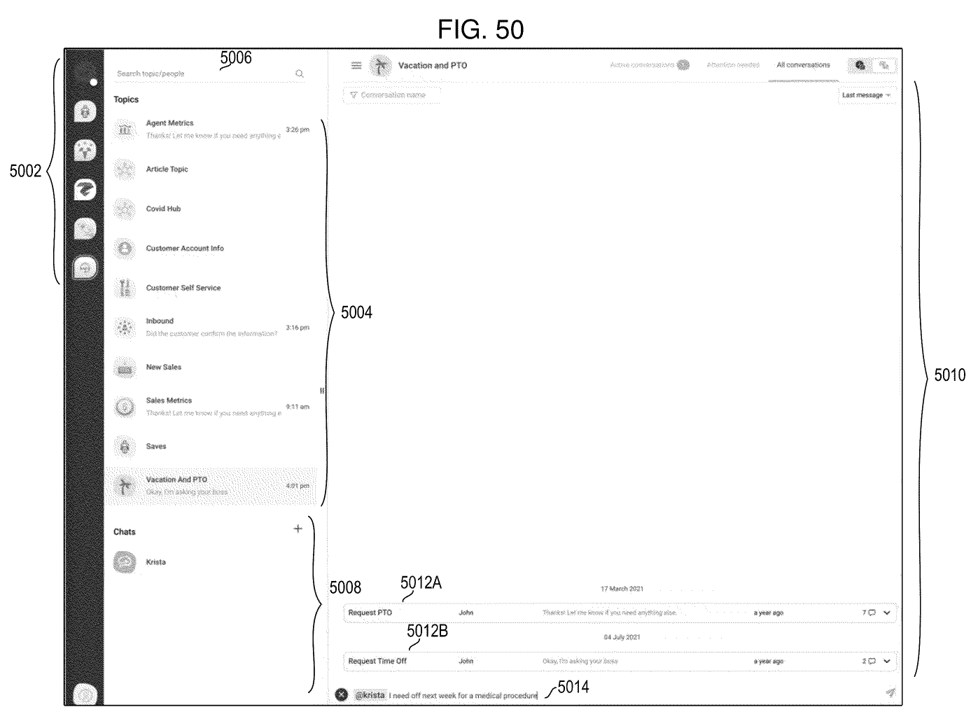

A client that allows a user to interface with the system 102 (e.g., to access conversations 210 and requests 212) may be provided via any suitable channel 114. FIG. 50 depicts a view that may be provided by an example client for interacting with one or more workspaces 108 of an organization. The view provided by the client is based on the user’s permissions (e.g., the client will only show workspaces, conversations, requests, fields, etc. for which the user has access permissions).

In the embodiment depicted, the client provides a workspace area 5002 comprising icons for workspaces available to the user. When a particular workspace is selected, a topic area 5004 may be provided comprising icons for topics that are available to the user within that workspace (e.g., Agent Metrics, Article Topic, Covid Hub, Customer Account Info, among others in the depicted embodiment). The client also provides a search bar 5006 to search for topics (e.g., when the number of topics is greater than the area available within the topic area 5004) or people within the workspace. The topic results may be returned based, e.g., on a keyword match between a title, synonym, or description of the topic (or conversation(s) or request(s) within the topic) and the term(s) searched for.

A topic may be selected as the current topic for the client. A chat area 5008 may display recent and/or pinned chat partners (including other persons in the workspace or the system 102 itself, marked in the depicted embodiment as “Krista”).

Communication area 5010 may display past and/or current communications for the currently selected topic, such as chats with other users or messages from executed conversations. For example, in the depicted embodiment, a conversation summary 5012A for a Request PTO conversation and a conversation summary 5012B for a Request Time Off conversation is shown (in various embodiments, a summary may be selected to view the messages received during the execution of the conversation).

In some embodiments, the client may provide various filters for the communication area 5010. For example, the user may select between showing active conversations, conversations in which attention is needed, or all conversations.

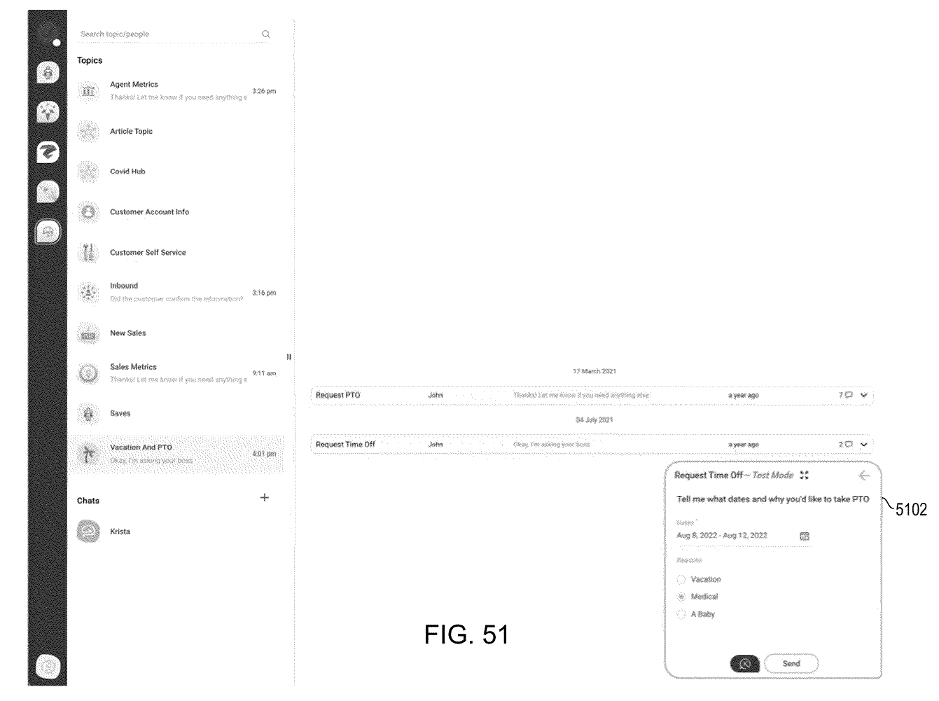

This area may also include an interface 5014 in which the user may submit input to invoke conversations 210 and/or requests 212. As will be described in more detail below, in various embodiments, NLP searching may be performed on such input in order to identify conversations and/or requests desired by the user. In the embodiment depicted, the input “I need off next week for a medical procedure” may result in invoking the Request Time Off conversation as shown in FIG. 51. The conversation executes an ask a person block, resulting in the sending of a message 5102 requesting a date range and a reason for taking time off.

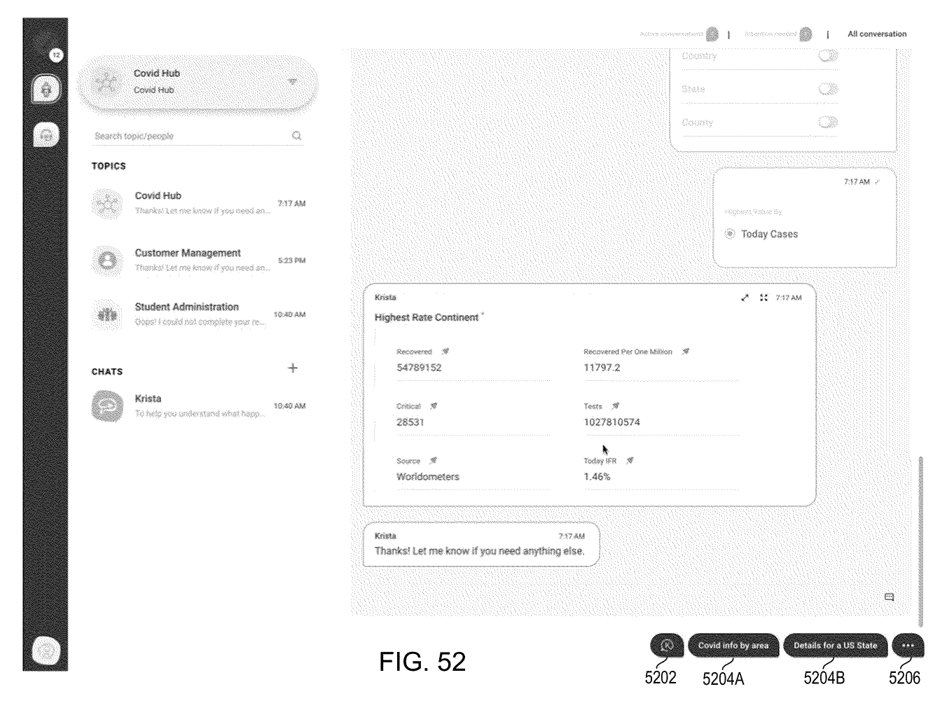

In some embodiments, the client may provide additional icons to facilitate use of the client. For example, in FIG. 52, an icon 5202 may be selected to bring up interface 5014. Icons 5204A and B may be selected to initiate recent or pinned conversations, and icon 5206 may be selected to bring up a conversation starter window.

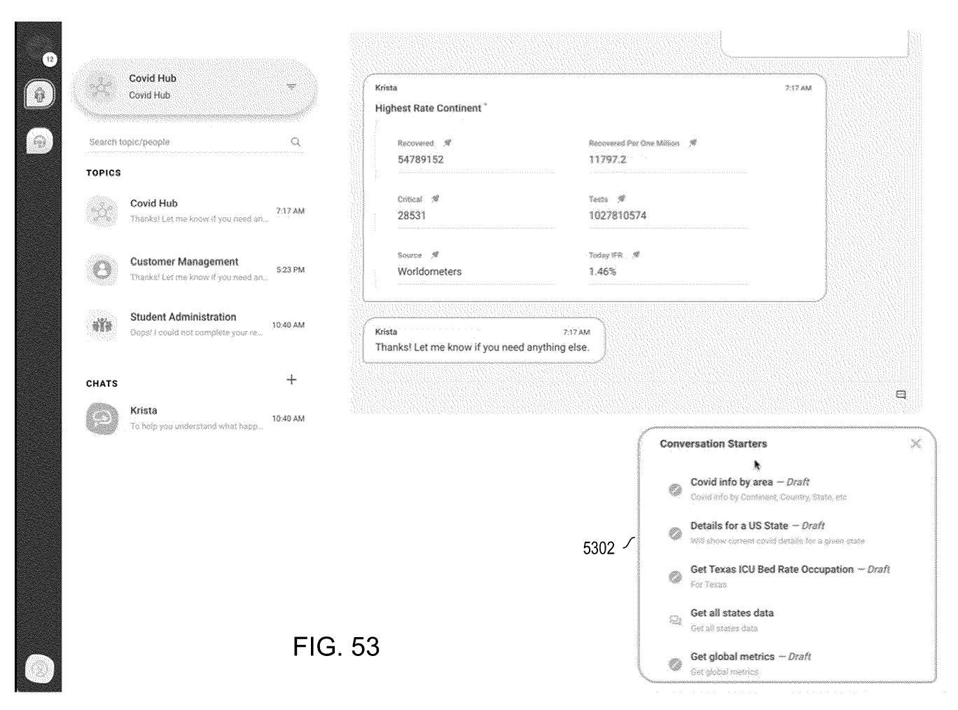

FIG. 53 depicts a conversation starter window 5302 in which various conversation starters are listed for selection by a user. In some embodiments, the conversation starter window 5302 includes conversations that have been pinned to the window 5302. In some embodiments, conversation starter window (or other portion of the client) may provide an option to erase conversation information from one or more past conversations or all conversation information (e.g., when the user does not want the information to be persistent from one conversation to another). In some embodiments, an option may allow a user to select certain conversation information (e.g., particular variables) to be persistent while erasing the remainder of the conversation information.

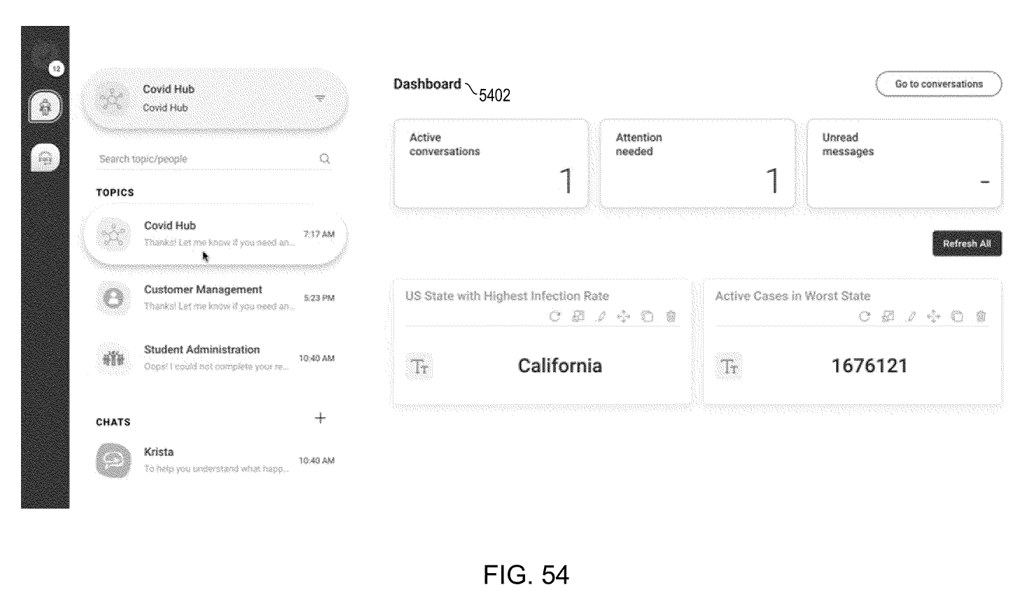

FIG. 54 illustrates a dashboard in accordance with certain embodiments. In some embodiments, each topic may be associated with a dashboard 5402 that may be displayed separately from or concurrently with the communication area 5010. The dashboard 5402 may display information that has been selected by a user (e.g., during execution of a conversation). For example, a user may use a conversation to request information and then may select the information (or a portion thereof) to be pinned to the user’s dashboard within the currently selected topic. For example, in the depicted embodiment, the user has pinned “US State with Highest Infection Rate” and “Active Cases in Worst State”. In various embodiments, the user may have the ability to modify the format the data will be displayed in on the dashboard (at the time of pinning and/or after the data has been pinned). As just one example, the user may specify a chart type for the data. As another example, the data may be resized, deleted, or moved within the dashboard.

A dashboard may update dynamically. For example, if the pinned data changes in the backend system 116 it was retrieved from, then the information will be updated on the user’s dashboard. In various embodiments, the system 102 may prevent a user from pinning simulated data (e.g., data from a conversation which is in a test mode). In addition to customized information pinned by the user, the dashboard may also display information about (and/or provide links to) messages or conversations (e.g., active conversations, conversations needing the user’s attention, or unread messages).

The enterprise automation system 102 may utilize a novel NLP system with automatic retraining based on resource creation or editing to enhance user searches. In various embodiments, the ontology and/or taxonomy used by the NLP system may be created based on (and/or may include) one or more of topic names, topic name synonyms, conversation names, conversation name synonyms, descriptions of conversations, entity names, entity name synonyms, entity descriptions, entity field names, entity field name synonyms, request names, request name synonyms, request descriptions, request input and output field names, phrases in ask a system or ask a person blocks, or other text associated with resources. Any of the above may be supplied, e.g., by one or more users of an organization (e.g., authors, administrators, etc.) for any number of resources used for the ontology and/or taxonomy. When a resource is created or a parameter (e.g., name, description synonym, field name) of the resource is changed, the NLP system may be retrained (or training could take place at any suitable interval to incorporate any additions or deletions of resources or edits to resources), e.g., by adding a name, synonym, field name (or other suitable parameter such as any of those described above) to one or more ontologies and/or taxonomies.

In various embodiments, the ontologies and/or taxonomies may be different per topic. For example, the NLP system may use a first ontology and/or taxonomy based on the resources present within a first topic, a second ontology and/or taxonomy based on the resources present within the second topic, and so on. As an example, a search for “customer” in a customer management topic may result in a search result including an entity named customer, whereas a search for “customer” in a student administration topic may treat “customer” as a synonym for student and return a “student” entity or other resources with “student” in the name, description, etc. As another example, the term “benefit” may be a noise word within many topics, but may have a very specific meaning in the ontology in the Human Relations topic.

Searches may also utilize the context within which a search is performed. For example, if the user is working within a particular workspace, then the ontology and/or taxonomy used during a search may be based on resources within that workspace. As another example, if the user is working within a particular catalog, then the ontology and/or taxonomy may be based on resources within that catalog. As another example, if the user is working within a particular topic or domain, then the ontology and/or taxonomy may be based on resources within that topic or domain respectively.

In some embodiments, particular data may be given more weight than other data during a search. For example, the name, name synonyms, and/or description of a resource may be considered more important during the search than other data associated with the resource (e.g., the names of inputs and outputs associated with the resource).

The NLP system may be utilized during any suitable search, such as a user searching for a conversation or request (e.g., within a particular topic using interface 5014), an author searching for a request within a particular domain in a catalog, an author searching for an entity, or any other search for a resource within a workspace or catalog.

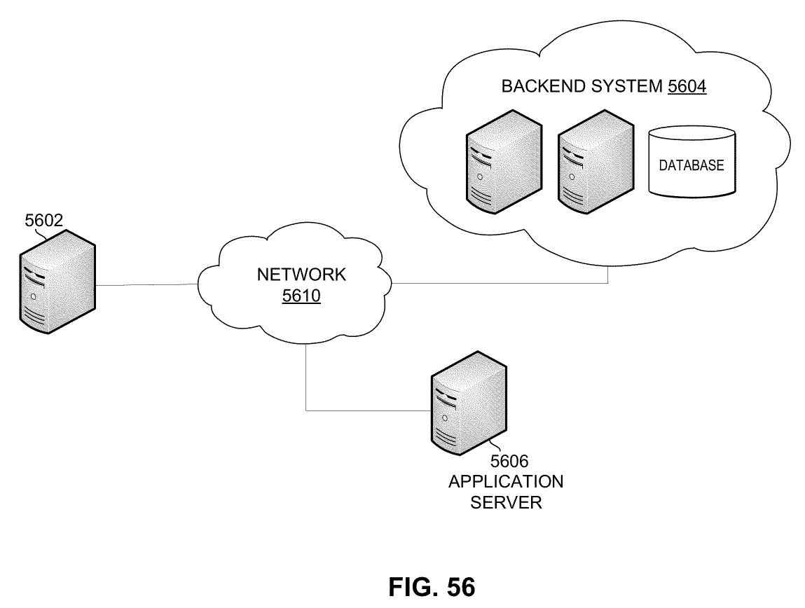

FIG. 56 illustrates a computing device 5602 coupled to a plurality of backend systems 5604 and an application server 5606 via a network 5610. Computing device 5602, application server 5606, backend systems 5604 (e.g., 5604A-N), and/or other computing devices may be used to provide any one or more of the features described herein. For example, any of these device and systems (or combinations thereof) may provide any one or more features of enterprise automation system 102, a backend system 116, and/or a channel 114.

A computing device 5602 may include any one or more electronic computing devices operable to receive, transmit, process, and store any appropriate data. In various embodiments, computing device 5602 may include a mobile device or a stationary device capable of connecting (e.g., through a wired or wireless connection) to one or more networks 5610. As examples, mobile devices may include laptop computers, tablet computers, smartphones, and other devices while stationary devices may include desktop computers, or other devices that are not easily portable. Computing device 5602 may include a set of programs such as operating systems (e.g., Microsoft Windows, Linux, Android, Mac OSX, Apple iOS, UNIX, or other operating system), applications, plug-ins, applets, virtual machines, machine images, drivers, executable files, and other software-based programs capable of being run, executed, or otherwise used by computing device 5602.

Backend system 5604 may comprise any suitable servers or other computing devices that facilitate the provision of features described herein. In various embodiments, backend system 5604 or any components thereof may be deployed using a cloud service such as Amazon Web Services, Microsoft Azure, or Google Cloud Platform. For example, the functionality of the backend system 5604 may be provided by virtual machine servers that are deployed for the purpose of providing such functionality or may be provided by a service that runs on an existing platform. In one embodiment backend system 5604 may include a backend server that communicates with a database to initiate storage and retrieval of data related to the system 5600. The database may store any suitable data associated with the system in any suitable format(s). For example, the database may include one or more database management systems (DBMS), such as SQL Server, Oracle, Sybase, IBM DB2, or NoSQL databases (e.g., Redis and MongoDB).

Application server 5606 may be coupled to one or more computing devices through one or more networks 5610. One or more applications that may be used in conjunction with system 5600 (which itself may be used to implement at least a portion of system 100) may be supported with, downloaded from, served by, or otherwise provided through application server 5606 or other suitable means. In some instances, the applications can be downloaded from an application storefront onto a particular computing device using storefronts such as the Google Android Market, Apple App Store, or other sources.

In general, servers and other computing devices of backend system 5604 or application server 5606 may include electronic computing devices operable to receive, transmit, process, store, or manage data and information associated with system 5600. As used in this document, the term computing device, is intended to encompass any suitable processing device. For example, portions of backend system 5604 or application server 5606 may be implemented using servers (including server pools) or other computers. Further, any, all, or some of the computing devices may be adapted to execute any operating system, including Linux, UNIX, Windows Server, etc., as well as virtual machines adapted to virtualize execution of a particular operating system, including customized and proprietary operating systems.

Servers and other computing devices of system 5600 (and thus system 100) can each include one or more processors, computer-readable memory, and one or more interfaces, among other features and hardware. Servers can include any suitable software component or module, or computing device(s) capable of hosting and/or serving a software application or services (e.g., services of backend system 5604 or application server 5606), including distributed, enterprise, or cloud-based software applications, data, and services. For instance, servers can be configured to host, serve, or otherwise manage data sets, or applications interfacing, coordinating with, or dependent on or used by other services. In some instances, a server, system, subsystem, or computing device can be implemented as some combination of devices that can be hosted on a common computing system, server, server pool, or cloud computing environment and share computing resources, including shared memory, processors, and interfaces.

A computing device (e.g., used to implement any of system 102, channels 114, backend systems 116, computing device 5602, backend system 5604, application server 5606) may include a computer system to facilitate performance of their respective operations. In particular embodiments, a computer system may include a processor, memory, and one or more communication interfaces, among other components. These components may work together in order to provide functionality described herein.

A processor may be a microprocessor, controller, or any other suitable computing device, resource, or combination of hardware, stored software and/or encoded logic operable to provide, either alone or in conjunction with other components of computing devices, the functionality of these computing devices. For example, a processor may comprise a processor core, graphics processing unit, hardware accelerator, application specific integrated circuit (ASIC), field programmable gate array (FPGA), neural network processing unit, artificial intelligence processing unit, inference engine, data processing unit, or infrastructure processing unit. In particular embodiments, computing devices may utilize multiple processors to perform the functions described herein.

A processor can execute any type of instructions to achieve the operations detailed herein. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., FPGA), an erasable programmable read only memory (EPROM), an electrically erasable programmable ROM (EEPROM)), or an ASIC that includes digital logic, software, code, electronic instructions, or any suitable combination thereof.

Memory may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory may store any suitable data or information utilized by computing devices, including software embedded in a computer readable medium, and/or encoded logic incorporated in hardware or otherwise stored (e.g., firmware). Memory may also store the results and/or intermediate results of the various calculations and determinations performed by processors.

Communication interfaces may be used for the communication of signaling and/or data between computing devices and one or more networks (e.g., 5610) or network nodes or other devices of system 5600. For example, communication interfaces may be used to send and receive network traffic such as data packets. Each communication interface may send and receive data and/or signals according to a distinct standard such as an IEEE 802.11, IEEE 802.3, or other suitable standard. In some instances, communication interfaces may include antennae and other hardware for transmitting and receiving radio signals to and from other devices in connection with a wireless communication session.

System 5600 also includes network 5610 to communicate data between the computing device 5602, the backend system 5604, and the application server 5606 (a similar network or networks may be used to couple channels 114 and/or backend systems 116 to system 102). Network 5610 may be any suitable network or combination of one or more networks operating using one or more suitable networking protocols. A network may represent a series of points, nodes, or network elements and interconnected communication paths for receiving and transmitting packets of information. For example, a network may include one or more routers, switches, firewalls, security appliances, antivirus servers, or other useful network elements. A network may provide a communicative interface between sources and/or hosts, and may comprise any public or private network, such as a local area network (LAN), wireless local area network (WLAN), metropolitan area network (MAN), Intranet, Extranet, Internet, wide area network (WAN), virtual private network (VPN), cellular network (implementing GSM, CDMA, 3G, 4G, 5G, LTE, etc.), or any other appropriate architecture or system that facilitates communications in a network environment depending on the network topology. A network can comprise any number of hardware or software elements coupled to (and in communication with) each other through a communications medium. In some embodiments, a network may simply comprise a transmission medium such as a cable (e.g., an Ethernet cable), air, or other transmission medium.

Although components are illustrated in particular configurations, this disclosure contemplates components distributed among any suitable computing systems in any suitable manner. For example, components (or portions thereof) illustrated as part of system 102 could be implemented in whole or in part by a separate system (e.g., a system of an organization that controls or is otherwise associated with respective channels and/or backend systems 116). Moreover, components (or portions thereof) may be implemented by a single computing system or any number of computing systems.

Logic may be used to implement any of the functionality of the various components illustrated herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable storage medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage medium used in the transmission of information over the Internet via electrical, optical, acoustical or other forms of propagated signals (e.g., carrier waves, infrared signals, digital signals, etc.). Accordingly, the computer-readable medium includes any type of tangible machine-readable storage medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A method, comprising:
providing a set of a conversation blocks in a programming interface to an author; and
constructing a conversation based on instantiation and configuration by the author of a plurality of conversation blocks of the set of conversation blocks, the conversation implementing an automation flow with respect to at least one backend system of an organization, wherein a first instantiated conversation block of the set of conversation blocks specifies a request, wherein the request is mapped to an extension comprising logic to interact with a backend system of the at least one backend system to effectuate an action described by a title of the request.

2. The method of claim 1, wherein the set of conversation blocks comprises:
a first conversation block to inform one or more persons;
a second conversation block to ask information from one or more persons; and
a third conversation block to make a request of a backend system of the organization.

3. The method of claim 2, further comprising causing display of the set of conversation blocks simultaneously with a program flow showing the instantiated conversation blocks responsive to a user indicating a desire to instantiate an additional conversation block.

4. The method of claim 3, wherein the set of conversation blocks comprises:
a fourth conversation block to call a second conversation;
a fifth conversation block to make a decision based on user or backend system input; and
a sixth conversation block to repeat steps in a loop.

5. The method of claim 2, wherein the set of conversation blocks comprises a fourth conversation block to call an artificial intelligence system.

6. The method of claim 1, further comprising receiving a selection of the extension from the author, wherein the extension is selected from a plurality of extensions each comprising logic to interact with a different backend system of the organization to effectuate the action described by the title of the request.

7. The method of claim 1, wherein the logic of the extension comprises one or more application programming interface (API) calls to the backend system.

8. The method of claim 1, wherein the logic of the extension comprises robotic process automation scripts to connect to the backend system.

9. The method of claim 1, further comprising importing the request from a catalog into a workspace of the organization, the catalog comprising requests organized by domains, wherein the catalog is available to a plurality of organizations.

10. The method of claim 1, further comprising providing an interface to allow the author to select whether the request is to use test data for a test mode.

11. The method of claim 1, further comprising providing an interface to allow the author to map inputs received from a person to respective values of the request.

12. The method of claim 1, further comprising providing an interface to the author to allow the author to define an entity and select a backend system for the entity.

13. One or more non-transitory computer-readable media comprising instructions to cause an electronic device, upon execution of the instructions by one or more processors of the electronic device, to:
provide a set of a conversation blocks in a programming interface to an author; and
construct a conversation based on instantiation and configuration by the author of a plurality of conversation blocks of the set of conversation blocks, the conversation implementing an automation flow with respect to at least one backend system of an organization, wherein a first instantiated conversation block of the set of conversation blocks specifies a request, wherein the request is mapped to an extension comprising logic to interact with a backend system of the at least one backend system to effectuate an action described by a title of the request.

14. The media of claim 13, wherein the set of conversation blocks comprises:
a first conversation block to inform one or more persons;
a second conversation block to ask information from one or more persons; and
a third conversation block to make a request of a backend system of the organization.

15. The media of claim 13, the instruction to cause the electronic device to cause display the set of conversation blocks simultaneously with a program flow showing the instantiated conversation blocks responsive to a user indicating a desire to instantiate an additional conversation block.

16. The media of claim 15, wherein the set of conversation blocks comprises:
a fourth conversation block to call a second conversation;
a fifth conversation block to make a decision based on user or backend system input; and
a sixth conversation block to repeat steps in a loop.

17. An apparatus comprising:
a memory to store one or more computer-readable media comprising instructions; and
one or more processors to execute the instructions to:
provide a set of a conversation blocks in a programming interface to an author; and
construct a conversation based on instantiation and configuration by the author of a plurality of conversation blocks of the set of conversation blocks, the conversation implementing an automation flow with respect to at least one backend system of an organization, wherein a first instantiated conversation block of the set of conversation blocks specifies a request, wherein the request is mapped to an extension comprising logic to interact with a backend system of the at least one backend system to effectuate an action described by a title of the request.

18. The apparatus of claim 17, wherein the set of conversation blocks comprises:
a first conversation block to inform one or more persons;
a second conversation block to ask information from one or more persons; and
a third conversation block to make a request of a backend system of the organization.

19. The apparatus of claim 17, the one or more processors to cause display of the set of conversation blocks simultaneously with a program flow showing the instantiated conversation blocks responsive to a user indicating a desire to instantiate an additional conversation block.

20. The apparatus of claim 19, wherein the set of conversation blocks comprises:
a fourth conversation block to call a second conversation;
a fifth conversation block to make a decision based on user or backend system input; and
a sixth conversation block to repeat steps in a loop.
